(19) United States
(12) Patent Application Publication
(10) Pub. No.: US 2003/0152857 A1
(43) Pub. Date: Aug. 14, 2003

(54) Toner, developer, image-forming method and image-forming device

(76) Inventors: Hideki Sugiura, Shizuoka (JP); Satoshi Mochizuki, Shizuoka (JP); Kazuhiko Umemura, Shizuoka (JP); Yasuo Asahina, Shizuoka (JP); Minoru Masuda, Shizuoka (JP); Kohsuke Suzuki, Shizuoka (JP); Tomomi Tamura, Shizuoka (JP); Yasuaki Iwamoto, Shizuoka (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/212,736

(22) Filed: Aug. 7, 2002

(30) Foreign Application Priority Data
Aug. 7, 2001 (JP) 2001-238556
Jan. 9, 2002 (JP) 2002-002785

(51) Int. Cl. G03G 9/08; G03G 13/01

(52) U.S. Cl. 430/109.2; 430/111.4; 430/108.1; 430/126; 399/308; 430/59.6; 430/108.8; 399/298; 430/108.4; 430/108.6; 430/45

(57) ABSTRACT

A toner for electrophotography contains a binder resin and a colorant, the toner for electrophotography has a tensile fracture strength of 10-1400 (N/m²) under 10 kg/cm² compression, and a loose apparent density of 0.10-0.50 (g/cm³).

### BACKGROUND OF THE INVENTION

1. Field of the Invention

The present invention relates to a toner for electrophotography, a developer, an image-forming method, and an image-forming device.

2. Description of the Related Art

A typical image-forming step for forming images in an electrophotography and electrostatic printing comprises: a step for uniformly charging an optical conducting insulating layer; irradiating the insulating layer; dissipating the charge on the irradiated portion to form a latent electrostatic image; and causing powdered toner to adhere to the latent image so as to render it visible; followed by a step for transferring the obtained visible image to a transfer material such as transfer paper; and finally a step for fixing the image by beat (usually, a heat roller) or pressure.

The developer for developing the static charge image formed on the latent electrostatic image bearing member surface may be a two-component toner comprising a carrier and toner, or a one-component developer (magnetic toner, non-magnetic toner) without a carrier. In one well-known method, a full color image-forming device first transfers a toner image of each color formed on the photoconductor to an intermediate transfer body, and then all the color images are transferred to a paper.

The toner used in this electrophotography or electrostatic printing has a binder resin and colorant as the main components, and also contains additives such as an electrostatic charge control agent and offset preventing agent, and various features are required in each of the aforementioned steps. For example, in the step for developing, in order to make the toner adhere to the latent electrostatic image, the toner and the binder resin for the toner must retain a suitable amount of electrostatic charge for a copier machine or a printer without being affected by environmental parameters such as temperature and humidity. Moreover, in the fixing step by heat roller fixing, the toner must have non-offset properties so it does not adhere to the heat roller which is usually heated to a temperature of about 100-230° C., and it must have good paper fixing properties. Further, it must also have anti-blocking properties so that it does not block up when stored in a copier.

In the field of electrophotography, in recent years, the problem of how to achieve high-quality images has been considered from various viewpoints, and there is now increasing awareness that it is very useful to reduce the particle diameter of toner and to sphericalize the particles. However, as the particle diameter of toner decreases, transfer properties deteriorate, and a poorer image tends to be obtained.

It is known, however, that the transfer properties improve by sphericalizing the toner particles (Japanese Patent Application Laid-Open (JP-A) No.09-258474).

In color copying machines or color printers, an improvement in the speed of image-forming is also desired. For improvement in speed, a “tandem method” is effective (as disclosed, for example, in (JP-A No.05441617). The “tandem method” is a method in which a full color image is acquired by superimposing and transferring images formed by an image-forming unit on a single transfer paper transported by a transfer belt. A tandem full color image-forming device can use various types of transfer paper, and permits a high quality full color image to be obtained at high speed. The fact that a full color image can be acquired at high speed is a characteristic which is not found in the other color image-forming method.

Other attempts are being made to attain high-quality images under high speed by using spherical toner. In order to gain an improvement in the speed of the device adopted to use the method, the time while the paper passes a transfer unit must be shortened, hence, to obtain the same transfer performance as in the related art, the transfer pressure must be raised. However, if the transfer pressure is raised, the toner becomes condensed due to the pressure at the time of transfer, which results in poor transferring and image-dropouts. To resolve this problem, the toner sphericity, particle diameter, specific gravity and BET specific surface must be specified, and the adhesive stress for 1 kg/cm² compression is specified to be 6 g/cm² or less, in an attempt to achieve high-quality images (JP-A) No. 2000-3063. However, as the compression pressure was too weak, with the increased transfer pressure because of an OHP transparency, pasteboard, surface coated paper, etc., it is likely to cause the problems such as poor transferring and image-dropouts, when an adhesive stress for 1 kg/cm² compression is used. If the adhesive stress is below 1 kg/cm², there are problems such as transfer dust.

For instance, the release properties of the toner have been improved by specifying the adhesion of one toner particle to be 3.0 dyne/contact point (JP-A No. 2000-352840). Release properties improve, as toner adhesion during compression is not specified. However, there is no improvement of transfer properties and image-dropouts, hence there is no improvement of image quality.

In other method, for instance, the degree of cohesion during compression is specified to improve developing properties and aging stability (Japanese Patent JP-B) No. 3002063). However, even if the degree of cohesion during compression is specified, there are still problems in image quality such as image-dropouts, and it is difficult to sufficiently improve transfer properties and transfer rate.

It has been attempted, for instance, to specify the product of the degree of cohesion and loose apparent density as 7 or less to improve image-dropouts (JP-A) No. 2000-267422, but this is not reflected in a change of physical properties during toner compression, and the effect in intermediate transfer systems and strongly stirred developing systems where there is more stress on the toner, was not sufficiently marked.

In another attempt, the ratio of the loose apparent density and hard apparent density (loose apparent density/hard apparent density)=0.5-1.0, and the degree of cohesion is specified to be 25% or less (JP-A No. 2000-352840), the apparent density used here being a value obtained by measuring the bulk density after tapping 50 times. The physical properties are close to reflecting fluidity and cannot reflect bulk density increase factors when applying a dynamic stress to the toner, and there is insufficient effect on intermediate transfer systems and strongly stirred developing systems where there is more stress on the toner. Adhesive stress during compression is discussed by JP-A No. 11-295928. However, this is a toner with a small adhesive stress when a low adhesive stress of 10 kg/cm² and 1.5 kg/cm² is applied (respectively, 6 g/cm² and 8 g/cm²), and is different from the behavior when compression is applied at the strong pressure of 10 kg/cm² of the present invention. It is therefore an object of the present invention to confer a tensile fracture strength within a predetermined range in the case of a stronger stress.

If the toner of JP-A No. 11-295928 is evaluated for compression under a strong pressure of 10 kg/cm², the tensile fracture strength is less than 10 N/m², and the toner has excessive fluidity. For example, in the embodiments, the total amount of additive used is 1.8% or more, and it can be presumed that fluidity is very high. Moreover, the resin currently used contains polyester resins having softening points of 110° C. and 150° C., and this also shows that it is hard and fluidity is high.

Loose apparent density is discussed by JP-A No. 2000-267422. However, although the loose apparent density of this toner is 0.50 g/cm³ or less, the adhesion stress for 10 kg/cm² compression is less than 10 N/m², which is outside the range of the present invention. Even if the loose apparent density is within the limits of the present invention, the tensile fracture strength under compression may not be within the range of the present invention. The tensile fracture strength depends on adhesive properties due to resin composition, shape and surface state, on the shape, size, particle diameter distribution or type of additive, and on the shape, size and hydrophobic state of the surface, which all interact in a complex manner.

Ionization potential or work function value is defined as the minimum energy required to extract one electron, and is used as an index which shows the ease with which a molecule becomes a positive ion.

The electrostatic charge properties of a toner have a close relation to its electronic state, and there is also a view wherein the movement of electrons is based on work function difference. Various studies have been performed on the work function of a carrier. For example, a method is known wherein the work function value difference between colors is specified to control the electrostatic charge properties between toner colors (JP-B No. 2954786), but with the work function value of the toner alone, sufficient effect as a developer was not obtained. An example which specified the work function value of the carrier is also known (JP-B No. 2992916, JP-B No. 2939870), but the electrostatic charge properties of a developer containing toner could not be sufficiently controlled only by the carrier, and a sufficient effect was not obtained thereby.

In electrophotographic photoconductors, an example which specifies ionization potentials such as that of the charge transporting material, is also known (JP-A No. 10312070, JP-A No. 2000-131860), but the ionization potential of the photoconductor surface which is in direct contact with the toner, or as an entire charge transporting layer, was unknown, and the relation between the photoconductor and toner was also unknown. It was also desired to improve the sensitivity of the photoconductor.

Various studies have been performed on the ionization potential of an intermediate transfer body (JP-A No. 2000-231273, JP-A No. 2001-133999), but this was a value of the intermediate transfer body alone, and did not take the relation with the toner into account,

A method has been proposed wherein inorganic powders, such as toner particles and various metal oxides, etc., are blended in order to improve the flow characteristics and electrostatic charge characteristics of the toner, these being referred to as additives. There are other methods wherein treatment with specific silane coupling agents, titanate coupling agents, silicone oil and organic adds, or covering with special resins, is applied to improve the hydrophobic property and electrostatic charge characteristics, etc. of the inorganic powder surface as necessary. Examples of the above-mentioned inorganic powders are silicon dioxide (silica), titanium dioxide (titania), aluminum oxide, zinc oxide, magnesium oxide, ceric oxide, iron oxide, copper oxide, and tin oxide.

In particular, hydrophobic silica particles, obtained by reacting silica and titanium oxide particles with organic silicon compounds such as dimethyl dichlorosilane, hexamethyl disilazane and silicone oil to replace silanol groups on the silica particles surface with organic groups, are used.

Of these, as a hydrophobic treatment agent showing sufficient hydrophobic properties, and which, when contained in toner, give the toner excellent transfer properties due to its low surface energy, silicone oil is preferred. The degree of hydrophobocity of silica treated with silicone oil is specified in Japanese Patent Application Publication No. 07-3600, or JP-B No 02568244. Silicone oil addition and the carbon content in the additive are specified in JP-A No. 07-271087, or JP-A No. 08-29598. The inorganic particles were hydrophobically treated, and their silicone oil content and degree of hydrophobicity satisfied the publications mentioned previously to ensure stability of the electrostatic charge properties of the developer under high humidity. However, there have been no serious attempts to lower adhesion to the component, for example, a contact electrostatic charge device, developer support (sleeve), doctor blade, carrier, latent electrostatic image bearing member (photoconductor) or intermediate transfer body, which comes in contact with the developer, using the low surface energy which is an important feature of silicone oil. In particular, soiling due to the strong adhesion of the developer to the photosensitive body, or missing parts after transfer in the edge or center of a character, line or dot (arts where the developer is not transfered), could not be improved simply by adjusting the added amount and degree of hydrophobicity of silicone oil. Likewise, white patches due to inability to transfer to depressions during transfer to transfer materials having marked unevenness, could not be improved. JP-A No. 11-212299 discloses inorganic particulates containing a specific amount of silicone oil as a liquid component. However, the above properties could not be satisfied with this definition of amount.

Polystyrene and styrene-acrylic copolymers, polyester resins and epoxy resins are generally used as binder resins as they have the characteristics required for toners, i.e., transparency, insulation, water resistance, fluidity (as powder), mechanical strength, gloss, thermoplasticity and crushability. Of these, styrene resins are very widely used as they have excellent crushability, water resistance and fluidity. However, when a copy obtained with a toner containing styrene resin is placed in a PVC resin sheet document holder, as the image surface of the copy is in intimate contact with the sheet, the plasticizer in the sheet, i.e., in the PVC resin, migrates into the fixed toner image and plasticizes it so that it sticks to the sheet. As a result, when the copy is separated from the sheet, part or all of the toner image peels off the copy, and the sheet is also soiled.

This defect is also observed with polyester resin toner. In JP-A No. 60-263951 or JP-A No. 61-24025, to prevent migration to the PVC resin sheet, it is proposed to blend an epoxy resin which is not plasticized by the plasticizer for PVC resin, with a styrene resin or polyester resin.

However, when such a blend resin is used as a color toner, there are problems as to offset properties, fixing image curl, gloss (in the case of a color toner image, it appears to be a poor image if it has no gloss), coloring properties, permeability and color developing properties due to non-compatibility between resins of different kinds. These problems cannot be completely solved by conventional epoxy resins or even by the acetylation-modified epoxy resin which is proposed in JP-A No. 61-235852.

It is possible to solve the above-mentioned problems by using an epoxy resin alone, but reactivity with the amine of the epoxy resin then arises as a new problem. In general, epoxy resins are used as curing resins having superior mechanical strength or chemical resistance by reacting the epoxy groups with a curing agent to incorporate a crosslinked structure. Curing agents may be divided broadly into an amine type and an organic acid anhydride type. Of course, epoxy resins used as toners for electrophotography are used as thermoplastic resins, and as some of the dyes or electrostatic charge control agents kneaded together with the resin as toner are amines, they may cause crosslinking reactions to occur during kneading, thus rendering them unsuitable for use as toner. Moreover, the chemical activity of this epoxy group may have biochemical properties, i.e., toxicity such as skin irritation, etc., and due care must be paid to them.

As epoxy groups show hydrophilic properties, they have remarkable water absorption at high temperature and high humidity, causing a decrease of the electrostatic charge, greasing and poor cleaning. Further, electrostatic charge stability in the epoxy resin is another problem.

In general, the toner comprises a binder resin, colorant and electrostatic charge control agent. As colorant, various dyes are known, some of which can control electrostatic charge, and some have the double function of colorant and electrostatic charge control agent. The above type of composition is widely used in toners using an epoxy resin as binder resin, the dispersibility of the dye and electrostatic charge control agent was a problem. In general, the binder resin, dye and electrostatic charge control agent are kneaded together by a heat roll mill, the kneaded needs to be dispersed the dye and electrostatic charge control agent uniformly in the binder resin. However, it is difficult to completely disperse them, and if dispersion of the dye used as colorant is poor, development of color will be poor and the degree of coloring will decline. If dispersion of the electrostatic charge control agent is poor, the electrostatic charge distribution will be uneven and will lead to poor electrostatic charge, greasing, scattering, ID shortage, “bosotsuki” and poor cleaning, and the like. JP-A No. 61-219051 discloses a toner wherein an epoxy resin which is ester-modified by epsilon-caprolactone is used as a binder resin. The resistance to PVC and fluidity are improved, however, the modified amount may be as much as 15 to 90 weight %, the softening point falls too much, and there is also too much gloss.

JP-A No. 52-486334 discloses the reaction of a primary or secondary aliphatic amine with terminal epoxy groups of an existing epoxy resin to give a toner with a positive electrostatic charge, however the epoxy groups and amine cause a crosslinking reaction as described above, and it may not be possible to use it as a toner in some cases. JP-A No. 52-156632 discloses the reaction of one or both of the terminal epoxy groups of the epoxy resin with an alcohol, phenol, a Grignard reagent, organic acid sodium acetylide or alkyl chloride, but if epoxy groups remain, problems occur such as reactivity with amines, toxicity and hydrophilic properties. Moreover, in the aforementioned reactants, there are hydrophilic substances, substances which affect the electrostatic charge and substances which affect crushability when they are used in a toner, and they are not necessarily all effective in the present invention.

JP-A No. 01-267560 discloses a substance produced by making both terminal epoxy groups of the epoxy resin react with a monofunctional compound containing active hydrogen, and esterifying with monocarboxylic acids, their ester derivatives or lactones. This solves the problems of the reactivity, toxicity and hydrophilic properties of the epoxy resin, but curl during fixing is not much improved.

Solvents such as xylene are often used in the synthesis of an epoxy resin or polyol resin (e.g., JP-A No. 11-189646), but these solvents or an ureacted monomer such as bisphenol A are then present in considerable amounts in the resin after manufacture, and they were also present in large amounts in toners using these resins, which caused a problem.

The method of manufacturing a toner of volume average particle diameter of 6-10 μm which is generally adopted is to mix all the starting materials together at once, heating, melting and dispersing in a kneading machine or the like, to obtain a uniform composite, and then cooling, grading the particles and crushing. Color toners used for forming a color image in electrophotography are generally obtained by dispersing various color dyes or pigments in the binder resin. In his case, the performance required of the toner used will be more severe than in the case where a black image is acquired.

In addition to mechanical and electrical stability to external factors such as impact and humidity which are required of the toner, a suitable color (degree of coloring) and optical permeability (transparency) are required when using for an overhead projector (OHP). Dyes which are used as colorants are for example disclosed in JP-A No. 57-130043 and JP-A No. 57-130044. However, when a dye is used as a colorant, although the image acquired has excellent transparency, good coloring properties are obtained and a dear color image can be formed, lightfastness is inferior, and if it is left under direct light, it tarnishes and fades.

In image-forming in the intermediate transfer method, plurality of visible color developing images formed on an image bearing member are superimposed one by one on an intermediate transfer body which performs an uninterrupted movement in a first transfer operation, and then the first transfer images (toner images) on this intermediate transfer body are transferred in a second transfer operation to a transfer material. Image-forming devices using this intermediate transfer method are advantageous in that they are compact, and there are few restrictions on the type of transfer material to which the visible image is finally transferred, so in recent years, they are tending to be used as color image-forming devices.

In such an image-forming device, if there are parts of the image which were not transferred in the first transfer and second transfer of the toner image's which form the developed color image, there will be “moth-eaten” (image-dropouts) parts where toner has not been transferred locally or completely in the transfer image to the transfer paper or the like, which is the final image medium. In the case of solid images, the moth-eaten images will represent transfer losses having a certain surface area. In the case of line images, transfer losses will occur so that the lines are broken at some point along their length.

When forming a four color full color image, such an unusual image is easily produced. This is due to the fact that, in addition to the thickening of the toner layer, the first transfer is repeated up to four times, so strong mechanical adhesive forces (forces other than electrostatic forces such as Van der Waals forces) which are non-Coulombic forces are produced by contact pressure between the image bearing member body surface and toner, and between the intermediate transfer body surface and toner. Further, in the image-forming step which is repeated, a filming phenomenon occurs wherein toner sticks like a film to the surface of the intermediate transfer body, thereby increasing the adhesive force between the surface of the intermediate transfer body and the toner.

In this connection, as a technique for avoiding moth-eaten images, a lubricating agent may be coated on the surface of the image bearing member body and intermediate transfer body to reduce the adhesive force acting on the toner, or the adhesive force of the toner itself can be reduced by an additive or the like, and this technique has already been applied in commercial machines. However, no consideration was given to four-color full color images or the adhesive force acting on the toner and tensile fracture strength when the transfer contact pressure generated during high speed transfer increased, and in particular, there was a problem of image quality after transfer to thick paper, surface-coated paper or OHP transparency.

In JP-A 08-211755, the relative balance between the toner adhesive force of the image bearing member body and the toner adhesive force of the intermediate transfer body is adjusted to improve transfer and prevent abnormal moth-eaten images. However, the toner adhesive force at this time is a value found by centrifugation in the powder state, and gives a different result from the physical properties when the transfer contract pressure increases.

### SUMMARY OF THE INVENTION

It is a first object of the present invention to provide a toner for electrophotography wherein the cohesive properties and adhesive force between toner particles during compressive toner transfer is suitably controlled, which has excellent developing properties, and which can form a high quality image which is not affected by the transfer material. It is a second object to provide a toner for electrophotography which has excellent charging properties in a high temperature, high humidity and low temperature, low humidity environment with little weakly charged or oppositely charged toner, which can form an image with little soiling. It is a third object to provide a toner for electrophotography which has excellent transfer properties during toner compression, as well as good refill and charging properties with excellent fluidity when not under compression. It is a fourth object to provide a toner and developer with excellent environmental charge stability with no color blurring from low printing speeds to high printing speeds, showing no decrease of image density after continued image output, and having an excellent balance between fixing properties and non-offset properties. It is a fifth object to provide proper toner transfer, and to provide a toner and image with excellent color reproducibility, color brightness and color transparency together with stable gloss and little unevenness. It is a sixth object to provide a toner having excellent environmental stability and environmental storage properties. It is a seventh object to provide a toner wherein the toner image does not migrate to a sheet even if the fixed image surface is brought into intimate contact with a polyvinyl chloride resin sheet. It is an eighth object to provide a toner and image wherein the fixed image does not curl. It is a ninth object to provide an image-forming device having a two-step transfer process wherein a toner image is first formed on an latent electrostatic image bearing member, and this toner image is then transferred to a transfer material, which can output at high speed by the tandem method and which prevents the occurrence of moth-eaten images.

As a result of intensive studies to achieve the above objects, the inventor discovered a toner for electrophotography comprising at least a binder resin and a colorant, in which the tensile fracture strength under 10 kg/cm² compression is 10-1400 (N/²) and the loose apparent density is 0.10-0.50 (g/cm³), and wherein the cohesive properties and adhesive force between toner particles during compressive toner transfer is suitably controlled, the toner has excellent developing properties, and can form a high quality image.

This mechanism is still being studied, but the following may be concluded from the analytical data.

By controlling the tensile fracture strength during 10 kg/cm² compression to be 10-1400 (N/m²) and more preferably 100-1200 (N/m²), the ease with which toner particles can be separated during transfer compression and cohesion, can be controlled. By arranging the tensile fracture strength to be 1400 N/m² or less, toner which is stuck together can peel away, little toner remains on the electrostatic image bearing member or transfer material, and soiling due to poor toner transfer can be prevented. Further, by increasing the transfer efficiency, the toner which is lost during cleaning can be reduced, and the toner consumption amount can be reduced due to the transfer of a smaller amount of toner. If however the tensile fracture strength is less than 10 (N/m²), the adhesive force between toner particles during compression is too small, and this gives rise to toner dust during transfer. As a result, line reproducibility decreases, and a satisfactory image density cannot be achieved.

Here, the bulk density at 10 kg/cm² compression was measured because the value at 10 kg/cm² gives the best correlation with properties. It may also be possible in some cases to perform identical tests at other compressive forces if they are sufficient and suitable, e.g., 5 kg/cm² or 20 kg/cm².

By simultaneously controlling the loose apparent density to be 0.10-0.50 (g/cm³), and preferably 0.30-0.50 (g/cm³), the bulk density of the toner when not under compression is controlled. Hence, it was possible to provide a toner and developer with high fluidity and uniform charge which gave a high quality image with little image density fluctuation, and also to provide a toner for electrophotography having excellent charging properties in high temperature, high humidity and low temperature, low humidity environments with little weakly charged or oppositely charged toner which can form an image without much soiling. When the loose apparent density is less than 0.10 (g/cm³), the bulk density is too high which gives rise to toner transfer dust during transfer. In particular, when the toner is laminated in full color, unfixed toner layers have a high bulk density and easily cause toner dust which is undesirable if however the loose apparent density exceeds 0.50 (g/cm³), sufficient fluidity cannot be guaranteed, toner refill properties and charging of toner and developer are impaired, and an image with a large amount of image density fluctuation is obtained which is undesirable.

In a toner having a volume average particle diameter of 3-10 μm, in order to ensure the aforementioned tensile fracture strength and loose apparent density, it is preferred to improve transfer properties, fluidity and environmental charge stability by including at least two types of hydrophobically-treated fine inorganic articles in which the average particle diameter of primary particles is 1-100 nm. By performing hydrophobic treatment, environmental stability is improved, and by specifying the average particle diameter of primary particles to be 1-100 nm and more preferably 5 nm-70 nm, sufficient fluidity can be obtained together with a toner space effect and coating effect. If the average particle diameter is less than 1 nanometer, the toner space effect is insufficient, environmental stability and environmental charge stability decrease, and fluidity decreases which is undesirable.

By including at least two types of these fine inorganic particles, fine inorganic particles having different charging properties, such as for example silica and titanium oxide (two types of silica with different particle diameters and surface treatment agent) can be balanced, and charging environment stability as well as charging properties can be further improved. It is preferred that the volume average particle diameter of toner is 3-0 μm, and more preferred that it is 5-7 μm. If the volume average particle diameter of the toner is less an 3 μm toner manufacturing properties and productivity decline, and toner is absorbed by human workers which is undesirable for health. If on the other hand it exceeds 10 μm, the granularity of the image decreases which is undesirable.

Further, by including at least two types of fine inorganic particles in which the average particle diameter of primary particles is 20 nm or less, and including at least one type of fine inorganic particle of 30 nm or more, fluidity can be ensured while embedding of the fine inorganic particles when the toner degenerates can be prevented. With fine inorganic particles of 20 nm or less, fluidity, environmental stability and charging properties are guaranteed. On the other hand, with fine inorganic particles of 30 nm or more, embedding of fine inorganic particles in the toner when the toner degenerates, which tends to occur when toner inflow/outflow is small, is prevented, toner spent is prevented and toner fluidity is maintained.

When transfer properties and fluidity are improved, the thermophysical properties of the toner also vary. By controlling the softening point of the toner to be 60-150° C. and more preferably 90-120° C., and by controlling the glass transition point (Tg) to be 40-70° C. and more preferably 50-70° C., a toner having excellent fixing properties, color reproducibility, color brightness, color transparency and transfer properties can be obtained.

By controlling the number average molecular weight (Mn) of this toner to the 2000-8000, the weight average molecular weight/number average molecular weight (Mw/Mn) to be 1.5-20 and at least one peak molecular weight (Mp) to be 3000-7000, a toner having a tensile fracture strength under 10 kg/cm² lying in the range 10-1400 (N/m²) which can also be fixed at low temperature, and having excellent fixing properties, color reproducibility, color brightness, color transparency and transfer properties, can be obtained.

By arranging that the binder resin in the toner comprises at least a polyol resin, sufficient compression strength, tensile fracture strength, environmental stability and stable fixing properties are obtained, and by arranging that the binder resin in the toner comprises at least an epoxy resin unit and polyoxyalkalene unit in the main chain, environmental stability and stable fixing properties are obtained while migration of the toner image to polyvinylchloride resin in a copy fixing image surface to a sheet when it is brought in intimate contact with the sheet, is prevented. In particular, when a color toner is used, color reproducibility, stable gloss and curl prevention of the copy fixing image can be obtained.

By arranging that the binder resin of the toner comprises at least a polyol resin unit and a polyester resin unit, the toner has good compression strength together with well-balanced expansion/contraction properties and adhesion properties, and stable transfer properties, developing properties and fixing properties are also obtained.

If the toner contains at least a wax which is used as a mold release agent, by arranging that the dispersion diameter of the wax in the toner is 3 μm or less, more preferably 2 μm or less and still more preferably 1 μm or less, hot offset, a process wherein the wax used as a mold release agent during toner fixing oozes out due to heat, is prevented. Also, the adhesion force between toner particles is reduced, transfer properties and transfer rate are improved, and dropout of the image in the character parts is prevented.

By using a developer for electrophotography comprising at least the aforementioned toner and a carrier containing magnetic particles, charging properties in good balance to the adhesive force of the carrier and developing properties having excellent environmental charge stability are obtained.

If the ends of the polyol resin in the toner binder resin are inactive, a toner having environmental stability and little toxicity can be obtained.

The epoxy resin used in the present invention is preferably obtained by combination of a bisphenol such as bisphenol A or bisphenol P with an epichlorhydrin. In order that the epoxy resin has stable fixing properties and gloss, it preferably comprises at least two or more bisphenol A epoxy resins of different number average molecular weight, the number average molecular weight of the low molecular weight component being 360-2000, and the number average molecular weight of the high molecular weight component being 3000-10000. It is also preferred that the low molecular weight component accounts for 20-50 wt %, and the high molecular weight component accounts for 5-40 wt %. If the lower molecular weight component is excessive or its molecular weight is lower than a molecular weight of 360, gloss is too high, and storage properties may be adversely affected. Conversely, if the high molecular weight component is excessive or the molecular weight is higher than a molecular weight of 10000, gloss is insufficient and fixing properties may be adversely affected.

Of the compounds used in the present invention, the following are examples of alkylene oxide adducts of biphenols, e.g., the reaction products of ethylene oxide, propylene oxide, butylene oxide or their mixtures with a bisphenol such as bisphenol A or bisphenol F. The adducts obtained may also be used by converting to a glycidyl derivative with epichlorhydrin or β-methyl epichlorhydrin. The diglycidyl ether of the alkylene oxide adduct of bisphenol A represented by the following general formula (1), is particularly preferred.

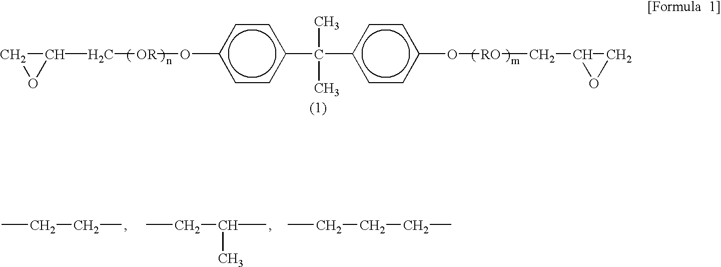

where n, m are numbers of repeating units both equal to one or more, and n+m=2-8 but preferably 2-6.

It is preferred that the alkylene oxide adduct of the biphenol or its glycidyl ether is contained in the polyol resin to the extent of 10-40 wt %. If the amount is less than this, there are such disadvantages as more curl, and if n+m is larger than 8 so that the amount is excessive, there is too much gloss and storage properties may be adversely affected.

Compounds having one hydrogen in the molecule which reacts with the epoxy group used in the present invention include monofunctional phenols, secondary amines and carboxylic acids. The following are examples of monofunctional phenols; phenol, cresol, isopropyl phenol aminophenol, nonyl phenol, dodecyl phenol, xylenol, p-cumyl phenol, and the like.

Examples of secondary amines include diethylamine, dipropylamine, dibutylamine, N-methyl (ethyl) piperazine and piperidine.

Examples of carboxylic acids are propionic add, caprolactic acid, and the like.

To obtain the polyol resin of the present invention comprising an epoxy resin unit and alkylene oxide unit in the main chain, combinations of various starting materials can be used. For example, the alkylene oxide adduct of an epoxy resin having a glycidyl group at both ends, and a biphenol having a glycidyl group at both ends, can be obtained by reacting with a dihalide, diisocyanate, diamine, dithiol, polyphenol or dicarboxylic acid. Of these, reaction with a biphenol is preferred from the viewpoint of reaction stability. Further, it is preferred to use a polyphenol or polybasic carboxylic acid in conjunction with the biphenol to the extent that it does not gel. Here, the amount of polyphenol or polybasic carboxylic acid is 15 percent or less, and preferably 10 percent or less, relative to the total amount. Examples of compounds having two or more active hydrogens in the molecule which react with the epoxy group used in the present invention are biphenols, polyphenols and polybasic carboxylic acids.

Examples of biphenols are bisphenols such as bisphenol A and bisphenol F. Examples of polyphenols are orthocresol novolac, phenol novolac, tris (4-hydroxyphenol) methane and 1-[α-methyl-α-(4-hydroxyphenyl) ethyl] benzene. Examples of polybasic carboxylic acids are malonic acid, succinic acid, glutaric acid, adipic acid, maleic acid, fumaric acid, phthalic add, terephthalic acid, trimellitic acid and anhydrous trimellitic acid.

By using a polyol resin having an epoxy resin unit, a polyoxyalkalene unit and polyester unit in the resin used in the present invention, the viscoelasticity and hardness of the resin change due to the polyester component, the resin composition becomes softer, and image curl is suppressed.

By controlling the epoxy equivalent of the binder resin to be 10000 or more, preferably 30000 or more and more preferably 50000 or more, the thermal properties of the resin can be controlled, the amount of low molecular weight epichlorhydrin and other reaction residues can be reduced, and a toner having excellent safety and resin properties is obtained.

In an image-forming device for electrophotography, in which an electrostatic image on an electrostatic image bearing member is developed by an electrostatic image developer to form a toner image, a transfer is brought into contact with the electrostatic image bearing member surface via a transfer material so that this toner image is electrostatically transferred to the transfer material, the developer used being a two-component developer comprising a carrier containing magnetic particles and the aforementioned toner, a high-quality image without image defects or transfer errors was obtained.

In an electrophotographic developing device wherein electrostatic images divided into plurality of colors on an electrostatic image bearing member are developed by an electrostatic image developer to form a toner image, a transfer is brought into contact with the electrostatic image bearing member surface via a transfer material so that this toner image is electrostatically transferred to the transfer material on plurality of occasions or in one operation, the developer used being a two-component developer comprising a carrier coning magnetic particles and the aforementioned toner, there were few unsuccessful transfers, and a high-quality image with few image defects relating to color reproducibility was obtained.

Further, in an electrophotographic/developing method used for an electrophotographic device wherein latent electrostatic images divided into plurality of colors formed on electrostatic image bearing members are developed on plurality of electrostatic image bearing members corresponding to respective colors by developers corresponding to each color, by plurality of multi-color developing units comprising developing rollers and developing blades which render the layer thickness of developer supplied to these developing rollers uniform, and wherein a transfer is brought into contact with the electrostatic image bearing member surface via a transfer material so that these toner images are successively electrostatically transferred to the transfer material, the developer used being a one-component developer comprising the toner, there were few unsuccessful transfers, a high-quality image with few image defects relating to color reproducibility was obtained, and a compact image-forming device was obtained.

In an image-forming device which first transfers a toner image formed on an electrostatic image bearing member to an intermediate transfer body, and then transfers this toner image to a transfer material which comprises the aforementioned toner, there nature of the transfer material, i.e. OHP or thick paper, etc., bad little effect, there were few unsuccessful transfers, and a high-quality image with few image defects was obtained.

By using an image-forming device wherein the static friction coefficient of the intermediate transfer body is 0.1-0.6 and preferably 0.3-0.5, transfer properties are further improved, there is not much soiling, the lost toner amount is small and the toner consumption amount is small.

In a tandem color image-forming device, wherein images formed by plurality of image-forming units disposed along a transfer belt stretched between a belt drive roller and a belt driven roller, are transferred successively one after another to a single transfer material transported by the transfer belt so as to obtain a color image on the transfer material, this device comprising the aforementioned toner, high-speed printing is possible, the transfer material such as OHP, thick paper or coated paper has little effect there were few unsuccessful transfers, and a high-quality image with few image defects was obtained.

It is a further object of the present invention to provide an image-forming device which stably maintains the following properties 1-10 even after outputting several tens of thousands of images.

1. Cohesive properties after stress during toner transfer compression and in the developer are excellent, adhesive force between toner particles is suitably controlled while transfer, developing and fixing are excellent, and a high-quality image which is not much affected by the nature of the transfer material is obtained.

2. Charging properties in a high temperature, high humidity or low temperature, low humidity environment are excellent and there is little weakly charged or oppositely charged toner, little soiling of the image and little scatter of toner inside the toner unit.

3. High durability and low maintenance as an image-forming system are obtained.

4. Transfer properties during toner compression are excellent, and there is sufficient fluidity when the toner is not compressed so that refill and charging properties are excellent.

5. The toner and developer have excellent environmental stability, and further, there is no color bluing from low printing speeds to high printing speeds, no decrease of image density after continual image output, and well-balanced fixing properties and non-offset properties.

6. Toner is transferred properly, color reproducibility, color brightness and color transparency are excellent, and the image has stable gloss without any unevenness.

7. Environmental stability and environmental storage properties are excellent.

8. Even if the fixed image surface is brought into intimate contact with a polyvinyl chloride resin sheet, there is no transfer of toner image to the sheet.

9. The fixed image does not curl.

10. In an image-forming device wherein a toner image formed on a latent electrostatic image bearing member is first transferred to an intermediate transfer body, and this toner image is then transferred to a transfer material, or wherein high speed output is possible by the tandem method, abnormal images such as moth-eaten images, image dust or defects in line reproducibility can be prevented.

As a result of extensive studies to achieve the above objects, the inventors discovered that, in an image-forming device comprising at least a toner and a latent electrostatic image bearing member, wherein a toner image formed on the latent electrostatic image bearing member is first transferred to an intermediate transfer body, and this toner image is then transferred to a transfer material, if the tensile fracture strength of the toner was 10-1400 (N/m²) during 10 kg/cm² compression, the ionization potential (IP) difference between the toner and the latent electrostatic image bearing member was 0-1.0 eV or less and the IP difference between the toner and the intermediate transfer body was 0-1.0 eV or less, cohesive properties during toner transfer and compression were excellent, transfer properties were such that the adhesive force between toner particles after stress in the developer could be suitably controlled, and a high-quality image with excellent developing properties could be obtained.

Regarding the tensile fracture strength characteristics under 10 kg/cm², by making the IP difference between the toner and latent electrostatic image bearing member, and between the toner and intermediate transfer body, 0-1.0 eV as described above, the charging level between the toner and latent electrostatic image bearing member, and between the toner and intermediate transfer body, is within the optimum range, so toner retention, transfer and peel-off are easier. Specifically, if the IP difference is set higher than 1.0 eV, the charge level is too far from that of the toner, so toner retention and toner peel-off are no longer possible, some of the toner remains after transfer, the image is moth-eaten or transfer dust is produced due to an electrical reaction, while the toner consumption amount increases due to a drop in the toner transfer rate and soiling occurs.

By making the image-forming device a functionally separate photoconductor comprising at least a charge conducting substrate, charge generating layer, charge transferring layer and filler-reinforced charge transporting layer, the charge on the photoconductor surface is transferred smoothly, and toner transfer, retention and peel-off are easier. Also, by providing the filler-reinforced charge transporting layer, there is little wear of the photoconductor surface even after printing several tens of thousands of sheets, photoconductor surface properties after printing are good, there are few unsuccessful transfers and a high-quality image with few defects is obtained.

Further, by providing an electronic photoconductor wherein the charge transferring layer of the latent electrostatic image bearing member comprises at least a charge transferring material (CTM) and a polycarbonate resin (R) having a viscosity average molecular weight of 30000-60000, and their compositional ratio (CTM/R) is 5/10 to 10/10 in terms of weight ratio, sufficient strength and hardness, together wit high-speed charge transferring properties, are obtained.

The polycarbonate resin which is the binder resin in the charge transferring layer (CTL) according to the present invention has a high wear resistance. Therefore, in a charge transferring layer having a compositional ratio such that there is more polycarbonate resin relative to the charge transferring material, a high wear resistance could be obtained. However, in such a CTL, the required electrical properties, charge implantation from the CGL and charge transferring in the CTL, i.e., high-speed response, cannot be obtained, and the rise of residual potential is also marked. If a large amount of the charge transferring material (CTM) is provided, charge implantation properties and high-speed response are obtained, but wear resistance declines. Therefore, it is convenient that the compositional ratio (CTM/R) of the charge transferring material (CTM) and polycarbonate resin (R) is 5/10 to 10/10.

If the charge transferring layer (CTL) is a thick layer, the decrease of charging properties due to cutting is reduced, but high-speed response falls as a result. Also, if a polycarbonate resin having a high viscosity average molecular weight is used to coat the CTL layer, a uniform layer cannot be obtained. In order to obtain a thick layer coating, it is necessary to decease the viscosity average molecular weight of the polycarbonate resin, and increase the solids concentration in the coating liquid, but the wear resistance then decreases. Therefore, when the CTM/R ratio is 5/10-10/10 and the molecular weight of R is 30000 to 60000, a thick CTL layer with little decrease in charging properties due to cutting can be applied. When the molecular weight is less than 30000, sufficient layer strength is not obtained and when it exceeds 60000, coating properties decline so that a sufficiently uniform layer cannot be formed, toner charge retention on the latent electrostatic image bearing member surface is non-uniform, and an image having excellent color reproducibility is not obtained.

By using an image-forming device wherein the intermediate transfer body is an elastic intermediate belt having a hardness of 10°≦HS≦65° (JIS-A), a high quality image with no moth-eaten parts, excellent transfer properties and good line reproducibility can be formed. The optimum hardness must be adjusted depending on the layer thickness of the belt. Also, the hardness of the intermediate transfer body can be adjusted by controlling the material (polymer, etc.), molecular structure, type of crosslinking and degree of crosslinking of the intermediate transfer body. If the hardness is less than 10° (JIS-A), it is very difficult to form the body with good dimensional precision. This is due to the ease with which molding is affected by contraction/expansion. In order to soften it, an oil component may generally be included in the substrate, but if operation is continued in the pressurized state, the oil component oozes out. From this, it was found that the photoconductor in contact with the intermediate transfer body surface became soiled, causing horizontal undulations. In general, a surface layer is provided to improve mold release properties, but as the surface layer is required to have high durability in order to completely prevent oozing, selection of materials and maintenance of properties is difficult. If however the hardness exceeds 65° (JIS-A), the dimensional precision increases by a corresponding amount and it is possible to avoid the oil component or suppress it low. The soiling properties of the photoconductor are thereby reduced, but transfer properties such as image-dropouts can cannot be improved, and it is difficult to stretch it over the roller.

The toner for electrophotography of the present invention comprises a binder resin; and a colorant, the toner has a tensile fracture strength of 10-1400 (N/m²) under 10 kg/cm² compression, and a loose apparent density of 0.10-0.50 (g/cm³).

the toner for electrophotography of the present invention further comprises at least two or more inorganic fine particles having hydrophobically-treated primary particles in which an average particle diameter is 1-100 nm, and the toner has a volume average particle diameter of 3 μm to 10 μm.

The toner for electrophotography of the present invention further comprises at least two or more inorganic fine particles having hydrophobically-treated primary particles in which an average particle diameter is 1-100 nm; and at least one or more inorganic fine particles having hydrophobically-treated primary particles in which an average particle diameter is 30 nm or more.

In the toner for electrophotography of the present invention, the toner has a softening point of 60-150° C., a flow start temperature of 70° C.-130° C., and a glass transition point (Tg) of 40-70° C.

In the toner for electrophotography of the present invention, the toner for electrophotography has a number average molecular weight (n) of 2000-8000, the weight average molecular weight/number average molecular weight Mw/Mn) of 1.5-20, and having at least one peak molecular weight (Mp) of 3000-7000.

In the toner for electrophotography of the present invention, the binder resin comprises a polyol resin.

In the toner for electrophotography of the present invention, the polyol resin is an epoxy resin having a polyoxyalkylene portion in the main chain.

In the toner for electrophotography of the present invention, the binder resin comprises at least a polyol resin unit and a polyester resin unit.

In the toner for electrophotography of the present invention, the toner comprises at least a wax having a dispersed average particle diameter of 3 μm or less.

The toner for electrophotography of the present invention comprises a toner for electrophotography; and a carrier containing magnetic particles, wherein the toner for electrophotography comprises: a binder resin; and a colorant, wherein the toner for electrophotography has a tensile fracture strength of 10-1400 (N/m²) under 10 kg/cm² compression, and a loose apparent density of 0.10-0.50 (g/cm³).

The image-forming device of the present invention comprises a latent electrostatic image being member; a charger for charging the latent electrostatic image bearing member; a light irradiator for irradiating the latent electrostatic image bearing member to a light to form a latent electrostatic image; an image developer for developing the latent electrostatic image with a developer for electrophotography to form a visible developed image; and a transfer for transferring the visible developed image to a transfer medium., wherein the developer for electrophotography comprises a toner for electrophotography which comprises: a binder resin; and a colorant, wherein the toner for electrophotography has a tensile fracture strength of 10-1400 (N/m²) under 10 kg/cm² compression, and a loose apparent density of 0.10-0.50 (g/cm).

In the image-forming device of the present invention, the developer for electrophotography is a one-component developer.

In the image-forming device of the present invention, the developer for electrophotography is a two-component developer comprising a carrier containing magnetic particles.

In the image-forming device of the present invention, the image developer forms the visible developed image by applying developers for electrophotography comprising a plurality of colors onto the latent electrostatic image which is divided into a plurality of colors, and the transfer transfers the developed image to the transfer material by one of a single operation and a plurality of operations.

In the image-forming device of the present invention, the image developer comprises a plurality of developing units for individual colors, the developing unit comprises: a developing roller; and a developing blade for uniformly controlling a thickness of the developer supplied onto the developing roller, and the image developer develops the respective latent electrostatic images formed on the respective developing rollers in the developing units using the developers of corresponding colors, and the transfer transfers the developed image to the transfer material by one of a single operation and a plurality of operations.

In the image-forming device of the present invention, the transfer comprises: an intermediate transfer body; a first transferer which transfers the developed image from the latent electrostatic image bearing member to the intermediate transfer body; and a second transferer which transfers the developed image from the intermediate transfer body to the final transfer material, wherein the developed image formed on the latent electrostatic image bearing member is first transferred to the intermediate transfer body, and second transferred to the final transfer material.

In the image-forming device of the present invention, the intermediate transfer body has a static coefficient of friction in the range of 0.1-0.6.

In the image-forming device of the present invention, the image forming device is a direct transfer type tandem color image forming device comprising an image-forming unit which comprises: a latent electrostatic image bearing member; a charger; a light irradiator; and an image developer, the image forming unit is disposed in plurality of along a transfer belt stretched between a belt drive roller and a belt driven roller, and the direct transfer type tandem color image forming device transfers the developed images formed on each of the latent electrostatic image bearing members by sequentially superimposing onto a single transfer member carried on the transfer belt, in which the transfer member is located in a state to touch the latent electrostatic image bearing member.

In the image-forming device of the present invention, the image forming device is an indirect transfer type tandem color image forming device comprising an image-forming unit which comprises: a latent electrostatic image bearing member; a charger; a light irradiator; and an image developer, the image forming unit is disposed in plurality of along a transfer belt stretched between a belt drive roller and a belt driven roller, and the indirect transfer type tandem color image forming device first transfers the developed images formed on the latent electrostatic image bearing member by separately superimposing onto an intermediate transfer body to form a developed image, and second transfers the developed image to a final transfer material to obtain a color image, in which the intermediate transfer member is located in a state to touch the latent electrostatic image bearing member.

The image-forming device of the present invention comprises: a latent electrostatic image bearing member; a charger for charging the latent electrostatic image bearing member; a light irradiator for irradiating the latent electrostatic image bearing member to a light to form a latent electrostatic image; an image developer for developing the latent electrostatic image with a developer to form a visible developed image; and a transfer for transferring the visible developed image to an intermediate transfer body, and then to a transfer medium, wherein the developer is a one-component developer comprising a toner for electrophotography having a tensile fracture strength of 10-1400 (N/m²) under 10 kg/cm² compression, and an ionization potential (IP) difference between the toner for electrophotography and the latent electrostatic image bearing member is 0-1.0 eV, and an EP difference between the toner for electrophotography and the intermediate transfer body is 0-1.0 eV or less.

In the image-forming device of the present invention, the toner for electrophotography comprises at least two or more inorganic fine particles having hydrophobically-treated primary particles in which an average particle diameter is 1-100 nm, and the toner for electrophotography has a volume average particle diameter of 2 μm to 8 μm.

In the image-forming device of the present invention, the toner for electrophotography has a softening point of 60-150° C., a flow start temperature of 70° C.-130° C., and a glass transition point of (Tg) of 40-70° C.

In the image-forming device of the present invention, the toner for electrophotography has a number average molecular weight (Mn) of 2000-8000, the weight average molecular weight/number average molecular weight (4 w/M) of 1.5-20, and at least one peak molecular weight (Mp) of 3000-7000.

In the image-forming device of the present invention, the toner for electrophotography comprises a binder resin which comprises a polyol resin, and the polyol resin is an epoxy resin having a polyoxyalkylene portion in the main chain.

In the image-forming device of the present invention, the toner for electrophotography comprises a wax, and a dispersed average particle diameter of the wax in the toner for electrophotography is 0.001-3 μm.

In the image-forming device of the present invention, the latent electrostatic image bearing member is a function separated electronic photoconductor comprising: an electroconductive substrate; a charge generating layer; a charge transporting layer; and a filler-reinforced charge transporting layer, wherein the charge transporting layer comprises at least a charge transferring material (CTM) and a polycarbonate resin (R) having a viscosity average molecular weight of 30,000 to 60,000, and the compositional ratio (CTM/R) of 5/10 to 10/10 in terms of weight ratio.

In the image-forming device of the present invention, the intermediate transfer body is an elastic belt having a hardness of 10°≦HS≦65° (JIS-A).

In the image-forming device of the present invention, the intermediate transfer body has a static coefficient of friction in the range of 0.1-0.6.

The image-forming method of the present invention comprises a step for charging a latent electrostatic image bearing member, a step for irradiating the latent electrostatic image bearing member to a light to form a latent electrostatic image; a step for developing the latent electrostatic image with a developer for electrophotography to form a visible developed image; and a step for transferring the visible developed image to a transfer medium, wherein the developer for electrophotography comprises a toner for electrophotography which comprises: a binder resin; and a colorant, the toner for electrophotography has a tensile fracture strength of 10-1400 (N/m²) under 10 kg/cm² compression, and a loose apparent density of 0.10-0.50 (g/cm³).

The image-forming method of the present invention comprises a step for charging a latent electrostatic image bearing member, a step for irradiating the latent electrostatic image bearing member to a light to form a latent electrostatic image; a step for developing the latent electrostatic image with a developer for electrophotography to form a visible developed image; and a step for transferring the visible developed image to an intermediate transfer body, and then to a transfer medium, wherein the developer for electrophotography is a one-component developer comprising a toner for electrophotography having a tensile fracture strength of 10-1400 (N/m²) under 10 kg/cm² compression, and an ionization potential (IP) difference between the toner for electrophotography and the latent electrostatic image bearing member is 0-1.0 eV, and an IP difference between the toner for electrophotography and the intermediate transfer body is 0-1.0 eV or less.

### BRIEF DESCRIPTION OF THE DRAWINGS

FIG. 1 is a schematic view showing an example of one embodiment of the present invention.

FIG. 2 is a schematic view showing an example of one embodiment of the present invention.

FIG. 3 is a schematic view showing an example of one embodiment of the present invention.

FIG. 4 is a schematic view showing an example of one embodiment of the present invention.

FIG. 5 is a schematic view showing an example of one embodiment of the present invention.

FIG. 6 is a schematic view showing an example of one embodiment of the present invention.

FIG. 7 is a figure illustrating a process cartridge of the present invention,

### DESCRIPTION OF THE PREFERRED EMBODIMENTS

The present invention will now be described in detail. Here, the system relating to the electrophotography process comprising the toner used in the invention, developer manufacturing method, materials and transfer belt may be those known in the art provided they satisfy certain conditions.

(Tensile Fracture Strength)

The tensile fracture strength measurement under 10 kg/cm² compression of the present invention, means the maximum tensile fracture strength (N/m²) measured using, for example, the powder layer compression/tensile property measuring device shown below (Aggrobot: Honkawa Micron Corporation.). A fixed amount of powder is packed into a cylindrical cell split into an upper and lower part under the conditions below, the powder is maintained under a pressure of 10 kg/cm², and the upper cell is raised. The tensile fracture strength is measured when the powder layer fractures.

If the tensile fracture strength measurement is performed according to the above principle, the above apparatus and conditions are however not indispensible.

Measurement Conditions

Sample amount: 8 g

Ambient temperature: 23° C.

Humidity: 50%

Cell inside diameter: 25 mm

Cell temperature: 25° C.

Spring line diameter: 1.0 mm

Rate of compression: 0.1 mm/sec

Compressive stress: 10 kg/cm²

Compression retention time: 60 seconds

Tensile velocity: 0.04 mm/sec

The tensile fracture strength can be adjusted by manufacturing conditions such as the type of fluidizer added to the toner, the type and added amount of surface treatment agent used as fluidizer, and the mixing adhesion with the toner. To reduce the tensile fracture strength, it is effective to use a fluidizer having a small specific surface, increase the amount of fluidizer, make the mixing conditions less severe, use an ultrasonic vibration screen in the elutriation step after mixing to prevent decrease of fluidizer, and use a technique to prevent cohesion between the fluidizer and toner. By combining these techniques, the aforementioned tensile fracture strength can be obtained.

(Loose Apparent Density)

The loose apparent density of the toner in the present invention is measured using a powder tester (Honkawa Micron Corporation, PT-N). A 246 μm screen is set on a vibrating platform, and 250 cc of the sample is placed thereon and vibrated for 30 seconds. After scraping off excess toner on the cup with the blade supplied, the weight is measured. This procedure is repeated 5 times and the average value is taken as the measured value. With PT-N, the measurement value is displayed automatically. The loose apparent density=weight (g)/volume of cup (100 cc). If the tensile fracture strength measurement is performed according to the above principle, the above apparatus and conditions are however not indispensible.

(Ionization Potential)

Ionization potential in the present invention was measured using a photoelectron emission measuring apparatus in atmospheric air. The measurement conditions are as follows.

(1) Apparatus: AC-1, Riken Keiki

(2) U V light source: 1000 nW xenon lamp light source

(3) Energy range of incident light: 3.4 eV to 6.2 eV

(4) Power: 1

(5) The toner was measured by placing approximately 20 mg of powder on an aluminium plate measuring approximately 10 mm by 10 mm, flattening it, and setting it in the apparatus. The latent electrostatic image bearing member and intermediate transfer body were measured by cutting them out to a size (about 10 mm by 10 mm) which could be set in the apparatus, and fashioning them into a layer sufficiently thin to be given suitable electroconductivity.

(6) The work function was deduced by the software attached to the apparatus.

If the measurement is performed according to the above principle, the above apparatus and conditions are however not indispensible.

(Softening Point, Efflux Initiation Temperature)

The softening point of the toner of the present invention was measured using a softening point apparatus (Mettler-Toledo K.K, FP90). The softening temperature and efflux initiation temperature were measured with a temperature increase rate of 1° C./min.

(Glass Transition Point (Tg))

Tg of the toner of the present invention was measured using the differential scanning type calorimeter described below, under the following conditions.

Differential scanning calorimeter: SEIKO1DSC100

SEIKO1SSC5040 (Disk Station)

Measurement conditions

Temperature range: 25-150° C.

Temperature increase rate: 10° C./min

Sampling time: 0.5 sec

The sample amount: 10 mg

(Molecular Weight)

The number average molecular weight (Mn) weight-average molecular weight (Mw) and Mp were measured by GPC (gel permeation chromatography), as follows. 80 mg sample was dissolved in 10 ml THF to prepare a sample liquid. This was filtered by a 5 μm filter, 100 microliters of this sample liquid was introduced into a column, and the retention time was measured under the following conditions. The retention time was measured using polystyrene of known average molecular weight as the standard substance, and the number average molecular weight of the sample was found by polystyrene conversion from an analytical curve prepared beforehand.

Column: Guard column+GLR400M+GLR400M+GLR400 (all manufactured by Hitachi, Ltd.)

Column temperature: 40° C.

Mobile phase (flowrate): THF (1 ml/min):

Peak detection method: UV (254 nm):

(Epoxy Equivalent)

The epoxy equivalent was found by the indicator titration method shown in 4.2 of JIS K7236.

(Penetration)

Toner was weighed out 10 g at a time, introduced into a 20 cc glass vessel, and left for 5 hours in a constant temperature bath set at 50° C. The penetration was measured by a penetration gauge.

(Coefficient of Static Friction)

The coefficient of static friction was measured as follows.

According to this aspect of the invention, a portable static friction meter (Shinto Kagaku Ltd., HEIDON Tribogear Muse TYPE94i200) was used. The static friction meter has a pressure plate inserted on the belt inner circumference side to make the contact between the photoconductor belt the intermediate transfer body and the planar pressure element of the static friction meter, uniform. Here, drum-shaped members may be used instead of the photoconductor belt and intermediate transfer body. In this case, the contact surface area decreases somewhat and there is some increase in the scatter of the data, but this is not a problem due to averaging or the like.

The static friction coefficient can be obtained by measuring the maximum frictional force acting between the planar pressure element installed underneath the static friction meter and the belt and taking the ratio of the forces which push against each other in a vertical direction. This planar pressure element is a metal probe of φ 40, and it presses lightly with a force of approximately 40 gf so that it does not scratch the belt surface, and the like. For the measurement, a damper is also placed between the planar pressure element and the belt. En this aspect of the invention, a thin cloth was used for the damper, but a natural fiber such as cotton, hemp, and the like, a synthetic resin fiber such as rayon, polypropylene, a metal fiber, a nonwoven fabric and the like may also be used. In addition, foam of suitable hardness or a thin film having suitable undulations may also be used.

The reason for placing rids damper between the planar pressure element and the belt is that the intermediate transfer body (or photoconductor belt) may deform due to its surface roughness and the softness of the material itself. Also, as the toner is a powder, it follows the undulations of the belt surface and it also intimately adheres to the base of the depressions. Therefore, the static friction coefficient of the belt surface which appears as the actual adhesive force between the belt and the toner, is a measured value which comprises also the depressions in these undulations. Thus, the measurement is made using a damper of a material which can accommodate the undulation surface, which is sufficiently pliable that it does not damage the other parts in contact with it, and which can be easily spread out. In this way, an average pressure can be applied to the belt, so a precise coefficient of static friction can be obtained. The fiber bundles of the fabric used in this aspect have a size of approximately 0.5 mm, and as the fibers are approximately 5-30 μm, if they are pressed between the planar pressure element and the belt, the fibers deform appropriately, and gradually spread out so that an average pressure can be applied to the belt. The question of what to use as the damper depends on the surface roughness and pliability of the contact surfaces.

Apart from the above static friction meter, there is another method described in JP-A 08-211757, whereby a gradient is applied, the angle θ when the element begins to slip is found, and mu=tan θ. In this publication, a polyethylene terephthalate (PET) sheet is wound around the planar pressure element specified in ASTMD-1894 of HEIDON-14DR manufactured by Shinto Kagaku Ltd., a perpendicular load of 200 gf is applied between the object to be measured and the aforementioned planar pressure element, and the skid resistance between the PET sheet and sample sheet is measured when the sample sheet is displaced horizontally at a rate of 100 mm/min. However, if an extension resin material such as PET and the like is used for the pressure element, the adhesion state where the toner follows and performs according to the undulations of the intermediate transfer body as described above cannot be reproduced, so only the frictional force due to the surface projections is observed. In addition, in such a measuring instrument, as the object piece is cut out to make the sample sheet, the test is semi-destructive, and a real-time evaluation where continuous measurements are performed during running cannot be made. Therefore, a portable static friction meter is desirable. The test is not limited to the above apparatus, and if the apparatus can make measurements according to the above principles, the above apparatus and conditions are not essential.

(Dispersion Average Particle Diameter of Wax)

The dispersion average particle diameter of wax relating to the present invention can be analyzed by observing an ultra-in section of toner with a TEM (conventional transmission electron microscope). If necessary, the dispersion average particle diameter is found by scanning the TEM image into a computer, and applying image processing software.

(Binder Resin)

Examples of the binder resin of the toner of the present invention include polymers of styrene and its substitution products such as polystyrene, poly p-chlorostyrene and polyvinyl toluene and the like; styrene copolymers such as styrene-p-chlorostyrene copolymer, styrene-propylene copolymer, styrene-vinyltoluene copolymer, styrene-vinyl naphthalene copolymer, styrene-methyl acrylate copolymer, styrene-ethyl acrylate copolymer, styrene-butyl acrylate copolymer, styrene-acrylic acid octyl copolymer, styrene-methyl methacrylate copolymer, styrene-ethyl methacrylate copolymer, styrene-butyl methacrylate copolymer, styrene-α-chloromethyl methacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, styrene-maleate copolymer and the like; polymethyl methacrylate, polybutylmethacrylate, polyvinylchloride, polyvinyl acetate, polyethylene, polypropylene, polyester, epoxy resin, polyol resin, polyurethane, polyamide, polyvinylbutyral, polyacrylic resin, rosin, modified rosin, terpene resin, aliphatic or alicyclic hydrocarbon resins, aromatic, petroleum resin, chlorinated paraffin and paraffin wax and the like, these being used alone or in combination.

It is more preferred to include a polyol resin, or at least, a polyol resin comprising an epoxy resin unit and polyoxyalkylene unit in the main cha as this confers compression resistance, tensile fracture strength, environmental stability, stable fixing properties, and prevention of migration of the toner image to a PVC resin sheet when a copy fixed image surface is in intimate contact with the sheet. It is particularly preferred in a color toner, as it confers color reproducibility, stable gloss, and prevention of curl of the copy fixed image. Further, by including a polyol resin unit and polyester resin unit, the toner has compression resistance and good balance between extensibility and adhesion, and stable transfer properties, developing properties and fixing properties, which is still more preferred.

Various types of polyester resin may be used here, in particular polyester resins preferred is made from the reaction of:

(1) at least one species chosen from dicarboxylic acids, their lower alkyl esters and acid anhydrides,

(2) a diol component represented by the following general formula (2):

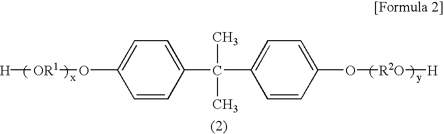

(in the formula, R¹ and R² are alkalene groups containing 2-4 carbon atoms which may be identical or different, x and y are numbers of repeating units equal to one or more, and x+y=2 to 16, and:

(3) at least one species chosen from polybasic carboxylic adds having a functionality of 3 or more, their lower alkyl esters and acid anhydrides, and polyalcohols having a functionality of 3 or more.

Here, examples of the dicarboxylic acids, lower alkyl esters and acid anhydrides in (1) include terephthalic acid, isophthalic acid, sebacic acid, isodecyl succinic acid, maleic acid, fumaric add, their monomethyl, monoethyl, dimethyl and diethyl esters, and phthalic anhydride and anhydride maleic acid. In particular, terephthalic acid, isophthalic acid and their dimethylesters are preferred from the viewpoint of antiblocking properties and cost. These dicarboxylic acids, lower alkyl esters and acid anhydrides have a large effect on toner fixing properties and antiblocking properties. Specifically, although it depends on the degree of condensation, if a large amount of aromatic terephthalic acid or isophthalic acid is used, antiblocking properties improve but fixing properties decline. Conversely, when a large amount of sebacic add, isodecyl succinic acid, maleic acid or fumaric acid is used, fixing properties improve, but anti blocking properties decline. Therefore, these dicarboxylic acids are suitably chosen depending on the composition, ratio and degree of condensation of other monomers, and may be used alone or in combination.

As examples of the diol component represented by the general formula (I) of (2), polyoxypropylene-(n)-polyoxyethylene-(n′)-2,2-bis (4-hydroxyphenyl) propane, polyoxypropylene-(n)-2,2-bis (4-hydroxyphenyl) propane and polyoxyethylene-(n)-2,2-bis (4-hydroxyphenyl) propane may be mentioned, but in particular, polyoxypropylene-(n)-2,2-bis (4-hydroxyphenyl) propane where 2.1≦n≦2.5 and polyoxyethylene-(n)-2,2-bis (4-hydroxyphenyl) propane where 2.0≦n≦2.5 are preferred.

This diol component improves the glass transition point and makes it easy to control the reaction. As examples of the diol component, aliphatic diols such as ethylene glycol, diethylene glycol 1,2-butanediol 1,3-butanediol, 1,4-butanediol, neopentyl glycol and propylene glycol can be used.

Examples of the polybasic acids, lower alkyl esters and acid anhydrides having a functionality of 3 or more in (3) are 1,2,4-benzene tricarboxylic acid (trimellitic add), 1,3,5-benzene tricarboxylic acid, 1,2,4-cyclohexane tricarboxylic acid, 2,5,7-naphthalene tricarboxylic acid, 1,2,4-naphthalene tricarboxylic add, 1,2,4-butane tricarboxylic acid, 1,2,5-hexatricarboxylic acid, 1,3-dicarboxylic-2-methyl-2-methylene carboxypropane, tetra (methylenecarboxy)methane, 1,2,7,8-octane tetracarboxylic acid, enpole trimer acid and their monomethyl, monoethyl, dimethyl and diethyl esters.

In addition, examples of the polyalcohols having a functionality of 3 or more of (3) are sorbitol, 1,2,3,6-hexane tetrol, 1,4-sorbitan, pentaerythritol, dipentaerythrytol, tripentaerythrytol, cane sugar, 1,2,4-butanetriol, 1,2,5-pentatriol glycerol, diglycerol, 2-methylpropanetriol, 2-methyl-1,2,4-butanetriol trimethylol ethane, trimethylolpropane and 1,3,5-trihydroxy methylbenzene.

Here, it is suitable if the combination proportion of polyvalent monomer having a functionality of 3 or more is approximately 1-30 mol % of the whole monomer composition. At less than 1 mol %, the offset resistance properties of the toner deteriorate and durability is easily impaired. On the other hand, at greater than 30 mol %, the fixing properties of the toner are easily impaired.

Of polyvalent monomers having a functionality of 3 or more, benzene tricarboxylic acids and anhydrides or esters of these adds are particularly preferred.

By using benzene tricarboxylic adds, both fixing properties and offset resistance properties can be obtained.

If these polyester resins or polyol resins are given a high crosslinking density, it is difficult to obtain transparency and luster, so it is preferred that there is no crosslinking, or weak crosslinking (THF insolubles 5% or less).

There is no particular limit on the method of manufacturing these binder resins, and for instance, block polymerization, solution polymerization, emulsion polymerization and suspension polymerization may be used.

(Additive)

The toner of the present invention may contain an additive if necessary. The additive may comprise fine inorganic particles or hydrophobically-treated fine inorganic particles, and preferably comprises at least two or more types of hydrophobically-treated fine inorganic particles in which the average particle diameter of primary particles is 1-100 nm, and more preferably, 5 nm-70 nm. It is still more preferred that it comprises at least two or more types of hydrophobically-treated fine inorganic particles in which the average particle diameter of primary particles is 20 nm or less, and at least one or more type of fine inorganic particles of 30 nm or more.

Those known in the art may be used provided that they satisfy the conditions. For example, they may contain silica fine particles, hydrophobic silica, metal salts of aliphatic adds (zinc stearate, aluminum stearate and the like), metal oxides (titania, alumina, tin oxide, antimony oxide the like), or a fluoropolymer.

Particularly preferred additives are hydrophobically-treated silica, titania, titanium oxide and alumina fine particles. Examples of silica fine particles include HDKH2000, HDKH2000/4, HDKH2050EP, HVK21 (Hoechst), and R972, R974, RX200, RY200, R202, R805, R812 (Japan Aerogel). Examples of titania fine particles include P-25 (Japan Aerogel) and STT-30, STT-65C-S (Titan Kogyo K.K), TAF-140 (Fuji Titanium Industry Co., Ltd), and MT-500W, MT-500B, MT-600B, MT-150A (TAYCA Corporation) and the like. Examples of hydrophobically-treated titania fine particles are T-805 (Japan Aerogel), STT-30A, STT65SS (Titan Kogyo), TAF-500T, TAF-1500T (Fuji Titanium Industry Co., Ltd), MT-100S, MT-100T (TAYCA Corporation), and IT-S (Ishihara Sangyo Kaisha., Ltd) and the like.

Hydrophobically-treated silica microparticles and alumina fine particles can be obtained by treating hydrophilic microparticles with a silane coupling agent such as methyl trimethoxysilane, methyl triethoxysilane, octyl trimethoxysilane and the like. Silicone oil-treated fine particles obtained by treating inorganic particles with a silicone oil, if necessary with heating, are also suitable.

Examples of silicone oils are dimethyl silicone oil, methylphenyl silicone oil, chlorophenyl silicone oil, methyl hydrogen silicone oil, alkyl-modified silicone oil, fluorine-modified silicone oil, polyether-modified silicone oil, ethyl alcohol-modified silicone oil, amino-modified silicone oil, epoxy-modified silicone oil, epoxy polyether-modified silicone oil, phenol-modified silicone oil, carboxyl-modified silicone oil, mercapto-modified silicone oil, acryl, methacryl-modified silicone oil and α-methylstyrene-modified silicone oil.

Examples of fine inorganic fine particles include silica, alumina, titanium oxide, barium titanate, magnesium titanate, calcium titanate, strontium titanate, iron oxide, copper oxide, zinc oxide, tin oxide, quartz sand, clay, mica, woodstone, silicon earth, chromium oxide, cerium oxide, red ocher, antimony trioxide, magnesium oxide, zirconia, barium sulfate, barium carbonate, calcium carbonate, silicon carbide, silicon nitride and the like. Of these, silica and titanium dioxide are particularly preferred. The adding amount is preferably 0.1-5 wt % and more preferably 0.3-3 wt % relative to toner. The average particle diameter of the primary particles in the fine inorganic particles is 100 nm or less, but preferably from 3 nm to 70 nm. At less than this range, the fine inorganic particles are buried in the toner and their function is not effectively implemented. At greater than this range, the photoconductor surface is unevenly scratched, which is undesirable. Here, the average particle diameter is the number average particle diameter. The particle diameter of fine inorganic particles used in the present invention can be measured by a particle diameter distribution measuring apparatus using dynamic light scattering, for example DLS-700 manufactured by Otsuka Electronics, Co., Ltd. or Coulter N4 manufactured by Coulter Electronics Inc. However, as it is difficult to dissociate secondary aggregates of particles after hydrophobic treatment it is preferable to find the particle diameter directly from a photograph obtained by a scanning electron microscope or a transmitting electron microscope. In this case, at least 100 or finer inorganic particles are observed, and the average value of their long diameter is calculated.

(Colorant)

The colorant of the toner used in the present invention may be a known dye or pigment, for example, carbon black, nigrosine dye, iron black, naphthol yellow-5, Hansa yellow (10G, 5G, G), cadmium yellow, yellow iron oxide, loess, chrome yellow, titanium yellow, oil yellow, Hansa yellow (GR, A, RN, R), pigment yellow L, benzidine yellow (G, GR), permanent yellow (NCG), Balkan F strike yellow (5G, R), tartrazine lake, chinoline yellow lake, anthragene yellow-BGL, iso-indolinone yellow, red ocher, red lead, lead vermilion, cadmium red, cadmium mercury red, antimony vermilion, permanent red 4R, paranitraniline red, fire red, p-chloro-orthonitroaniline red, re-sole fast scarlet G, brilliant fast scarlet, brilliant carmine BS, permanent red (F2R, F4R, FRL, FRLL, F4RH), fast scarlet VD, bell can fast robin B, brilliant scarlet G, re-sole rubin GX, permanent red F5R, brilliant carmine 6B, pigment scarlet 3B, Bordeaux 5B, toluidine maroon, permanent Bordeaux F2K, Herio Bordeaux-BL, Bordeaux 10B, Bonn maroon light, Bonn maroon medium, eosine lake, rhodamine lake B, rhodamine lake Y, alizarin lake, thioindigo red B, thioindigo maroon, oil red, quinacridon red, pyrazolone red, chromium vermilion, benzidine orange, Peri non orange, oil orange, cobalt blue, cerulean blue, alkali blue lake, peacock blue lake, Victoria blue lake, metal-free phthalocyanine blue, copper phthalocyanine blue, fast sky blue, indanthrene blue (RS, B C), indigo, permanent blue, Berlin blue, anthraquinone blue, fast violet B, methyl violet lake, cobalt purple, manganese purple, dioxazine violet, anthraquinone violet, chrome green, zinc green, chromium oxide, pyridian emerald green, pigment green B, naphthol green B, green gold, acid green lake, Malachite green lake, copper phthalocyanine green, anthraquinone green, titania, zinc oxide and lithopone, and mixtures thereof. In general, the application amount is 0.1-50 weight parts for 100 weight parts of binder resin.

(Masterbatch Pigment)

In the present invention, to increase the affinity between the resin and pigment, the resin and pigment may first be mixed in a ratio of about 1:1 and kneaded to make a master batch pigment. More preferably, a master batch pigment of superior environmental charge stability can be obtained by manufacturing a resin and pigment soluble in low polarity solvents and kneading with heat without using an organic solvent. The dispersibility can be further improved by using a dry powder pigment and using water to wet the resin.

Organic pigments employed as colorants are generally hydrophobic, but as water rinsing and drying steps are incorporated in the manufacturing process, water can be made to permeate the interior of pigment aggregates if a certain force is applied. When a mixture of pigment and resin where water has permeated the aggregates is kneaded at a set temperature of 100° C. or more in an open kneading machine, the water in the aggregates instanteously reaches the boiling point and undergoes volume expansion, so a force tending to break up the aggregates acts from within them. This force from within the aggregates can break them up much more efficiently than forces applied from outside. At this time, the resin is heated to a temperature equal to or higher than its softening point, so its viscosity falls and the aggregates can be wet efficiently. Simultaneously, by replacing the water close to boiling point temperature inside the aggregates in an effect similar to “flashing”, a master batch pigment wherein the pigment is dispersed in a state close to primary particles, can be obtained. Further, in the water vaporization step, as the heat of vaporization required for vaporization of the water is taken from the kneaded mixture, the kneaded mixture is maintained at a relatively low temperature below 100° C. and at low viscosity, a shear force also acts effectively on the pigment aggregates. The open kneading machine used for manufacturing the master batch pigment of the present invention may be a two roller or three roller machine. In addition, a Banbury mixer may be used as the open type, or a Mitsui Mining Corp. continuous two roller-kneading machine may be used.

(Charge Controlling Agent)

The toner of the present invention may contain a charge-controlling agent if necessary. The charge controlling agent may be one of those known in the art, for example, a nigrosine dye, triphenylmethane dye, chromium-containing metal complex dye, molybdic acid chelate pigment, rhodamine dye, alkoxyamine, quartenary ammonium salt (including quartenary fluorine-modified ammonium salts), alkylamide, phosphorus or a phosphorus compound, tungsten or a tungsten compound, fluorine type activator, metal salt of salicylic acid and metal salt of a salicylic acid derivative.

Specific examples are Bonn thoron 03 which is a nigrosine dye, Bonn thoron P-51 which is a quaternary ammonium salt, Bonn thoron S34 which is a metal-containing azo dye, E-82 which is an oxy-naphthoic acid metal complex, E-84 which is a salicylic acid metal complex, E-89 which is a phenolic condensate (manufactured by Orient Chemical Industries, Ltd.), TP-302 which is a quaternary ammonium salt molybdenum complex, TP415 (manufactured by Hodogaya Chemical, Inc.), copy charge PSYVP 2038 which is a quaternary ammonium salt, copy blue PR which is a triphenylmethane, copy charge NEGVP2036 which is a quaternary ammonium salt, copy charge NXVP434 (manufactured by Hoechst AG), LRA-901, LR-147 which is a boron complex (manufactured by Japan Carlit Co., Ltd), copper phthalocyanine, perylene, quinacridon, azo pigment, and polymer compounds having a functional group such as sulfonate, carboxyl and quaternary ammonium salt.

The usage amount of the charge-controlling agent in the present invention is determined by the kind of binder resin, the presence or absence of additives which are used as necessary, and by the toner manufacturing method including the dispersion method. It is not uniquely determined, but it is preferred that 0.1-10 weight parts of this agent is employed relative to 100 weight parts of binder resin. A range of 2-5 weight parts is satisfactory. When 10 weight parts are exceeded, the charge properties of the toner are too large, the effect of the main charge controlling agent is dampened and the electrostatic attraction force to the developing roller increases, which leads to a decrease of fluid properties of the developer and a decease of image density.

(Carrier)

When the toner of the present invention is used in a two-component developer, it may be mixed with a magnetic carrier, and it is preferred that the blending ratio of carrier and toner in the developer is 1-10 weight parts relative to 100 weight parts of carrier. The magnetic carrier may be one of those known in the art, such as iron powder of particle diameter about 20-200 μm, ferrite powder, magnetic iron ore powder, a magnetic resin carrier and the like. As coating material, an amino resin, for example urea-formaldehyde resin, melamine resin, benzoguanamine resin, urea resin, polyamide resin or epoxy resin, may be used. In addition, polyvinyl and polyvinylidene resin, acrylic resin, PMMA resin, polyacrylonitrile resin, polyvinyl acetate resin, EVA resin, PVB resin, polystyrene resins such as PS resin and styrene acryl copolymerization resin, halogenated olefin resins of polyvinylchloride, polyester resins such as PET resin and PBT resin, polycarbonate resin, polyethylene resin, poly fluorinated vinyl resin, polyvinylidene fluoride resin, polytrifluoroethylene resin, polyhexafluoropropylene resin copolymer of vinylidene fluoride and acryl monomer, copolymer of vinylidene fluoride and vinyl fluoride, fluoroterpolymer of tetrafluoroethylene, vinylidene fluoride or a non-fluorinated monomer, and silicone resins can be used. In addition, it may contain an electroconductive powder if necessary. Examples of electroconductive powders are metal powder, carbon black, titania, tin oxide and zinc oxide. It is preferred that the average particle diameter of these electroconductive powders is 1 μm or less. If the average particle diameter is larger than 1 μm, it is difficult to control the electrical resistance. In addition, the toner of the present invention may be a one-component magnetic toner which does not use a carrier, or a non-magnetic toner.

(Wax)

It is preferred that the toner or developer contains wax, in order to confer fixing mold release properties on the toner or developer. The wax has a melting point of 40-120° C., or more preferably 50 to 110° C. It may occur that fixing properties at low-temperature are insufficient when the melting point of the wax is too high, or that offset resistance and durability decline when the melting point is too low. The melting point of the wax can be found by means of differential scanning calorimetry (DSC). The melting point peak value when a sample of several milligrams is heated at a constant temperature increase rate, for example 10° C./minute, is taken as the melting point. It is preferred that the wax content is preferably 0 to 20 weight parts, but more preferred that it is 0-10 weight parts.

Examples of the wax which can be used in the present invention include solid paraffin wax, micro wax, rice wax, aliphatic acid amide wax, aliphatic acid wax, aliphatic monoketones, aliphatic acid metal salt wax, fatty acid ester wax, partially saponified fatty acid ester system wax, silicone varnish, higher alcohols and carnuba wax and the like. Polyolefins such as low molecular weight polyethylene, polypropylene and the like can also be used. In particular, polyolefins and esters having a softening point of 70-150° C., and polyolefins and esters having a softening point of 120 to 150° C. as measured by the ring and ball method, are preferred.

It was found to be effective that it contains at least one type of wax selected from carnuba wax having an acid value of 5 or less, montan ester wax, oxidized rice wax having an acid value of 10-30, and sazole wax. Camuba wax free from fatty acids is manufactured by removing free fatty acids from carnuba wax as staring material. It therefore has an acid value of 5% or less and a more microcrystalline structure than conventional carnauba wax, the dispersion average particle diameter in the binder resin is 1 μm or less, and dispersibility is improved. Montan ester wax is manufactured from ore. It has an identical microcrystalline structure to that of carnauba wax, the dispersion average particle diameter in the binder resin is 1 μm or less, and dispersibility is improved. In the case of montan ester wax, it is particularly preferred that the acid value is 5-14.

Oxidized rice wax is rice bran wax which has been oxidized by air, and its acid value is preferably 10-30. When it is less than 10, the fixing lower limit temperature rises, and low temperature fixing properties are inadequate, whereas when it is higher than 30, the cold offset temperature rises which again makes low temperature fixing properties inadequate. The sazole wax may be the sazole waxes H1, H2, A1, A2, A3, A4, A6, A7, A14, C1, C2, SPRAY30, SPRAY40, and the like manufactured by the Sazole Co., but H1, H2, SPRAY30, SPRAY40 are superior in low-temperature fixing and storage stability, and are therefore preferred. The above waxes may be used alone or in combination, good results being obtained in the proportion of 0-20 weight parts, preferably 1-15 weight parts and more preferably 2-10 weight parts relative to 100 weight parts of binder resin.

(Cleaning Improvement Agent)

It is still more preferred that a cleaning improvement agent is added to the toner or toner surface, or to the developer or developer surface, to remove developer after transfer remaining on the photoconductor or first transfer medium. Examples of such cleaning improvement agents are metal salts of fatty acids such as zinc stearate, calcium stearate, stearic acid and the like, for instance, polymer particulates manufactured, for instance, by soap-free emulsion polymerization such as polymethylmethacrylate fine particles, polystyrene fine particles and the like. It is preferred that the polymer particulates have a relatively narrow particle size distribution, and that the volume average particle diameter is 0.01-1 μm. It is preferred that the content of the cleaning improvement agent is 0-5 weight parts, and particularly preferred that it is 0-1 weight parts.

(Magnetic Material)

The toner of the present invention may comprise a magnetic material and may also be used as magnetic toner if it is used as a magnetic toner, the toner particles may contain magnetic microparticles. Examples of magnetic materials are ferrite and magnetite, metals or alloys which exhibit ferromagnetic properties such as iron, nickel and cobalt or compounds containing these elements, alloys which do not contain ferromagnetic elements but which are made to exhibit ferromagnetic properties by suitable heat treatment, for example so-called Heusler alloys comprising manganese and copper such as manganese-copper-aluminium and manganese-copper-tin, chromium dioxide and others. It is preferred that the magnetic material is evenly dispersed in the form of microparticles having an average particle diameter of 0.1-1 μm. It is preferred that the blending proportion of the magnetic material is 10-70 weight parts, and more preferred that it is 20-50 weight parts, relative to 100 weight parts of the toner obtained.

(Toner Manufacturing Method)

The method of manufacturing the toner of the present invention comprises a step for mechanically mixing a developer component comprising at least a binder resin, main charge controlling agent and pigment, a step for melt kneading, a step for crushing, and a step for grading. This also includes manufacturing methods wherein, in the mechanical mixing step or melt kneading step, powder other than particles obtained as product in the crushing or grading step are recycled to be reused.

Here, powders other than particles which are products (side products) means fine particles and coarse particles other than those of components of products having a predetermined particle diameter obtained by the crushing step, or fine particles and coarse particles of components of products having a predetermined particle diameter produced in the grading step which is performed afterwards. It is preferred that these side products are mixed with the staring material in the mixing step or melt kneading step in a weight ratio of from 99 parts starting material to one part of side product, to 50 parts of starting material to 50 parts of side product.

The mixing step which mechanically mixes developer components comprising at least a binder resin and main charge controlling agent together with pigments and side products, maybe performed under the usual conditions using an ordinary mer having rotating blades and the like, there being no particular limit thereon.

When the above mixing step is complete, the mixture is introduced into a kneading machine and is melt-kneaded. The melt kneading machine may be a continuous kneading machine having one axis or two axes, or a batch kneading machine with a roll mill. Examples are the KTK2 axis extruder made by Kobe Steel, Ltd., TEM pattern extruder made by Toshiba Machine Co., Ltd. two-axis extruder made by KCK Co., PCM2 axis extruder made by Ikegai Corporation and the Konida made by Booth Co.

It is important that this melt kneading is performed under suitable conditions so that the molecular chain of the binder resin is not cleaved. Specifically, the melt kneading temperature should take account of the softening point of the binder resin. If it is too low compared to the softening point, molecular cleavage is severe, and if it is too high, dispersion does not occur. In addition, when controlling the amount of volatile component in the toner, it is more preferable to set optimum conditions for the melt kneading temperature, time and atmosphere while monitoring the remaining amount of volatile component.

When the above melt kneading step is complete, the mixture is then crushed. In this crushing step, it is preferred that the mixture is first coarsely crushed and then finely crushed. It is desirable to crush the mixture by impact with an impact plate in a jet air current or by mechanically crushing it in a narrow gap between a rotating rotor and a stator.

After this crushing step is complete, the crushed material is graded in an air current by centrifugal force or the like, and it is therefore possible to manufacture a toner having a predetermined particle diameter, for example a volume average particle diameter of 5-20 μm. The volume average particle diameter of the toner in the range of 3-10 μm is more preferred from the viewpoints of image quality, manufacturing cost, additive, coverage efficiency, and the like. The volume average particle diameter can be measured for example by means of a COULTERTA-, (COULTERELECTRONICS, INC).

When preparing the toner, to increase the fluidity, storage properties, developing properties and transfer properties of the toner, inorganic fine particles such as the aforementioned hydrophobic silica fine particles may be further added to the toner manufactured as described above. The additive can be mixed by an ordinary powder mixer, but it is preferred to provide a jacket or the like so that the internal temperature can be adjusted. To vary the load history of the additive, the additive can be added midway during the process or intermittently. It will be understood that the rotation speed of the mixer, rolling speed, time, temperature and the like may also be varied. A strong load can first be applied followed by a relatively weak load. Examples of the mixing device which may be used are a V type mixer, rocking mixer, raidage mixer, nauta mixer, Herschel mixer or the like. Other manufacturing methods which may be used are the polymerization method and the capsule method. An outline of these manufacturing methods is given below.

(Polymerization Method)

(1) The polymerizing monomer, and a polymerization initiator and coloring agent if necessary, are granulated in an aqueous dispersion medium.

(2) The particles of the granulated monomer composition are graded to a suitable particle diameter.

(3) Particles of the monomer composition having a specified internal diameter obtained by grading, are polymerized.

(4) After suitable processing to remove the dispersing agent, the polymer product obtained as described above is filtered, rinsed and dried to give core particles.

(Capsule Method)

(1) The resin, and a colorant if necessary, are kneaded by a kneading machine to obtain a fused toner core material.

(2) The toner core material is placed in water, and stirred vigorously to obtain microfine particles of core material.

(3) The above microfine particles of core material are placed in a solution of a shell material, and a poor solvent is dripped in while stirring to cover the core material surface with the shell material.

(4) The capsules obtained above are filtered and dried to obtain core particles.

(Latent Electrostatic Image Bearing Member)

There is no particular limit on the electroconductive support body of the latent electrostatic image bearing member (photoconductor) installed in the image-forming device of the present invention. The support uses electroconductive materials having a volume resistivity of less than 10¹⁰ Ωcm, for example, metals such as aluminium, titanium, nickel, chromium, nichrome, hastelloy, palladium, magnesium, zinc, copper, gold, platina and their alloys, and metal oxides such as tin oxide, indium oxide, antimony oxide, and the like, which are coated by vapour deposition, sputtering or dispersion in a resin binder. The material is coated on a film, cylindrical plastic, paper, the aforementioned metals, metal oxides or electroconductive carbon are made into a film or dispersed in a cylindrical plastic, or aluminium, alumnium alloy, iron, nickel alloy, stainless steel alloy or titanium alloy plates may be used. These may also be D.I. or I.I. extruded and drawn into pipes, and then surface finished by cutting, super finishing and polishing.

The charge developing layer comprises a charge developing material alone, or a resin layer in which a charge developing material has been dispersed or mixed.

There is no particular limit on the charge developing material. For example, organic pigments such as sea eye pigment blue 25 [color index (CI) 21180], sea eye pigment red 41 (CI21200), sea eye add red 52 (CI45100), sea eye BASIC red 3 (CI45210), phthalocyanine pigment having a porphyrin skeleton, asrhenium salt pigment, squalic salt pigment, anthanthracone pigment, azo pigment having a carbazole skeleton (JP-A No.53-95033), azo pigment having a stilbene skeleton (JP-A No.53-138229), azo pigment having a triphenylamine skeleton (JP-A No.53-132547), azo pigment having a dibenzo thiophene skeleton (JP-A No.54-21728), azo pigment having an oxadiazole skeleton (JP-A No.54-12742), azo pigment having a fluorenon skeleton (JP-A No. 54-22834), azo pigment having a bis stilbene skeleton (JP-A No.54-17733), azo pigment having a styryl oxadiazole skeleton (JP-A No.542129), azo pigment having a styryl carbazole skeleton (JP-A No.5417734), triazo pigment having a carbazole skeleton (JP-A No.57-195767, No.57-195768), phthalocyanine pigment such as sea eye pigment blue 16 (CI74100), sea eye bat brown 5 (CI73410), indigo pigment such as sea eye bat die (CI73030), argo scarlet B (Violet Co.), and perylene pigments such as indathrene scarlet R (made by Bayer AG) can be used.

It is preferred to use a metal or metal-free phthalocyanine chemical compound (more preferably, titanyl phthalocyanine or hydroxy potassium phthalocyanine, and most preferably, a titanyl phthalocyanine having a maximum peak at a Bragg angle 2 θ of 27.2 degrees for the Cu—K α line), or an ANS anthrone chemical compound. Two or more of these may be used if necessary.

It is convenient if the layer thickness of the charge developing layer is about 0.05-2 μm, and preferred that it is 0.1-1 μm.

The charge developing layer may be formed by dispersing or mixing a charge developing material with a resin binder in a solvent, coating on a substrate or underlayer, and drying.

Examples of the resin binder are thermoplastic or thermosetting resins such as polystyrene, styrene-butadiene copolymer, styrene-acrylic nitrile copolymer, styrene-maleic anhydride copolymer, polyester, polyarylate, polyvinylchloride, chloroethylene-vinyl acetate copolymer, polyvinyl acetate, polyvinylidene chloride, acrylics, polycarbonate, cellulose acetate resin, ethyl cellulose resin, polyvinylbutyral, polyvinylacetal, polyvinylformal, phenoxy resin, polyvinyl pyridine, poly-N-vinyl carbazole, acrylic resin, silicon resin, nitrile rubber, chloroprene rubber, butadiene rubber, epoxy resin, melamine resin, urethane resin, phenol resin, alkyd resins, and the like or polymer organic semiconductors such as poly-N-vinylcarbazole, but it is not limited thereto. These binder resins may be used alone or in admixture. It is preferred that the proportion of charge developing material and binder material is 100:0-100:50 in terms of weight ratio.

The solvent may be benzene, toluene, xylene, methylene chloride, dichlorobenzene, monochlorobenzene, dichlorobenzene, ethyl alcohol, carbinol, butyl alcohol, isopropanol, ethyl acetate, butyl acetate, butanone, dioxane, tetrahydrofuran, cydohexane, methyl cellosolve, ethylcellosolve, and the like, but it is not limited to these. These solvents may also be used alone or in combination.

According to the present invention, it is preferred to provide an underlayer between the exposure layer and substrate in order to improve charge blocking properties. In general, this underlayer has a resin as its main component. Examples of the resin are water-soluble resins such as polyvinyl alcohol, casein and sodium polyacrylate, alcohol-soluble resins such as copolymer nylon, curing type resins forming a three-dimensional anastomosis such as polyurethane, melamine resin, phenol resin or epoxide resin, ceramics and the like comprising silane coupling agents or organic chelate compounds, but it is not limited thereto.

An exposure layer is provided on the underlayer. The exposure layer may have a monolayer or a laminated layer construction, but it is preferred that it has a functionally separate laminated construction comprising a charge developing layer and a charge transferring layer.

The charge transferring layer comprises a charge transferring material (CTM) and a binder resin, or a binder resin having a charge transporting function. The polymer compound which can be used as the binder component may for example be a thermoplastic or thermosetting resin such as polystyrene, styrene/acrylonitrile copolymer, styrene/butadiene copolymer, styrene/maleic anhydride copolymer, polyester, polyvinylchloride, chloroethylene/vinyl acetate copolymer, polyvinyl acetate, polyvinylidene chloride, polyarylate resin, polycarbonate, cellulose acetate resin, ethyl cellulose resin, polyvinylbutyral, polyvinylformal, polyvinyl toluene, acrylic resin, silicone resin, fluororesin, epoxide resin, melamine resin, urethane resin, phenol resin and alkyd resin, but it is not limited thereto. These polymer compounds may be used alone, a mixture of two or more may be used, or they may be copolymerized with a charge transporting material.

The charge transferring layer comprises a charge transferring material (CTM) and a polycarbonate resin (R) having a viscosity average molecular weight of 30,000 to 60,000, and the composition ratio (CTM/R ratio) is from 5/10 to 10/10 in terms of weight ratio is particularly preferred. Polycarbonate resins having various skeletons are known, and all of the polycarbonate resins known in the art may be used. For example, it may be a polycarbonate resin comprising at least one of a polymer and copolymer having a structural unit represented by the following general formula (1), general formula (2), general formula (3) or general formula (4) of the following formula 3 as its main repeating unit.

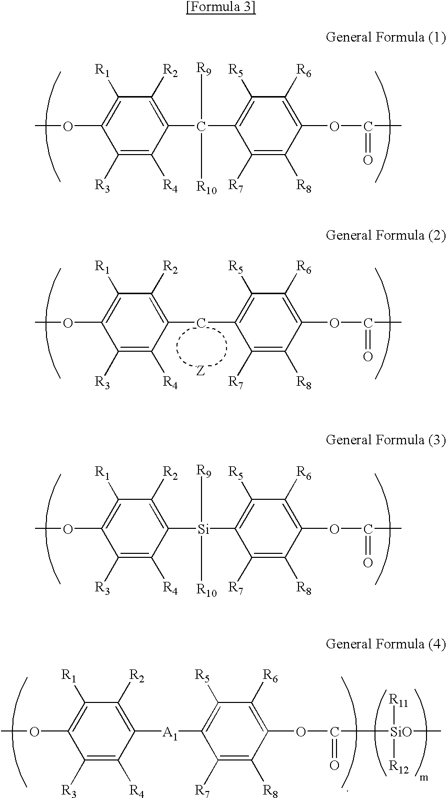

[As examples, (R₁ . . . R₈ in the general formula (1) represent a hydrogen atom, halogen atom, lower alkyl group or aryl respectively, R₉, R₁₀ represent a hydrogen atom, lower alkyl group or aryl group, at least one of R₁ . . . R₈ is a halogen atom, lower alkyl group or aryl group, or at least one of R₉ and R₁₀ is a lower alkyl group having 3 or more carbon atoms or an aryl group). Further, R₁, R₂, R₃, R₄, R₅, R₆, R₇ and R₈ in the general formula (2), general formula (3) and general formula (4) respectively represent a hydrogen atom, halogen atom or lower alkyl group, R₉, R₁₀, R₁₁ and R₁₂ respectively represent a hydrogen atom, and lower alkyl group or aryl group. Z is an atomic group required to form a carbon ring or heterocyclic ring A₁ is —C(R₁₃) (R₁₄)—, —Si (R₅) (R₁₆)—, —S,—SO₂—, —CO—,O— or —(CH₂) n-(where n is an integer equal to 2 or more, R₁₃, R₁₄ are bonded to each other to form a carbocyclic ring or heterocyclic ring, R₁₅, R₁₆ are respectively substituted or unsubstituted alkyl or aryl groups, and 1, m are such that (1+m)=0.1 to 0.9)], but these examples are not limited.

Examples of the CTM are carbazoles, oxazoles, oxadiazoles, thiazoles, thiadiazoles, triazoles, imidazoles, imidazolone derivative, imidazolidines, bis imidazolidines, styryl compounds, hydrazones, pyrazolines, oxazolones, benzimtidazole derivative, quinazolines, benzofurans, acidines, phenazines, amino stilbenes, triaryl amine derivative, phenylenediamines, stilbenes, benzidines, poly-N-vinyl carbazole and poly-1-vinylpyrene, poly-9-vinyl anthracene, but these are not limited.

These may be used alone, or two or more may be used in admixture. The film thickness of the charge transferring layer is preferably 10-35 μm.

The charge transporting material may be various compounds such as a hydrazone, pyrazoline compound, styryl compound, triphenylmethane compound, oxadiazole compound, carbazole compound, stilbene compound, enamine compound, oxazole compound, triphenylamine compound, tetraphenyl benzidine compound or azine compound, but it is preferred that the ionization potential of the charge transporting material itself is high. Butadiene compounds or pyrazoline compounds tend to have a relatively low ionization potential, and as the ionization potential is affected by the substituent group, the charge transporting material must be selected considering the nature of the substituent group. The substituent group may be an electron-accepting group such as a nitro group or a halogen atom, and there is a tendency for these to increase the ionization potential.

To reduce wear due to fatigue after repeated use, or to improve durability, an antioxidant such as a hindered amine or hindered phenol known in the art, ultraviolet absorption agent, electron-accepting substance, surface reforming agent, plasticizer or atmosphere dependency reduction agent or the like may be added in a suitable proportion if necessary to any of the photoconductor layers. In particular, regarding the addition of additives to the charge transporting layer, the addition of an antioxidant is effective for adjusting the ionization potential, and the ionization potential can be increased by adding an antioxidant.

A protective layer may also be provided in addition to the photoconducting layer if necessary. If a filler-reinforced charge transporting layer, described later, is not also provided, a filler material may be added to the surface of the charge transporting layer in order to improve abrasion resistance. Examples of organic filler materials are fluororesin powders such as polytetrafluoroethylene, silicone resin powder and a-carbon paper powder. Examples of inorganic filler materials are metal powders such as copper, tin, aluminum, indium, and the like, metal oxides such as tin oxide, zinc oxide, titania, alumina, indium, antimony oxide, bismuth oxide, calcium oxide, tin oxide doped with antimony, indium oxide doped with tin, metal fluoride compounds such as fluoride tin, calcium fluoride and aluminum fluoride, potassium titanate and boron nitride.

In these fillers, from the viewpoint of the hardness of the filler, it is advantageous to use inorganic materials in order to improve abrasion resistance. In particular silica, titania and alumina can be effectively employed. These fillers may be used alone, or two or more may be used in admixture. The surface of the fillers can be improved by surface treating agents in order to improve dispersibility of the coating liquid and in the coating film.

These filler materials may be dispersed using a suitable dispersing machine together with the charge transporting material, binder resin and solvent. The average primary particle diameter of the filler is 0.01-0.8 μm. This situation is preferable from the viewpoint of permeability and abrasion resistance of the charge transporting layer.

The entire charge transporting layer may contain these fillers, but as they may increase the electric potential of the exposure part, it is preferred that a filler concentration gradient be set up so that the outermost surface of the charge transporting layer has a high concentration and the support body side has a low concentration, or plurality of charge transporting layers may be provided, and the filler concentration gradually increased from the support body side to the surface side.

It is preferred that the layer thickness of the inorganic filler layer contained by the surface side of the charge transporting layer (depth from surface) is 0.5 μm or more, and more preferred that it is 2 μm or more.

When the filler-reinforced charge transporting layer is provided on the surface of the charge transporting layer, the charge transporting layer is formed by dissolving or dispersing a mixture or copolymer having the charge transporting component and binder component as main components in a suitable solvent and coating and drying it. It is convenient if the layer thickness of the charge transporting layer is about 10-100 μm, and about 10-30 μm if resolving power is required.

For example, the binder component used in the charge transporting layer in this case may for example be the aforementioned thermoplastic or thermosetting resin. These polymer compounds may be used alone, two or more may be used in admixture, or they may be copolymerized with the charge transferring material.

To form the layer, the coating method is most common, the coating liquid being applied by immersion coating, spray coating, blade coating, spin coating, bead coating, curtain coating and circular amount regulation coating.

Next, the filler-reinforced charge transporting layer will be described.

The filler-reinforced charge transporting layer according to the present invention comprises at least a charge transporting component, binder resin component and filler, and denotes a functional layer having charge transporting properties and mechanical durability. The filler-reinforced charge transporting layer has the feature of exhibiting a high degree of charge transferring equal to that of a conventional charge transporting layer, and this is distinguished from the surface protective layer. The filler-reinforced charge transporting layer is used as the surface layer wherein the charge transporting layer in the laminated photoconductor is functionally separated into two or more layers. This layer is used in lamination with a charge transporting layer which does not contain filler, and is not used alone. Therefore, it is distinguished from a single charge transporting layer when the filler is dispersed in the charge transporting layer as an additive.

The filler material used for the filler-reinforced charge transporting layer may be an inorganic material as described hereintofore, silica, titanium oxide and alumina being particularly effective. These filler materials may be used alone, or two or more may be used in admixture. The filler surface of these fillers may be modified by a surface treatment agent to improve dispersion properties in the coating liquid and the coating film, as described above.

These filler materials can be dispersed using a suitable dispersion machine together with the charge transporting material, binder resin and solvent. The average of the primary particle diameter of the filler is preferably 0.01-0.8 μm from the viewpoint of permeability and abrasion resistance of the charge transporting layer.

The coating method may be immersion, spray coating, ring coating, roll coating, gravure coating, nozzle coating or screen printing. The layer thickness of the filler-reinforced charge transporting layer is preferably 0.5 μm or more, but more preferably 2 μm or more.

(Intermediate Transfer Body)

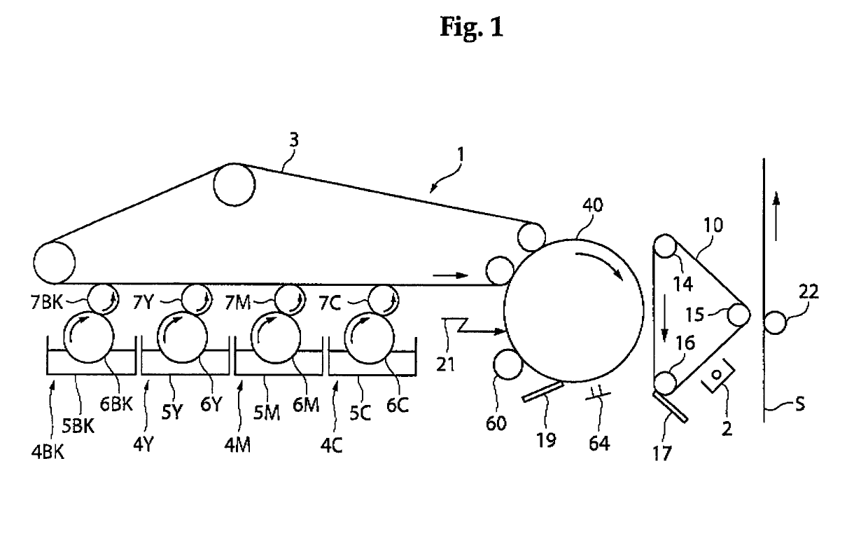

The intermediate transfer body according to the present invention will now be described with reference to one aspect. FIG. 1 is a schematic diagram of a copier according to this aspect. An electrostatic charge roller 60 which is a charging device, exposure device 21, cleaning device 19 comprising a cleaning blade, charge eliminator lamp 64 which is an eliminator device, developing device 1 and intermediate transfer body 10 which is a first transferrer, are disposed around a photoconductive drum (referred to as a photoconductor) 40 which is a latent electrostatic image bearing member. This intermediate transfer body 10 is suspended by support rollers 14, 15, 16, and is made to travel for permanent in the direction of the arrow by a drive means such as a motor not shown on the figure. A part of this support roller plays the role of a transfer bias roller which supplies a transfer bias to the intermediate transfer body 10, a predetermined transfer bias voltage is applied from a power supply which is not shown in the figure. A cleaning device 17 which comprises a cleaning blade of the intermediate transfer body 10 is also provided. A transfer roller 22 facing the intermediate transfer body 10 is provided as a second transferrer to transfer the toner image onto a transfer paper as the final transfer material, the transfer roller 22 supplying a transfer bias from a power supply device which is not shown in the figure. A corona charger 2 is installed as a charge supply means in the vicinity of the intermediate transfer body 10.

The developing device 1 comprises a developing belt 3 which is a developing support, and a black (referred to as Bk) developing unit 4K, yellow (hereinafter, referred to as Y) developing unit 4Y, magenta (referred to as magenta) developing unit 4M and cyan (referred to as C) developing unit 4C, all of which are spanned around the developing belt 3. The developing belt 3 is spanned over belt rollers, and it travels endlessly in the direction of the arrow by a drive means such as a motor that is not shown on the figure, and moves at the substantially same speed as the photoconductor 40 at the part contacting with the photoconductor 40.

Each construction of the developing units is common themselves. Therefore, in the following description only will the Bk developing unit 4Bk be described hereinafter. Regarding developing units 4Y, 4M, and 4C, the letters Y, M, C will merely be appended to numbers assigned to each unit corresponding to the Bk developing unit 4Bk in the figure, hence description of the rest of the developing units are omitted.

The developing unit 4Bk comprises a developing tank 5Bk which accommodates a developer, a drawing roller 6Bk which is disposed so that the lower part is immersed partly in the developer in the developing tank 5Bk, and a coating roller 7Bk which coats the developing belt 3 with thin layer of developer drawn up from the drawing roller 6Bk. The coating roller 7Bk is electroconductive, in which a predetermined bias is applied from a power source that is not shown in the figure.

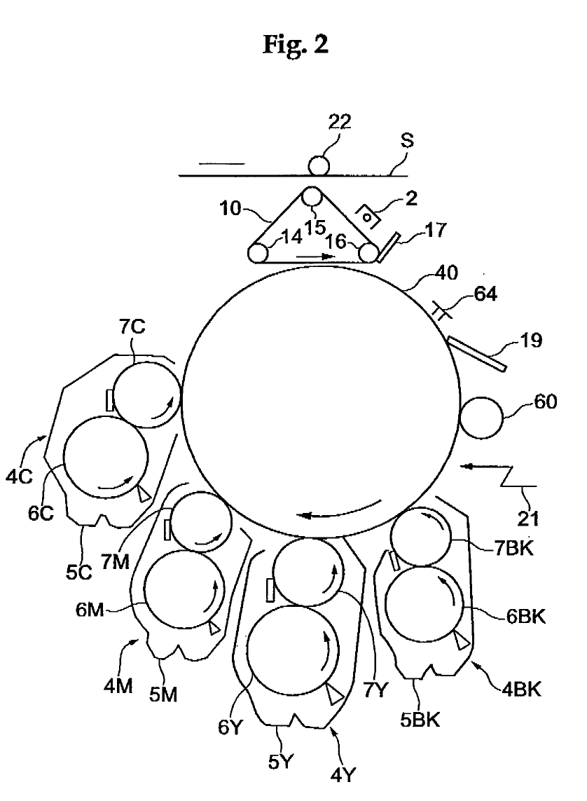

The construction of the copier according to this aspect, in addition to the construction shown in FIG. 1, may also comprise developing units 4 with various colors arranged around the photoconductor 40, as shown in FIG. 2.

Next, the operation of the copier according to this aspect will be described. In FIG. 1, the photoconductor 40 is charged uniformly by the charging roller 60 as rotating in the direction of the arrow, and, by the exposure device 21, a light reflected from a document via an optical system that is not shown in the figure, is projected onto the photoconductor 40 so as to form a latent electrostatic image. This latent electrostatic image is developed by the developing device 1 to form a clearly visible toner image. The thin layer of the developer on the developing belt 3 separates from the belt 3 due to the contact with the photoconductor 40 in the developing area, and then moves to the part where the latent image is formed on the photoconductor 40. The toner image developed by this developing device 1 is transferred to the surface of the intermediate transfer body 10 in the part (first transfer region) contacted with the intermediate transfer body 10 which is moving at the same speed as the photoconductor 40 (first transfer). If three or four colors are to be transferred at the same time, this process is repeated for each color so as to form a color image on the intermediate transfer body 10.

The corona charger 2 which charges the toner images superimposed on the intermediate transfer body is installed at a position downstream of the parts of the photoconductor 40 and intermediate transfer body 10 which face each other in contact, and upstream of the parts of the intermediate transfer body 10 and transfer papers which face each other in contact, in the direction of rotation of the intermediate body 10. This corona charger 2 which charges identical polarity to that of the toner particles formed on the toner image, to the toner image, so that sufficient charge can be transferred to the toner image for satisfactory transfer to the transfer paper. After the toner image is charged by the corona charger 2, it is transferred in one operation to the transfer paper which is transported in the direction of the arrow by a supply unit, not shown, by a transfer bias from the transfer roller 22 (secondary transfer). Subsequently, the transfer paper to which the toner image is transferred is separated from the intermediate transfer body 10 by a separating device, and is ejected from the device after fixing by a fixing device, not shown. The toner which is not transferred is recovered and removed, and the remaining charge on the photoconductor 40 after transfer is eliminated by the eliminator lamp 64.

The coefficient of static friction of this intermediate transfer body is preferably 0.1-0.6, but more preferably 0.3-0.5. It is preferred that the bulk resistance of his intermediate transfer body is several Ωcm to 10³ Ωcm. By arranging the bulk resistance to be several Ωcm to 10³ Ωcm, charging of the intermediate transfer body itself is prevented and the charge given by the charger does not easily remain on the intermediate transfer body, so it is possible to prevent uneven transferring on the second transfer. In addition, the transfer bias is easily applied in the second transfer.

There is no particular limit on the material of the intermediate transfer body, and any of the materials known in the art may be used. Specific examples are as follows; (1) Materials having a high Young's modulus (tensile elasticity) which are used as monolayer belts, such as PC (polycarbonate), PVDF polyvinylidene fluoride), PAT (polyalkylene terephthalate), blend material of PC (polycarbonate)/PAT (polyalkylene terephthalate), ETFE (ethylene-tetrafluoroetlylene copolymer)/PC, ETFE/PAT, blend material of PC/PAT, and a thermohardening polyimide with a carbon black dispersion. Monolayer belts having a high Young's modulus produce little image deformation relative to stress when the image is formed, and in particular have the advantage that there is little register gap when a color image is formed. (2) Belts having two to three layers comprising a base layer having a high Young's modulus, and a surface layer or intermediate layer on its outer circumference. These 2-3 layer belts have the property of preventing dropout of line images due to the hardness of monolayer belts. (3) Belts having a relatively low Young's modulus using rubber or elastomer. These belts have the advantage that there is practically no dropout of line images due to their softness. In addition, by making the width of the belt larger than the drive roller and suspension roller, and using the elasticity of the ear of the belt projecting from the roller, meandering is prevented, so the system can be realized at low cost without the need for ribs or meandering prevention devices.

Intermediate transfer belts were conventionally manufactured from fluorinated resins, polycarbonate resins and polyimide resin, but in recent years, elastic belts wherein all layers of the belt or part of the belt are made from an elastic material, have come to be used. There are the following problems when transferring the color image using a resin belt.

Normally, a color image is formed using four colored toners. To form one color image, four toner layers are formed. The first toner layer receives pressure due to the first transfer (transfer to intermediate transfer belt from the photoconductor) and second transfer (transfer to a transfer material such as paper from intermediate transfer belt), and cohesion between toner increases. When cohesion between toner increases, image-dropouts and loss of the edges of a close typesetting image, tend to occur. A resin belt is hard and does not deform depending on the toner layer, so the toner layer is easily compressed and image-dropouts easily occur.

In recent years, there is increasing demand to form full color images on various types of paper, for example Japanese paper, or to deliberately make bumps, etc. However, in the case of paper which is not very smooth or where crevices with the toner tend to occur, there will tend to be missing patches in the transfer image. If the transfer pressure of the second transfer part is raised to increase adhesion, the cohesive force of the toner layer will be increased which will tend to increase the aforementioned image-dropouts.

Elastic belts are used with the following objective. Elastic belts deform corresponding to the surface status of a toner image having less flat portions at the contacting portion of the belt. In other words, as the elastic belt deforms following the local undulations, there is no excessive increase of transfer pressure relative to the toner layer, satisfactory fixing properties are obtained, and a transfer image with no image-dropouts and having excellent uniformity even on paper which is not very flat can be obtained.

The resin of the elastic belt may be one, two or more chosen from a group comprising polycarbonate, fluorinated resin (ETFE, PVDF), polystyrene, chloropolystyrene, poly-α-methylstyrene, styrene-butadiene copolymer, styrene-chloroethylene copolymer, styrene-vinyl acetate copolymer, styrene-maleic add copolymer, styrene-acrylate copolymer (or the like styrene-methyl acrylate copolymer, styrene-ethyl acrylate copolymer, styrene-butyl acrylate copolymer, styrene-acrylic acid octyl copolymer and styrene-phenylacrylate copolymer), styrene-methacrylate copolymer (styrene-methyl methacrylate copolymer, styrene-ethyl methacrylate copolymer, styrene-phenyl methacrylate copolymer), styrene-α-chloromethyl acrylate copolymer, styrene resin of styrene-acrylonitrile-acrylate copolymer (monomer or copolymer of styrene or styrene substitution product), polymethyl methacrylate, butyl methacrylate resin, ethyl acrylate resin, butyl acrylate resin, modified acryl resin (silicone-modified acryl resin, chloroethylene resin-modified acryl resin, acrylic urethane resin), chloroethylene resin, styrene-vinyl acetate copolymer, chloroethylene-vinyl acetate copolymer, rosin-modified maleic resin, phenol resin, epoxide resin, polyester resin, polyester polyurethane resin, polyethylene, polypropylene, polybutadiene, polyvinylidene chloride, ionomer resin, polyurethane resin, silicone resin, ketone resin, ethylene-ethylacrylate copolymer, xylene resin and polyvinylbutyral resin, polyamide resin and modified polyphenylene oxide resin. It will of course be understood that the above materials are not limited.

The elastic rubber or elastomer may be one, two or more chosen from a group comprising butyl rubber, fluorinated rubber, acrylic elastomer, EPDM, NBR, acrylonitrile-butadiene-styrene rubber natural rubber, isoprene rubber, styrene-butadiene rubber, butadiene rubber, ethylene-propylene rubber, ethylene-propylene terpolymer, chloroprene rubber, chlorosulfonated polyethylene, chlorinated polythene, urethane rubber, syndiotactic 1,2-polybutadiene, epichlorohydrin rubber, silicone rubber, fluorine-containing rubber, polysulfide rubber, polynorbornene rubber, hydrogenated nitrile rubber, and thermoplastic elastomer (for example, polystyrene type, polyolefin type, polyvinyl chloride type, polyurethane type, polyamide type, polyurea, polyester type, fluorinated resin type). It will of course be understood that the above materials are not limited.

There is no particular limit on the resistance value adjusting agent which may for example be carbon black, graphite, a metal powder such as aluminum or nickel, or an electroconductive metal oxide such as tin oxide, titanium oxide, antimony oxide, indium oxide, potassium titanate, antimony oxide-tin oxide complex (ATO) or indium oxide-tin oxide complex (ITO). The electroconductive metal oxide may also be coated with insulating microparticles of barium sulphate, magnesium silicate or calcium carbonate. It will be understood that the above electroconductive agents are not limited.

For a material comprising a surface layer, a material which reduces adhesion of the toner on the surface of the transfer belt by reducing surface frictional resistance, which also improves secondary transfer properties, and which prevents soiling of photoconductive materials by an elastic material, thus improving cleaning properties is required. For example, one, two or more of polyester or epoxy resins are used to reduce surface energy and improve lubricating properties, such as powders of fluorinated resins, fluorine compounds, fluorocarbons, titanium dioxide and silica carbide. Alternatively, one, two or more types of particle, or particles having different particle diameters, can be dispersed, or a fluorine-rich layer can be formed on the surface by heat treatment, as in the case of fluorinated rubber, to reduce the surface energy.

There is no particular limit on the method used to manufacture the intermediate transfer belt, general examples being the centrifugation method wherein a material is poured into a rotating cylindrical mold to form a belt, the spray coating method wherein a liquid coating material is sprayed to form a film, the dipping method wherein a cylindrical mold is immersed in a solution of the material and then hoisted up, the injection method wherein the material is injected into an inner mold or outer mold, and a method wherein a compound is wound around a cylindrical mold, vulcanized and polished, however these are not limited, and it is common to combine plurality of methods to manufacture the belt.

The elongation of the elastic belt may be prevented by forming a rubber layer on a core resin layer which has little elongation, or by introducing a material to prevent elongation of the core layer, but this has no large impact on the manufacturing method. The material forming the core layer which prevents elongation may for example be one, two or more chosen from a group comprising natural fibers such as cotton, silk, and the like, synthetic fibers such as polyester fiber, nylon fiber, acryl fiber, polyolefin fiber, polyvinyl alcohol fiber polyvinyl chloride fiber, polyvinylidene chloride fiber, polyurethane fiber, polyacetal fiber, polyfluoroethylene fiber, phenol fiber, boron fiber, and the like, inorganic fibers such as carbon fiber, glass fiber, and the like and metal fibers such as iron fiber, copper and the like. The above materials are of course not limited.

The yarn may be single or plurality of filaments twisted together, and any kind of twisting method may be used such as throwing, plying or double thread. Fibers of the material selected from the above group may for example be spun together. Suitable electroconductive treatment may of course also be applied.

A fabric woven by knitted weave can be used, or a cosswoven fabric may be used, and electroconductive treatment may of course be applied.

There is no particular limit on the method used to provide the core layer, for example a metal mold or the like can be covered by a fabric woven in the shape of a cylinder and a coating layer provided thereon, a fabric woven in the shape of a cylinder can be immersed in liquid rubber, and a coating layer provided on one side or both sides of the core layer, or a thread wound spirally at an arbitrary pitch on a metal mold or the like, and a coating layer provided thereon.

The thickness of the elastic layer depends on the hardness of the elastic layer, but if it is too thick, surface elongations and contractions increase, and tend to cause tears in the surface layer. Also, if it is too thick (approximately 0.05-1 mm), the elongation/contraction amount increases which causes stretching or shrinking of the image.

An appropriate range of hardness of the elastic layer is 10°≦HS≦65° (JIS-A). It may be necessary to adjust the optimum hardness depending on the belt thickness if it is less hard than a hardness of 10°0 (JIS-A), it becomes extremely difficult to form the belt with precise dimensions. This is because it easily tends to contract or expand during molding. To soften it, an oil component is generally contained in the base material, but if it works continuously in the pressurized state, the oil component tends to ooze out. It was found that this soiled the photoconductor in contact with the intermediate transfer body surface, and caused side belt-shaped unevenness.

In general, a surface layer is provided to improve mold release properties. The surface layer must have high durability and high quality to be able to completely prevent oil stains, thus the selection of the material is difficult and it is difficult to maintain its properties. On the other hand, materials having a hardness of 65° or more (JIS-A) can be formed with higher precision according to their hardness, and as they do not contain oil or the amount of oil has been suppressed low, staining of the photoconductor can be reduced. However, improvement of transfer properties such as image-dropouts can no longer be obtained, and it is difficult to stretch the material over the roller.

The ionization potential of the intermediate transfer body depends largely on its main resin, but as in the case of the photoconductor, addition of antioxidants such as hindered amines or hindered phenols is effective to adjust the ionization potential. By adding an antioxidant, it is possible also to increase the ionization potential.

(Tandem Color Image Forming Device)

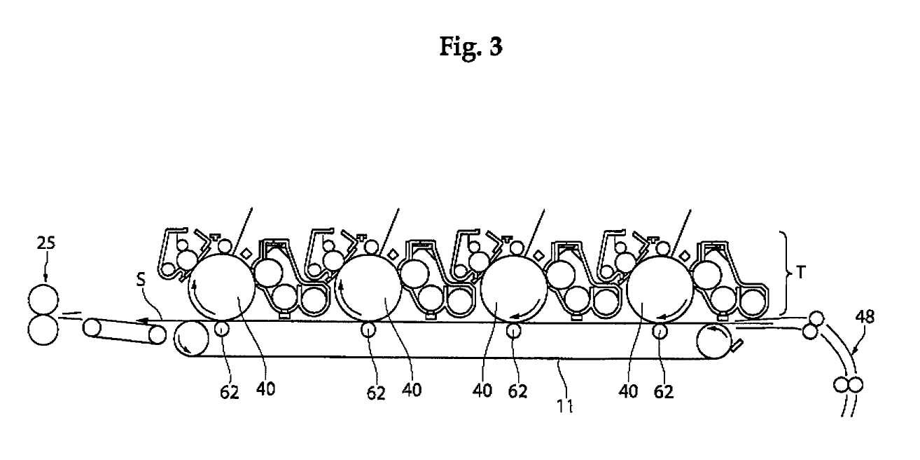

One aspect of a tandem color image forming device will now be described. Tandem type device for electrophotography may be broadly divided into two types, i.e. One is a direct transfer type where the images on the photoconductors 40 are successively transferred to a sheet which is transported by a sheet transport belt 11 in a transfer device 62, as shown in FIG. 3.

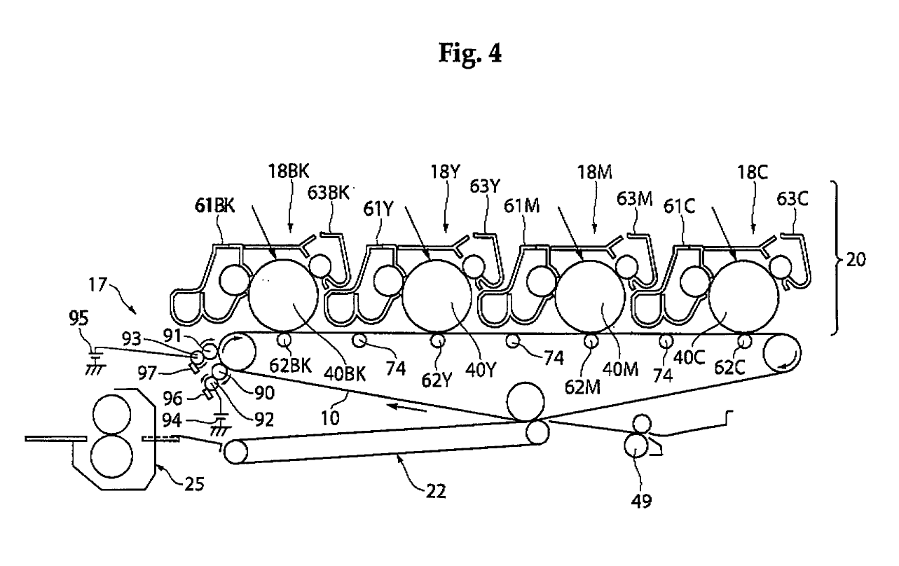

The other is an indirect transfer type where the images on the photoconductors 40 are successively transferred to the intermediate transfer body 10 by the primary transfer device 62, and then the images on the intermediate transfer body 10 are transferred in one operation to the sheet by the secondary transfer device 22, as shown in FIG. 4. The transfer device 5 is a transfer transport belt, but it may also be a roller.

Comparing the direct transfer type and indirect transfer type, in the direct transfer type, a supply device 47 must be installed upstream of a tandem image forming device T wherein the photo conductors 40 are aligned, and a fixing device 7 must be installed downstream, which results in a disadvantage that the supply device 47 needs to be bigger toward the sheet transport direction.

By contrast, in the indirect transfer type, the secondary transfer device can be installed relatively freely. Further, the supply device 47 and fixing device 25 can be installed parallel to the tandem image-forming device T, which contributes to downsizing of a copier.

In order to prevent a big direct transfer apparatus toward the sheet transport direction, the fixing device 25 must be installed closely to the tandem image forming device T. Therefore, the fixing device 25 cannot be disposed with sufficient space to the extent that a sheet can be bent Due to the impact given when the tip of a sheet reaches the fixing device 25 (particularly evident in a case of a thick sheet), and because of the different sheet transport speed between when a sheet passes through the fixing device 25 and when a sheet transfers the transport belt, the fixing device 25 tends to affect the image-forming which takes place upstream. On the other hand, in the indirect transfer type, the fixing device 25 can be disposed with sufficient space to the extent that the sheet can be bent. Therefore, the fixing device 25 can be arranged so that it does not practically affect image-forming.

Consequently, the indirect transfer type in tandem electrophotography has recently rose attention. Thus, in this type of color electronic transfer device, as shown in FIG. 4, transferred toner remaining on the photoconductor 40 after the first transfer is eliminated by the photoconductor cleaning device 19 to clean the surface of the photoconductor 40 in preparation for the next image-forming. Transferred toner remaining on the intermediate transfer body 10 after the second transfer is eliminated by the intermediate transfer body cleaning device 17 to clean the surface of the intermediate transfer body 10 in preparation for the next image-forming.

One aspect of the present invention will now be described with reference to the drawings.

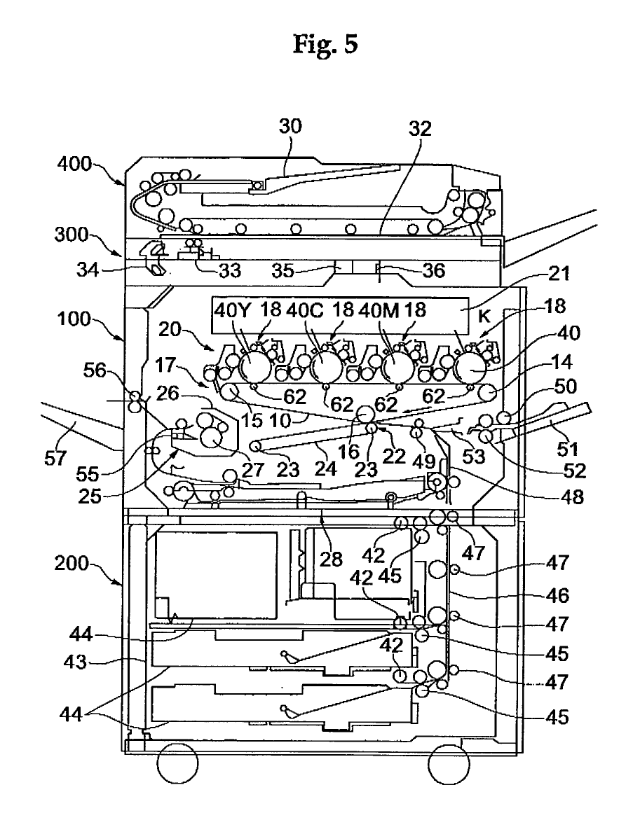

FIG. 5 shows one aspect of the present invention, which is a tandem indirect transfer electrophotographic device. In the figure, 100 is the copier body, 200 is a paper feeding table on which it is mounted, 300 is a scanner attached to the copier body 100, and 400 is an automatic document feeder (ADF) attached thereon. The endless belt intermediate transfer body 10 is installed in the center of the copier body 100.

As shown in FIG. 5, 3 support rollers 14, 15,16 are spanned around the endless belt intermediate transfer body 10 so that it can rotate in the clockwise direction.

In the example shown in this figure, the intermediate transfer body cleaning device 17 which removes toner remaining on the intermediate transfer body 10 after image transfer, is installed on the left of the second support roller 15 of the three rollers.

Further, the four image-forming means 18, i.e., yellow, cyan, magenta and black, are arranged horizontally to form an image-forming device 20 on the intermediate transfer body 10 which spans the first support roller 14 and second support roller 15 among the three support rollers.

An exposure device 21 is further provided on the tandem image-forming device 20 as shown in FIG. 5. A secondary transfer device 22 is provided on the opposite side of the intermediate transfer body 10 to the tandem image-forming device 20. In the example shown in the figure, the secondary transfer device 22 consists of a secondary transfer belt 24, which is an endless belt, and two rollers 23, both of which are spanned around a secondary transfer belt 24. The secondary transfer device is pressed on the support roller 16, and transfer an image on the intermediate transfer body 10 to a sheet.

The fixing device 25 which fixes the transferred image on the sheet is provided alongside the secondary transfer device 22. The fixing device 25 consists of pressing a pressure roller 27 against a fixing belt 26, which is an endless belt.

The aforementioned second transfer device 22 also has a sheet transport function which transports the sheet done with image transfer to this fixing device 25. The secondary transfer device 22 may also comprise a transfer roller or non-contact charger, and in this case, it is difficult to provide this sheet transport function. In the example shown in the figure, a sheet inverting device 28 which inverts the sheet in order to record an image on both surfaces of the sheet, is provided underneath this secondary transfer device 22 and fixing device 25 parallel to the aforementioned tandem image-forming device 20.

When a copy is to be made with this color electrophotographic device, the document is set in the document holder 30 of the automatic document feeder 400. Alternatively, the automatic document feeder 400 is opened, the document is set on a contact glass 32 of the scanner 300, and the automatic document feeder 400 is closed to hold the document.

After turning on a start switch, which is not shown in the figure, if the document is set in the automatic document feeder 400, the document has n transported above the contact glass 32. If the document is set on the contact glass 32, the scanner 300 is immediately driven to move a first travel body 33 and second travel body 34. Light is then emitted from a light source by the first travel body 33, the reflected light from the document surface is reflected again towards the second travel body 34, and is again reflected by the mirror of the second travel body 34 to a reading sensor 36 via an imaging lens 35 so as to read the document.

Also, when tuning on the starter switch not shown in the figure, one of the support rollers 14, 15, 16 is rotated and driven by a motor which is not shown in the figure, which leads to rotating and driving the other two support rollers and then eventually leads to rotating and transporting the intermediate transfer body 10. Simultaneously, the photoconductors 40 are rotated by the image-forming means 18 so that monocolor images of black, yellow, magenta, cyan, are formed respectively on the photoconductors 40. As the intermediate transfer body 10 moves, these monocolor images are successively transferred so as to form one color image on the intermediate transfer body 10.

On the other hand, when turning on starter switch that is not shown in the figure, one of paper feed rollers 42 on a paper feed table 200 is selected and rotated. The sheets are paid out from one of paper feed cassettes 44 placed in a few levels of a paper bank 43, taken one sheet by a separating roller 45 to place the sheet on a paper feed path 46, transported by transport roller 47 to a paper feed path 48 in the copier body 100, and come in contact with a resist roller 49, in which the sheet is stopped. Alternatively, the sheets are also stopped in contact with the resist roller 49 by rotating a paper feed roller 50 to take sheets from a pull-out tray 51, choosing one by a separating roller 52, and placing the sheet on a paper feed path 53.

The resist roller 49 is then rotated with the correct timing for the color image on the intermediate transfer body 10, a sheet is delivered between the intermediate transfer body 10 and second transfer device 22, and the color image is thereby transferred by the second transfer device 22 so as to record the color image on the sheet.

After the image has been transferred to the sheet, it is transported by the second transfer device 22 to the fixing device 25, and heat and pressure are applied by the fixing device 25 to fix the transferred image. The transferred image is then changed over by the change-over hooks 55, ejected by an ejection roller 56, and stacked on an ejected paper tray 57. Alternatively, it is changed over by the changeover hooks 55, passes a sheet inverting device 28 where it is inverted, and is again led to the transfer device where an image is recorded on the reverse surface, too, and is finally ejected by the ejection roller 56 to be ejected onto the ejection tray 57.

At the same time, toner remaining on the intermediate transfer body 10 after image transfer is removed therefrom by the intermediate transfer body cleaning device 17, and is re-used for image-forming by the tandem image-forming device 20 for the next occasion.

In general the resist roller 49 is earthed, but a bias may also be applied to remove paper powder from the sheet.

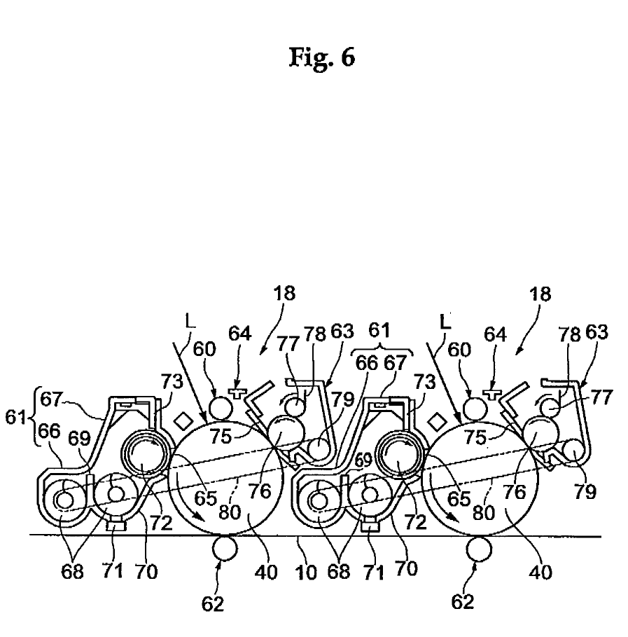

In the aforementioned tandem image-forming device 20, as shown for example in FIG. 6, the image-forming means 18 comprises the charging device 60, developing device 61 (image device 61), primary transfer device 62, photoconductor body cleaning device 63 and charge eliminating device 64 which are disposed above the drum-shaped photoconductor 40, and so on.

Although not shown in the drawings, it is also possible to install at least the photoconductor 40 and to form process cartridges on all or some of the parts of the image-forming means 18. The installment of the photoconductor 40 contributes to facilitating the maintenance because the process cartridges can be freely inserted to and removed from the copier body 100.

Of the parts comprising the image-forming means 18, the charging device 60 is formed in the shape of a roller in the example shown in the figure, and charges the photoconductor 40 by applying a voltage in contact with the photoconductor 40. Needless to say, it will be understood that charging may be performed also by a non-contact scrotron charger.

The developing device 61 may use a one-component developer, but in the example shown in the figure, a two-component developer comprising a magnetic carrier and a non-magnetic toner is used. This comprises a stirring unit 66 which transports this two-component developer while stirring it supplies the two-component developer and makes it adhere to the developing sleeve 65, and a developing unit 67 which transfers toner in the two-component developer adhering to this developing sleeve 65. The sting unit 66 is at a lower position than this developing unit 67.

Two parallel screws 68 are provided in the stirring unit 66. The interval between the two screws 68 is divided by a partition 69 apart from the two ends. A toner concentration sensor 71 is attached to a developing case 70.

In the developing unit 67, the developing sleeve 65 is installed opposite to the photoconductor 40 via an opening in the developing case 70, and a magnet 72 is fixed inside this developing sleeve 65. A doctor blade 73 is installed with its tip in proximity to this developing sleeve 65.

The two-component developer is transported and recirculated while string with the two screws 68, and supplied to the developing sleeve 65. The developer supplied to the developing sleeve 65 is drawn up and held by the magnet 72, and forms a magnetic brush on the developing sleeve 65. The magnetic brush is cut into an appropriate amount by the doctor blade 73 as the developing sleeve 65 rotates. The developer which is cut off, is returned to the stirring unit 66.

Also, a toner in the developer on the developing sleeve 65 migrates to the photoconductor 40 due to the developing bias voltage applied to the developing sleeve 65, and renders the latent electrostatic image on the photoconductor 40 visible. After the image has been made visible, developer remaining on the developing sleeve 65 separates from the developing sleeve 65 and returns to the string unit 66 when there is no magnetic force from the magnet 72. When the toner concentration in the stirring unit 66 becomes her due to repetition of this cycle, it is detected by the toner concentration sensor 71 so that toner is supplied to the stirring unit 66.

Next, the first transfer unit 62 is roller-shaped, and is installed so that it presses against the photoconductor 40 on the other side of the intermediate transfer body 10. Instead of a roller shape, the unit may take the form of an electroconductive brush, a non-contact corona charger or the like.

The photosensitive cleaning device 63 for example comprises a polyurethane cleaning blade 75 in which the tip is pressed against the photoconductor 40. It also has a contact brush in which the outer circumference is in contact with the photoconductor 40 to improve cleaning properties. In this specification, an electroconductive fur brush 76 in which the outer circumference is in contact with the photoconductor 40 and is free to rotate in the direction of the arrow, is provided. In addition, a metal electric field roller 77 which applies a bias to the fur brush 76 is provided free to rotate in the direction of the arrow, the tip of a scraper 78 being pressed against this electric field roller 77. A recovery screw 79 to recover toner which has been removed, is also provided.

The toner remaining on the photoconductor 40 is removed by the fur brush 76 which rotates in the opposite direction to the photoconductor 40. Toner adhering to the fur brush 76 is removed by the electric field roller 77 which rotates in contact with and in the opposite direction to the fur brush 76, and to which a bias is applied. Toner adhering to the electric field roller 77 is cleaned by the scaper 78. The toner recovered by the photoconductor cleaning device 63, is made to approach one side of the photoconductor cleaning device 63 by a recovery screw 79, and is returned to the developing unit 61 by a toner recycling device 80, described later, to be reused.

The charge eliminator 64 is, for example, a lamp, and it irradiates light so that the surface potential of the photoconductor 40 is initialized.

As the photoconductor 40 rotates, the surface of the photoconductor 40 is first uniformly charged by the charging device 60, and it is then irradiated by a writing light L such as a laser or LED from the exposing device 21 described above according to the contents read by the scanner 300, so that an latent electrostatic image is formed on the photoconductor 40.

Subsequently, toner is made to adhere by the developing unit 61 so as to render the latent electrostatic image visible, and this visible image is transferred to the intermediate transfer body 10 by the primary transfer device 62. The surface of the photoconductor 40 after image transfer is cleaned by removing residual toner with the photoconductor cleaning device 63, and then charge is removed by the charge eliminator 64 so that an image can again be formed.

FIG. 4 is an enlarged view of the essential parts of the color copier shown in FIG. 5. In the figure, the image-forming means 18 of the tandem image-forming device 20, the photoconductors 40 of this image-forming means 18, the developing units 61, the photoconductor cleaning devices 63, and the primary transfer units 62 installed respectively facing the photoconductors 40 of the image-forming meetings 18, are each distinguished by the letters BK for black, Y for yellow, M for magenta and C for cyan which are appended after the respective symbols.

The symbol 74 in FIG. 4 is not shown in FIG. 5 and FIG. 6, but it represents an electroconductive roller in contact with the base layer side of the intermediate transfer body 10 between the first transfer devices 62. This electroconductive roller 74 prevents the bias applied by the first transfer units 62 during transfer from flowing to the adjacent image-forming means 18 via the base layer which has a medium or low resistance.

The developing sleeve 65 is a non-magnetic sleeve-shaped member which can rotate, plurality of magnets 72 being disposed therein. As the magnets 72 are fixed, they cause a magnetic force to act when the developer passes a predetermined point. In the example shown in the figure, the diameter of the developing sleeve 65 is φ 18, and the surface is sandblasted or treated to form plurality of grooves having a depth of 1-several mm such that RZ is within the range of 10-30 μm.

The magnet 72 for example has 5 magnetic poles N₁, S₁, N₂, S₅, S₃ in the direction of rotation of the developing sleeve 65 from the location of the doctor blade 73.

The developer forms a magnetic brush due to the magnet 72, and is supported on the developing sleeve 65. The developing sleeve 65 is disposed facing the photoconductor 40 in a region on the S1 side of the magnet 72 forming the magnetic brush of developer.

In the example shown in the figure, two fur brushes 90, 91 are provided as cleaning members in the cleaning device 17, as shown in FIG. 4. Biases of different polarity are applied from a power supply, not shown, to these fur brushes, 90, 91.

Metal rollers 92, 93 are respectively in contact with the fur brushes 90, 91, and rotate in the same direction or opposite directions. In this example, a (−) voltage is applied to the metal roller 92 upstream of the direction of rotation of the intermediate transfer body 10 from a power supply 94, and a (+) voltage is applied to the metal roller 93 upstream of the direction of rotation of the intermediate transfer body 10 from a power supply 95. The tips of blades 96,97 are pressed against these metal rollers 92, 93 respectively.

As the intermediate transfer body 10 rotates in the direction of the arrow, the (−) bias for example is applied using firstly the upstream fur brush 90 to perform cleaning of the surface of the intermediate transfer body 10. If −700 V is applied to the metal roller 92, the fur brush 90 becomes −400V, and the (+) toner on the intermediate transfer body 10 displaces to the side of the fur brush 90. The toner which was removed displaces to the metal roller 92 from the fur brush 90 due to the potential difference, and is scraped off by the blade 96.

Although the toner on the intermediate transfer body 10 is removed by the fur brush 90, a large amount of toner still remains on the intermediate transfer body 10. This toner is negatively charged with electricity by the (−) bias applied by the fur brush 90. This charging is probably due to introduction of charges or discharge.

However, this toner can be removed by cleaning, by next applying a (+) bias using the downstream fur bush 91. The removed toner displaces from the fur brush 91 to the metal roller 93 due to the potential difference, and is scratched off by the blade 97.

The toner which is scratched off by the blades 96, 97 is recovered in a tank, not shown.

There is no particular limit on the sequence of the colors forming the image, and this will differ according to the objective and properties of the image-forming device.

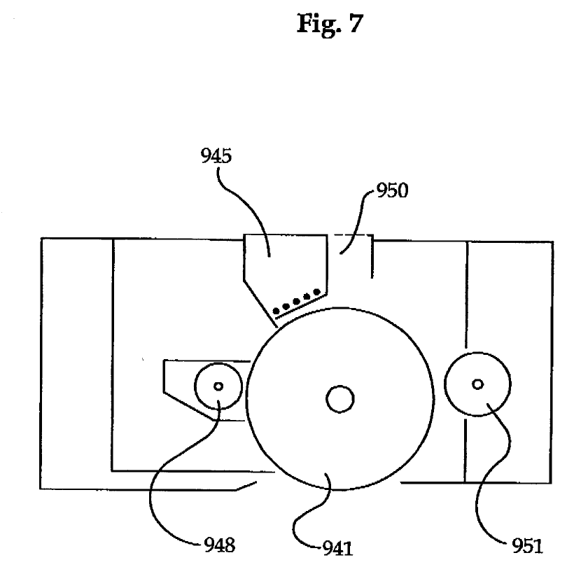

The aforementioned image-forming device may be incorporated in a copier, facsimile machine or printer, or it may be built into these instruments in the form of a process cartridge. The process cartridge has a built-in photoconductor, and is a device (product) also comprising a charger, a light irradiator, developer, transfer, cleaner and charge eliminator. The process cartridge may take many different forms, but a general example is shown in FIG. 7. The photoconductor 941 comprises an electrophotographic photoconductor manufactured according to the present invention on an electroconductive support.

By using the image-forming device according to the present invention shown above, a good image can be provided.

### EXAMPLE A

The present invention will now be described in more detail by means of examples and comparative examples, but it should be noted that the present invention is not restricted to the examples. In the following examples, parts and percentages are based on weight unless specified. The properties and test results obtained are shown in Table 1. The tests in the examples were performed as follows.

The images used in the tests were evaluated using one of the following testing devices A, B, C, D.

(Testing Device A)

A modified Ricoh full-color laser copier, Image Camera 2800, using the method wherein four color developing parts were developed on a drum-shaped photoconductor by a two-component developer, successively transferred to an intermediate transfer body, and four colors were transferred together to a transfer paper or the like.

(Testing Device B)

A modified Ricoh full-color laser printer, IPSiO 5000, using the method wherein four color developing parts were successively developed on a belt photoconductor by a non-magnetic one-component developer, successively transferred to an intermediate transfer body, and four colors were transferred together to a transfer paper or the like.

(Testing Device C)

A modified Fujitsu full-color LED printer, GL8300, comprising four color non-magnetic one-component developing parts and four color photoconductors, wherein the images were successively transferred to a transfer paper or the like by the tandem method.

(Testing Device D)

A Fujitsu full color LED printer, GL8300, was upgraded by a non-magnetic two-component developing unit to a four color non-magnetic two-component developing unit and four color photoconductor. The toner image was first transferred to an intermediate transfer body and this toner image was then transferred to a transfer material by the tandem method. Tests were carried out with high-speed printing (equivalent to 30-70 sheets/min/A4).

(Test Items)

(1) Tensile Fracture Strength

The tensile fracture strength under 10 kg/cm² compression was shown. The average value is shown in the case of a four-color toner.

(2) Loose Apparent Density

The average value is shown in the case of a four-color toner.

(3) Dropout in Character Image

A character image was output in four superimposed colors to a Ricoh DX OHP sheet. The character image was then compared with a staged sample in terms of the non-transfer frequency of a toner, which had a drop out of character part. The rank of the improvement is expressed in the order X, Δ, ◯, ⊚.

(4) Toner Transfer Rate

The transfer rate was computed from the relation between introduced toner amount and waste toner amount after outputting 100,000 image charts having a 7% image surface area in the monochrome mode.

Transfer rate=100×(introduced toner-waste toner)/(introduced toner)

⊚ transfer rate of 90 or more

◯ 75 to 90

Δ 60 to 75

X less than 60

(5) Toner Refilling Properties

5000 sheets each of an image having an image surface area of 90 percent and an image having 5 percent image surface area were alternately output, and toner refilling properties on these occasions were examined.

The toner refilling properties were expressed in the order X, Δ, ◯, ⊚, in which the properties were improved.

(6) Thin Line Reproducibility

A thin line drawing image of 600 dpi was to output to type Ricoh Co., Ltd. 6000 paper, and the degree of blotting of the thin lines was compared with a stage sample. The rank of the improvement was expressed in the order X, Δ, ◯, ⊚. This was performed for four colors superimposed.

(7) Image Deposition

A blank paper image was stopped in development, the developer on the photoconductor after development was transferred by tape, and the difference from the image density of non-transferred tape was measured by a 938 Spectrodensitometer (X-Rite). Image deposition is better with little difference of image density, and the rank of the improvement is expressed in the order X, Δ, ◯, ⊚.

(8) Image Density

A solid image was output to Ricoh 6000 paper, and the image density was measured by X-Rite (X-Rite Co.). This was performed independently for four colors, and the average was calculated. When this value was less than 1.2, x was assigned, for 1.2 to 1.4, Δ was assigned, for 1.4 to 1.8, ◯ was assigned, and for 1.8 to 2.2, ⊚ was assigned.

(9) Heat-Resistance Storage Properties

Toner of each color was measured out 10 g at a time, introduced into a 20 cc glass container, and after tapping a glass bottle approx. 100 times, it was left in a constant temperature bath for 24 hours, and the penetration was measured with a penetration gauge. The storage properties was evaluated in descending order as, ⊚:20 mm or more, ◯:15 mm to less than 20 mm, Δ:10 mm-15 mm, and X:less than 10 mm.

(10) Transparency

Fixing was performed on a OHP sheet of Type DX by Ricoh Co., Ltd., under the conditions of image density: 1.0 mg/cm² and fixing temperature: 150° C. respectively for single colors, and measurements were made with a direct haze computer, type HGM-2DP manufactured by the Suga Instrument Co. Ltd. The transparency was evaluated in the order ⊚, ◯, Δ, X.

(11) Color Brightness, Color Reproducibility

The color brightness and color reproducibility was evaluated visually by an image outputted to Ricoh Co., Ltd. 6000 paper. The performance were expressed in the order ⊚, ◯, Δ, X.

(12) Gloss

The gloss of images outputted to 6000 paper by Ricoh Co., Ltd. was measured using a gloss meter (VG-1D) (Nihon Denshoku Co.), wherein the light projection angle and the light receiving angle were arranged to be 60 degrees, respectively, the S, S/10 change-over SW was set to S, and a standard setting was measured using a 0 preparation and a standard plate. The gloss was evaluated in descending order as ⊚:20 or more, ◯:10 to 20, Δ:5 to less than 10, and X:less than 5.

(13) Environmental Charge Stability

The charge stability was measured by measuring the charge amount at a temperature of 40° C. and 90% humidity. Part of the developer was sampled every 1000 sheets by the blow-off method during a 30,000-sheet running output of an image chart having an 7% image area 7% in monochrome mode. The charge decline is expressed in the order ⊚, ◯, Δ, X.

(14) Fixing Properties

This was determined by the toner fixing minimum temperature and fixing maximum temperature lying within a fixing temperature region where hot offset and cold offset did not occur, and transport problems such as paper jam, etc., did not often occur. The general fixing properties were evaluated in decreasing order as ⊚, ◯, Δ, X.

### Example A-1

(Polyol Resin 1)

378.4 g (number average molecular weight: approx. 360) of low molecule bisphenol A type epoxy resin, 86.0 g (number average molecular weight: approx. 2700) of high polymer bisphenol A type epoxy resin, 191.0 g of a diglicydyl compound which is an additional product of a bisphenol A type propylene oxide (n+m=approx. 2.1 in the aforementioned general formula (1)), 274.5 g bisphenol F, 70.1 g p-cumylphenol and 200 g xylene were added to a separable flask fitted with a stirrer, thermometer, N2 introduction port and cooling pipe. The temperature was raised to 70 to 100° C. in a N2 atmosphere, and 0.183 g of lithium chloride was added. The temperature was raised again to 160° C., water was added under decompression, xylene, water, other volatile components and polar solvent soluble components were removed by bubbling water and xylene, and polymerization was performed at a reaction temperature of 180° C. for 6 to 9 hours. In this way, 1000 g of a polyol resin having Mn; 3800, Mw/Mn; 3.9, Mp; 5000, softening point 109° C., Tg 58° C. and an epoxy equivalent of 30000 or more (hereafter polyol resin 1), was obtained. The reaction conditions in the polymerization reaction were controlled so that the monomer component did not remain. The polyoxyalkylene part of the main chain was verified by NMR.

(Manufacture of Toner)

<Black Toner>

| | |
|---|---|
| Water | 1000 parts |
| Phthalocyanine green water cake (solids 30%) | 200 parts |
| Carbon black (MA60, Mitsubishi Chemicals) | 540 parts |
| Polyol resin 1 | 1200 parts |

The aforementioned materials were mixed by a Henschel mixer, and a mixture containing water within a pigment aggregate was thus obtained. This was kneaded for 45 minutes by two rollers set to a roll surface temperature of 130° C., roll cooling was performed, and the product was crushed in a pulverizer to obtain a master batch pigment.

| | |
|---|---|
| Polyol resin 1 | 100 parts |
| Master batch | 8 parts |
| Charge controlling agent (Orient | 2 parts |
| Chemical Industries, Ltd. | |
| Bontron E-84) | |

After mixing these materials in a mixer, the materials were melt-kneaded in a two roller mill, and roll cooling of the kneaded mixture was performed. The product was then introduced into an impact plate crusher by a jet mill (an I-type mill, Nippon Pneumatic Mfg. Co., Ltd.) and air current grading by swirl flow (DS classifier: Nippon Pneumatic Mfg. Co., Ltd.) to obtain black colored coloring particles having a volume average particle diameter of 6.5 μm. 1.0 wt % of hydrophobic silica (HDK H2000, Clariant Japan, Ltd.) having a primary particle diameter of 10 nm and 0.5 wt % of titanium oxide (MT-150A, TAYCA Corporation) having a particle diameter of 15 nm were then mixed by a Henschel mixer, and then passed through a sieve of 50 μm mesh to remove aggregates and obtain a black toner 1. By preparing the additive mixing conditions (rotation speed, mixing time, frequency of mixings, temperature during mixture, shape of rotating blades) most appropriately, the tensile fracture strength and loose apparent density shown in Table 1 were obtained.

<Yellow Toner>

| | |
|---|---|
| Water | 600 parts |
| Pigment Yellow 17 water cake (solids 50%) | 1200 parts |
| Polyol resin 1 | 1200 parts |

The aforementioned starting materials were mixed by a Henschel mixer, and a mixture containing water within a pigment aggregate was thus obtained. This was kneaded for 45 minutes by two rollers set to a roll surface temperature of 130° C., roll cooling was performed, and the product was crushed in a pulverizer to obtain a master batch pigment.

| | |
|---|---|
| Polyol resin 1 | 100 parts |
| Master batch | 8 parts |
| Charge controlling agent (Orient | 2 parts |
| Chemical Industries, Ltd., | |
| Bontron E-84) | |

After mixing these materials in a mixer, the materials were melt-kneaded in a two roller mill, and roll cooling of the kneaded mixture was performed.

Similarly to the example of producing a black toner, the melt-kneaded was crushed and classified in order to obtain yellow colored coloring particles having a volume average particle diameter of 6.5 μm. 1.0 wt % of hydrophobic silica ASK H2000, Clariant Japan, Ltd.) having a primary particle diameter of 10 nm and 0.5 wt % of titanium oxide M-150A, TAYCA Corporation) having a particle diameter of 15 nm were then mixed by a Henschel mixer, and then passed through a sieve of 50 μm mesh to remove aggregates and obtain a yellow toner 1. By preparing the additive mixing conditions (rotation speed, mixing time, frequency of mixings, temperature during mixture, shape of rotating blades) most appropriately, the tensile fracture strength and loose apparent density shown in Table 1 were obtained.

<Magenta Toner>

| | |
|---|---|
| Water | 600 parts |
| Pigment Red 57 water cake (solids 50%) | 1200 parts |
| Polyol resin 1 | 1200 parts |

The aforementioned starting materials were mixed by a Henschel mixer, and a mixture containing water within a pigment aggregate was thus obtained. This was kneaded for 45 minutes by two rollers set to a roll surface temperature of 130° C., roll cooling was performed, and the product was crushed in a pulverizer to obtain a master batch pigment.

| | |
|---|---|
| Polyol resin 1 | 100 parts |
| Master batch | 8 parts |
| Charge controlling agent (Orient | |
| Chemical Industries, Ltd., | 2 parts |
| Bontron E-84) | |

After mixing these materials in a mer, the materials were melt-kneaded in a two roller mil, and roll cooling of the kneaded mixture was performed.

Similarly to the example of producing a black toner, the melt-kneaded was crushed and classified in order to obtain magenta colored coloring particles having a volume average particle diameter of 6.51 μm. 1.0 wt % of hydrophobic silica (HDK H2000, Clariant Japan, Ltd.) having a pi particle diameter of 10 nm and 0.5 wt % of titanium oxide (MT-150A, TAYCA Corporation) having a particle diameter of 15 nm were then mixed by a Henschel mixer, and passed through a sieve of 50 μm mesh to remove aggregates and obtain a magenta toner 1. By preparing the additive mixing conditions (rotation speed, mixing time, frequency of mixings, temperature during mixture, shape of rotating blades) most appropriately, the tensile fracture strength and loose apparent density shown in Table 1 were obtained.

<Cyan Toner>

| | |
|---|---|
| Water | 600 parts |
| Pigment Blue 15:3 water cake (solids 50%) | 1200 parts |
| Polyol resin 1 | 1200 parts |

The aforementioned materials were mixed by a Henschel mixer, and a mixture containing water within a pigment aggregate was thus obtained. This was kneaded for 45 minutes by two rollers set to a roll surface temperature of 130° C., roll cooling was performed, and the product was crushed in a pulverizer to obtain a master batch pigment.

| | |
|---|---|
| Polyol resin 1 | 100 parts |
| Master batch | 8 parts |
| Charge controlling agent (Orient | 2 parts |
| Chemical Industries, Ltd., Bontron E-84) | |

After mixing these materials in a mixer, the materials were melt-kneaded in a two roller mill, and roll cooling of the kneaded mixture was performed.

Similarly to the example of producing a black toner, the melt-kneaded was crashed and classified in order to obtain cyan colored coloring particles having a volume average particle diameter of 6.5 μm. 1.0 wt % of hydrophobic silica (HDK H2000, Clariant Japan, Ltd.) having a primary particle diameter of 10 nm and 0.5 wt % of titanium oxide (MT-150A, TAYCA Corporation) having a particle diameter of 15 nm were then mixed by a Henschel mixer, and then passed through a sieve of 50 μm mesh to remove aggregates and obtain a cyan toner 1. By preparing the additive mixing conditions (rotation speed, mug time, frequency of mixings, temperature during mixture, shape of rotating blades) most appropriately, the tensile fracture strength and loose apparent density shown in Table 1 were obtained.

(Two-Component Developer Test)

To evaluate the image by a two-component system developer, a developer was prepared using a ferrite carrier of average particle diameter 50 μm coated by a silicone resin to an average thickness of 0.3 am, and 5 weight parts of toner of each color to 100 weight parts of the carrier were uniformly mixed and charged using a tabular mixer wherein a container is rolled and agitated.

### Example A-2 to A-5

A toner and developer were prepared and evaluated in the same way as Example A-1, except for using a resin synthesized and manufactured in with the materials, additive amounts and physical properties shown in Table 2.

### Example A-6

A test was performed by adding 2.0 wt % hydrophobic silica (HDK H2000, Clariant Japan, Ltd.) and 1.0 wt % titanium oxide (MT-150A, TAYCA Corporation), and making the additive mixing conditions less severe (lower rotation speed, shorter mixing time, fewer frequency of mixings) to control the tensile fracture strength and loose apparent density to the values shown in Table 1. Other processes were conducted in the same way as Example A-1.

### Example A-7

A test was performed by adding 0.3 wt % hydrophobic silica (HDK H2000, Clariant Japan, Ltd.) and 0.3 wt % titanium oxide (MT-150A, TAYCA Corporation), and making the additive mixing conditions more severe (higher rotation speed, longer mixing time, larger frequency of mixings) to control to the tensile fracture strength and loose apparent density to the values shown in Table 1. The other processes were conducted in the same way as in Example A-1.

### Example A-8

A test was performed by adding dimethyl silicone oil (viscosity 300 mm2/s) to silica (OX-50, Japan Aerogel) having a primary particle diameter of 40 nm, adding 0.5 wt % of heat-treated hydrophobic silica so as to have the free silicone oil component 50%. The other processes were conducted in the same way as Example A-1. By preparing the additive mixing conditions (rotation speed, mixing time, frequency of mixings, temperature during mixture, shape of rotating blades) most appropriately, the tensile fracture strength and loose apparent density shown in Table 1 were obtained.

### Example A-9

A test was performed in the same way as Example A-1, except for controlling the volume average particle diameter of each color toner to 11 μm, and crushing it.

### Example A-10

A test was performed in the same way as Example A-1, except for making the melt-kneading conditions more severe, so as to have 110° C. of the softening point, 61° C. of the glass transition point (Tg), and 110° C. of the outflow start temperature.

### Example A-11

A test was performed in the same way as Example A-1, except for making the melt-kneading conditions less severe, so as to have 130° C. of the softening point, 92° C. of the glass transition point Tg), and 129° C. of the outflow start temperature.

### Example A-12

A test was performed in the same way as Example A-1, except for making the toner kneading conditions less severe so as to have 4300 of number average molecular weight (Mn), 3.9 of weight average molecular weight/number average molecular weight (Mw/M), and 4900 of at least one of peak molecular weight (MP), at the same time.

### Example A-13

A test was performed in the same way as Example A-1, except for making the toner kneading conditions more severe so as to have 3500 of number average molecular weight (Mn), 2.8 of weight average molecular weight/number average molecular weight (Mw/Mn), and 4200 of at least one of peak molecular weight (MP), at the same time.

### Example A-14

A test was performed by altering resin to polyester resin (acid value: 3, hydroxyl value: 25, Mn: 44300, Mw/Mn: 3.8, Tg: 59° C). The other processes were conducted as shown in Example A-1.

### Example A-15

A test was performed by altering diglicydyl compound, which is an adduct of a bisphenol A type propylene oxide, to a phthalic acid ester of a bisphenol A type propylene oxide. The test was resulted in obtaining 1000 g of a polyol resin containing a polyester resin part having Mn: 3200, Mw/M: 5.9, Mp: 5100, softening point 108° C., Tg 59° C. and epoxy equivalent of 30000 or more. The reaction conditions were controlled by the polymerization reaction so that the monomer component did not remain. The polyoxyalkylene part of the main chain was verified by NMR, and the polyester resin part was verified by infrared spectrophotometer.

### Example A-16

A test was performed in the same way as Example A-i, except for adding 5 weight parts of montan ester wax at the time of melt-kneading The dispersion average particle diameter of the wax in the toner was 1.2 μm.

### Example A-17

A test was performed in the same way as Example A-1, except for adding 4 weight parts of carnauba wax with fatty adds removed (acid value 4) at the time of melt-kneading. The dispersion average particle diameter of the wax in the toner was 0.8 μm.

### Example A-18

A test was performed in the same way as Example A-1, except for using a testing device B.

### Example A-19

A test was performed in the same way as Example A-1, except for using a testing device C.

### Example A-20

A test was performed in the same way as Example A-1, except for using a testing device D.

### Example A-21

A test was performed in the same way as Example A-1, except for conducting a surface treatment, with a testing device D, to smooth the intermediate transfer body surface so as to have 0.4 of the static frictional coefficient of this intermediate transfer body.

### Example A-22

A test was performed in the same way as Example A-I, except for conducting a surface treatment, with a testing device D, to have asperity on the intermediate transfer body surface so as to have 0.4 of the static frictional coefficient of this intermediate transfer body.

### Comparative Example A-1

A test was performed by adding 2.0 wt % hydrophobic silica (HDK H2000, Clariant Japan, Ltd.) and 1.0 wt % titanium oxide (MT-150A, TAYCA Corporation), and making the additive mixing conditions less severe (lower rotation speed, shorter mixing time, fewer frequency of mixings) to control the tensile fracture strength and loose apparent density to the values shown in Table 1. Other processes were conducted in the same way as Example A-1.

### Comparative Example A-2

A test was performed by adding 0.3 wt % hydrophobic silica (HDK H2000, Clariant Japan, Ltd.) and 0.3 wt % titanium oxide (MT-150A, TAYCA Corporation), and making the additive mixing conditions more severe (higher rotation speed, longer mixing time, more frequency of mixings) to control the tensile fracture strength and loose apparent density to the values shown in Table 1. Other processes were conducted in the same way as Example A-1.

### Comparative Example A-3

A test was performed by adding 2.0 wt % hydrophobic silica (HDK H2000, Clariant Japan, Ltd.) and 1.0 wt % titanium oxide (MT-150A, TAYCA Corporation), and making the additive mixing conditions less severe (lower rotation speed, shorter mixing time, fewer frequency of mixings) to control the tensile fracture strength and loose apparent density to the values shown in Table 1. Other processes were conducted in the same way as Example A-1

### Comparative Example A-4

A test was performed by adding 0.3 wt % hydrophobic silica (HDK H2000, Clariant Japan, Ltd.) and 0.3 wt % titanium oxide (MT-150A, TAYCA Corporation), and making the additive mixing conditions more severe (higher rotation speed, longer mixing time, more frequency of mixings) to control the tensile fracture strength and loose apparent density to the values shown in Table 1. Other processes were conducted in the same way as Example A-1.

### Comparative Example A-5

A test was performed by altering resin to polyester resin (acid value: 3, hydroxyl value: 25, Mn: 44300, Mw/Mn: 3.8, Tg: 59° C.), adding 2.0 wt % of titanium oxide having primary particle diameter of 15 nm (MT-150A, TAYCA Corporation), and controlling the tensile fracture strength and loose apparent density to the values shown in Table 1.

The other processes were conducted as shown in Example A-1.

TABLE 1

| | Loose | Loose | | | | | | | | | | | | | | |
|---|---|---|---|---|---|---|---|---|---|---|---|---|---|---|---|---|
| | Tensile | appar- | Test- | | Toner | Toner | Line | Im- | | Heat | | | | Color | Environ- | |
| | fracture | ent | ing | | trans- | refill | repro- | age | Toner | stability | | | Color | repro- | mental | Fixing |
| | strength | density | de- | Drop- | fer | prop- | duci- | depo- | den- | in | Trans- | | bright- | duci- | charge | prop- |
| | (N/m²) | (g/cm²) | vice | out | rate | erties | bility | sition | sity | storage | parency | Gloss | ness | bility | stability | erties |
| Ex. A-1 | 550 | 0.37 | A | ◯ | ◯ | ◯ | ◯ | ◯ | ⊚ | ◯ | ◯ | ⊚ | ◯ | ⊚ | ◯ | ◯ |
| Ex. A-2 | 820 | 0.42 | A | ◯ | ◯ | ◯ | ◯ | ⊚ | ⊚ | ◯ | ◯ | ⊚ | ◯ | ⊚ | ◯ | ◯ |
| Ex. A-3 | 230 | 0.35 | A | ⊚ | ⊚ | ◯ | ◯ | ◯ | ⊚ | ◯ | ◯ | ⊚ | ◯ | ⊚ | ◯ | ◯ |
| Ex. A-4 | 1150 | 0.31 | A | ◯ | ◯ | ◯ | ⊚ | ◯ | ⊚ | ◯ | ◯ | ⊚ | ◯ | ⊚ | ◯ | ◯ |
| Ex. A-5 | 1020 | 0.48 | A | ◯ | ⊚ | ◯ | ◯ | ◯ | ⊚ | ◯ | ◯ | ⊚ | ◯ | ⊚ | ◯ | ◯ |
| Ex. A-6 | 11 | 0.13 | A | ⊚ | ⊚ | ◯ | ◯ | ◯ | ◯ | ◯ | ◯ | ◯ | ◯ | ◯ | ◯ | ◯ |
| Ex. A-7 | 1380 | 0.46 | A | ◯ | ◯ | ◯ | ⊚ | ◯ | ◯ | ◯ | ◯ | ◯ | ◯ | ◯ | Δ | ◯ |
| EX. A-8 | 540 | 0.31 | A | ⊚ | ⊚ | Δ | ◯ | ⊚ | ⊚ | ⊚ | ◯ | ◯ | ◯ | ⊚ | ⊚ | ◯ |
| Ex. A-9 | 130 | 0.31 | A | ◯ | ◯ | ◯ | Δ | ⊚ | ◯ | ⊚ | ◯ | ◯ | Δ | ◯ | ⊚ | ◯ |
| Ex. A-10 | 640 | 0.35 | A | ◯ | ⊚ | ◯ | ◯ | ◯ | ⊚ | ◯ | ⊚ | ⊚ | ◯ | ⊚ | ◯ | ⊚ |
| Ex. A-11 | 950 | 0.40 | A | ◯ | ⊚ | ◯ | ◯ | ◯ | ⊚ | ◯ | ◯ | ◯ | ◯ | ◯ | ◯ | ⊚ |
| Ex. A-12 | 590 | 0.36 | A | ◯ | ⊚ | ◯ | ◯ | ◯ | ⊚ | ◯ | ◯ | ⊚ | ◯ | ⊚ | ◯ | ⊚ |
| Ex. A-13 | 820 | 0.33 | A | ◯ | ⊚ | ◯ | ◯ | ◯ | ⊚ | ◯ | ⊚ | ⊚ | ⊚ | ⊚ | ◯ | ⊚ |
| Ex. A-14 | 1320 | 0.42 | A | ◯ | Δ | ◯ | ◯ | ◯ | ⊚ | ◯ | ⊚ | ⊚ | ⊚ | ⊚ | ◯ | Δ |
| Ex. A-15 | 630 | 0.41 | A | ⊚ | ⊚ | ⊚ | ◯ | ◯ | ⊚ | ◯ | ◯ | ⊚ | ◯ | ⊚ | ⊚ | ⊚ |
| Ex. A-16 | 760 | 0.39 | A | ⊚ | ◯ | ◯ | ◯ | ◯ | ⊚ | ◯ | ◯ | ⊚ | ◯ | ⊚ | ◯ | ⊚ |
| Ex. A-17 | 650 | 0.42 | A | ⊚ | ⊚ | ◯ | ◯ | ◯ | ⊚ | ◯ | ◯ | ⊚ | ◯ | ⊚ | ◯ | ⊚ |
| Ex. A-18 | 550 | 0.37 | B | ⊚ | ◯ | ◯ | ⊚ | ◯ | ⊚ | ◯ | ◯ | ⊚ | ◯ | ⊚ | ◯ | ◯ |
| Ex. A-19 | 550 | 0.37 | C | ⊚ | ◯ | ◯ | ◯ | ◯ | ⊚ | ◯ | ◯ | ⊚ | ◯ | ⊚ | ◯ | ◯ |
| Ex. A-20 | 550 | 0.37 | D | ⊚ | ◯ | ◯ | ◯ | ◯ | ⊚ | ◯ | ◯ | ⊚ | ⊚ | ⊚ | ◯ | ◯ |
| Ex. A-21 | 550 | 0.37 | D | ⊚ | ⊚ | ◯ | ◯ | ◯ | ⊚ | ◯ | ◯ | ⊚ | ⊚ | ⊚ | ◯ | ◯ |
| Ex. A-22 | 550 | 0.37 | D | Δ | Δ | ◯ | ◯ | ◯ | ⊚ | ◯ | ◯ | ⊚ | ⊚ | ⊚ | ◯ | ◯ |
| Comp. | 9 | 0.12 | A | ◯ | ◯ | ⊚ | X | ◯ | X | ⊚ | Δ | Δ | Δ | Δ | ◯ | Δ |
| Ex. A-1 | | | | | | | | | | | | | | | | |
| Comp. | 1430 | 0.49 | A | X | X | X | Δ | X | ◯ | Δ | ◯ | ◯ | ◯ | ◯ | ◯ | Δ |
| Ex. A-2 | | | | | | | | | | | | | | | | |
| Comp. | 12 | 0.09 | A | ◯ | ◯ | ◯ | X | ◯ | X | ⊚ | Δ | Δ | Δ | Δ | ◯ | Δ |
| Ex. A-3 | | | | | | | | | | | | | | | | |
| Comp. | 1390 | 0.52 | A | X | X | X | ◯ | X | ◯ | Δ | ◯ | ◯ | ◯ | ◯ | ◯ | Δ |
| Ex. A-4 | | | | | | | | | | | | | | | | |
| Comp. | 1630 | 0.61 | A | X | X | X | Δ | X | ◯ | Δ | ◯ | Δ | ◯ | ◯ | ◯ | Δ |
| Ex. A-5 | | | | | | | | | | | | | | | | |

TABLE 2

| | | | | | | | | | | | Softening | Tg of |
|---|---|---|---|---|---|---|---|---|---|---|---|---|
| | | Low molecular | | High molecular | | Diglycidyl | | | Bisphenol | p-cumyl | point of | resin |
| | | weight bisphenol A | | weight bisphenol A | | compound | | Bisphenol F | AD | phenol | resin | ob- |
| | | | Adding | | Adding | n + | Adding | Adding | Adding | Adding | obtained | tained |
| | Resin | Mn | amount(g) | Mn | amount(g) | m | amount(g) | amount(g) | amount(g) | amount(g) | ° C. | ° C. |
| Ex. A-1 | Resin 1 | 360 | 378.4 | 2700 | 86 | 2.1 | 191 | 274.5 | — | 70.1 | 109 | 58 |
| Ex. A-2 | Resin 2 | 360 | 205.3 | 3000 | 54 | 2.2 | 432 | 282.7 | — | 26.0 | 109 | 58 |
| Ex. A-3 | Resin 3 | 360 | 252.6 | 10000 | 112 | 5.9 | 336 | — | 255.3 | 44.1 | 109 | 58 |
| Ex. A-4 | Resin 4 | 2400 | 289.9 | 10000 | 232 | 6.0 | 309 | — | 117.5 | 51.6 | 116 | 61 |
| Ex. A-5 | Resin 5 | 680 | 421.5 | 6500 | 107 | 2.0 | 214 | 210 | — | 47.5 | 114 | 60 |

More specifically, according to one aspect of the present invention, by using a toner for electrophotography containing at least binder resin and colorant, and which has a tensile fracture strength during 10 kg/cm² compression of 10-1400 (N/m²) and loose apparent density of 0.10-0.50 (g/cm³), toner transfer properties were improved, image-dropouts and abnormal images were prevented, the lost toner amount was reduced due to improved toner transfer rate, toner consumption was reduced, solid images were more uniform due to improved toner refill properties, thin line reproducibility was improved by reduction of toner dust, and there was less soiling due to better charge environmental stability. Moreover, printed matter having excellent heat-resistance storage properties, color reproducibility, vividness of color, gloss, transparency and fixing properties were obtained.

### EXAMPLES B

Next, the invention will be described specifically with reference to other examples, but it should be understood that the present invention is not limited only to these examples. In the following examples, parts and % are based on weight unless otherwise stated. The latent electrostatic image bearing member, intermediate transfer body, testing device, and properties and test results obtained are shown in Table 3. The evaluations in the examples were performed as follows.

(Testing Devices)

The images used for the evaluation were evaluated using the following testing devices A, B, C.

(Testing Device A)

Tests were performed using the testing device A modified to the intermediate transfer method, wherein an image was first transferred to an intermediate transfer body and this image was then transferred to a transfer material. This was done by improving a tandem full color laser beam printer, IPSiO Color 8000, by Ricoh Co., Ltd., having four color non-magnetic two-component developing units and four color photoconductors. Tests were performed with high speed printing (modified to 20-50 sheets/min/A4).

(Testing Device B)

Tests were performed using the testing device B, a modified full color laser copying machine, IMAGIO Color 2800 by Ricoh Co., Ltd., wherein four color developing units developed a two-component developer on one drum-shaped photoconductor for each color, the images were successively transferred to an intermediate transfer body, and four colors were then transferred to a transfer material in one operation.

(Testing Device C)

Tests were performed using the testing device C, a modified full color laser printer, IPSiO Color 5000 by Ricoh Co., Ltd., wherein four color developing units developed a one-component developer on one belt photoconductor for each color in succession, the images were successively transferred to an intermediate transfer body, and four colors were then transferred to a transfer material in one operation.

(Test Items)

1) Tensile Fracture Strength

The tensile fracture strength during 10 kg/cm² compression was shown. In the case of four color toners, the average value was shown.

2) Ionization Potential

The ionization potential was measured under the condition shown in the aforementioned publication. In the case of four color toners, the average value was shown.

3) Toner Scattering

After running output of 20,000 sheets having an image chart of 50% image area in monochrome mode, the developing unit was opened and the amount of toner which dispersed from the developing unit was visually determined. The rank of the improvement is expressed in the order X, Δ, ◯, and ⊚.

4) Dropout in Character Image

After running output of 20,000 sheets having an image chart of 50% image area in monochrome mode, a character image was output by superimposing four colors to a OHP sheet of Type DX by Ricoh Co., Ltd., and the frequency with which toner did not transfer, where there were parts missing from a line drawing image of a character part, was compared with a stage sample. The rank of the improvement is expressed in the order X, Δ, ◯, and ⊚.

5) Toner Transfer Rate

After running output of 100,000 sheets having an image chart of 7% image area in monochrome mode, the transfer rate was computed from the relation between the supplied toner amount and the lost toner amount.

Transfer rate (%)=100 ×(toner injection amount-lost toner amount)/(toner injection amount)

⊚ less than 90%, ◯ 75% to 90%, Δ 60% to 75%, X less 60%.

6) Toner Refill Properties

After alternately outputting an image chart of 90% image area and a 5% image chart every 5000 sheets, the refill properties of the toner at that time were examined. The rank of the improvement is expressed in the order X, Δ, ◯, and ⊚.

7) Transfer Dust

After running output of 20,000 sheets having an image chart of 50% image area in monochrome mode, 10 mm×10 mm solid images were output to Ricoh Co., Ltd. 6000 paper, superimposing four colors, and the transfer dust amount was compared with a stage sample. The rank of the improvement is expressed in the order X, Δ, ◯, and ⊚.

8) Thin Line Reproducibility

After running output of 20,000 sheets having an image chart of 50% image area in monochrome mode, a 600 dpi lineimage was output to Ricoh Co., Ltd. 6000 paper, and the degree of line blurring was compared with a stage sample. The rank of the improvement is expressed in the order X, Δ, ◯ and ⊚ This was done with four colors superimposed.

9) Soiling

After running output of 20,000 sheets having an image chart of 50% image area in monochrome mode, a blank paper image was stopped in development, the developer on the photoconductor after development was transferred to tape, and the difference from the image density on non-transferred tape was measured by a 938 Spectrodensity Meter (X-Rite). Little difference of image density means little soiling. The rank of the improvement is expressed in the order X, Δ, ◯, and ⊚.

10) Image Density

A solid image was output to 6000 paper by Ricoh Co., Ltd., and the image density was measured by X-Rite (X-Rite). This was performed independently for four colors, and the average was calculated. X less than 1.2, Δ 1.2 to 1.4, ◯ 1.4 to 1.8, ⊚ 1.4 to 1.8.

10) Heat-Resistance Storage Properties

10 g of toner of each color was weighed out, introduced into a 20 cc glass container the glass bottle was tapped approx. 100 times, and then left in a constant temperature bath for 24 hours. The penetration was measured with a penetration gauge. The descending performance order is ⊚: more than 20 mm, ◯: 15 mm-20 mm, Δ: 10 mm-15 mm, and X less than 10 mm.

12) Transparency

Single color images were fixed on an OHP sheet of Type DX by Ricoh Co., Ltd., with an image density of 1.0 mg/cm² and fixing temperature of 150° C., and measurements were taken with a direct Haze computer HGM-2DP, Suga Instrument Co. Ltd. The good transparency was expressed in the order ⊚, ◯, Δ, X.

13) Color Brightness, Color Reproducibility

The color brightness and color reproducibility was evaluated visually for an image outputted to 6000 paper by Ricoh Co., Ltd. The performance was expressed in the order ⊚, ◯, Δ, X.

14) Gloss

The gloss of images outputted to 6000 paper by Ricoh Co., Ltd. was measured using a gloss meter (VG-1D) (Nihon Denshoku Co.), wherein the light projection angle and the light receiving angle were arranged to be 60 degrees, respectively, the S, S/10 changeover SW was set to S, and a standard setting was measured using 0 preparation and a standard plate. The gloss was evaluated in descending order as ⊚: 15 or more, ◯: 6 to 15, Δ: 3 to less than 6, and X: less than 3.

15) High Temperature, High Humidity Charge Stability

The charge stability was measured by measuring the charge amount at a temperature of 40° C. and 90% humidity. Part of the developer was sampled every 1000 sheets by the blow-off method during a 50,000-sheet running output of an image chart having an 7% image area 7% in monochrome mode. The charge decline was expressed in the order ⊚, ◯, Δ, X.

16) Low Temperature, Low Humidity Charge Stability

The charge stability was measured by measuring the charge amount at a temperature of 10° C. and 15% humidity. Part of the developer was sampled every 1000 sheets by the blow-off method during a 50,000-sheet running output of an image chart having an 7% image area 7% in monochrome mode. The charge decline was expressed in the order (⊚, ◯, Δ, X.

17) Fixing Properties

This was determined by the toner fixing minimum temperature and fixing maximum temperature lying within a fixing temperature region where hot offset and cold offset did not occur, and paper jam, etc., transport problems did not often occur. The general fixing properties were evaluated in the order ⊚, ◯, Δ, X. The test was performed for a toner with wax by an oilless fixing machine, and for a toner without wax by an oil-coated fixing machine.

(Two-Component Developer Test)

To perform image evaluation using a two-component system developer, a developer was manufactured using a ferrite carrier of average particle diameter 50 μm coated to an average thickness of 0.3 μm with silicone resin, and charged by uniformly mixing 5 weight parts of toner of each color to 100 weight parts of carrier in a tabular mixer wherein the container rolls to produce agitation.

(Manufacture of Carrier)

Core Material

Cu—Zn ferrite particles (weight average diameter: 45 μm) 5000 weight parts

Coating Material

| | |
|---|---|
| Toluene | 450 weight parts |
| Silicone resin SR2400 (Toray Dow Corning Silicone, | 450 weight parts |
| non-volatiles 50%) | |
| Aminosilane SH6020 (Toray Dow Corning Silicone, | 10 weight parts |
| Carbon black | 10 weight parts |

The aforementioned coating material was dispersed by a stirrer for 10 minutes to prepare a coating liquid, and this coating liquid and core material were introduced into a coating device having a rotating sole plate disk and sting blade which coats while creating a swirl current so as to apply the coating liquid to the core material. The coated object was calcinated in a furnace at 250° C. for 2 hours, and the aforementioned carrier was thus obtained.

(Manufacture of Latent Electrostatic Image Bearing Member A)

An undercoat coating liquid, a charge-generating coating liquid and charge transporting layer coating liquid having the following compositions were successively coated on an aluminum drum of φ 30 mm. In this way, an undercoat layer of 3.5 μm, charge-generating layer of 0.2 μm and charge transporting layer of 28 μm were formed. The inorganic filler coating liquid described below was crushed (pulverized) by a paint shaker using zirconia beads for 2 hours to give a coating liquid. This liquid was applied thereon as a spray to form a 1.5-μm filler-reinforced charge transporting layer, and thus obtain the latent electrostatic image bearing member of the present invention

| | |
|---|---|
| [Undercoat coating liquid] | |
| Alkyde resin (Bekozole 1307-60-EL, Dainippon Ink & | 6 weight parts |
| Chemicals) | |
| Melamine resin (Super Bekkamine (G-821-60, | 4 weight parts |
| Dainippon Ink & chemicals) | |
| Titanium oxide (CR-EL Ishihara Sangyo Kaisha, Ltd.) | 40 weight parts |
| Methyl ethyl ketone | 200 weight parts |
| [Charge-generating layer coating liquid] | |
| Oxytitanium phthalocyanin paint | 2 weight parts |
| Poly vinyl butyral (UCC:XYHL) | 0.2 weight parts |
| Tetrahydrofuran | 50 weight parts |
| [Charge transporting layer coating liquid] | |
| Polycarbonate resin (Z Polyca, viscosity average | 12 weight parts |
| molecular weight: 50,000, Teijin Chemicals Co.) | |
| Low molecular weight charge transporting material | 10 weight parts |
| having the following structure | |
| 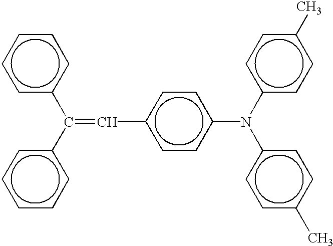 | |
| Tetrahydrofurane | 100 weight parts |
| 1% silicone oil (KF50-100CS, Shin-Etsu Chemical | 1 weight part |
| Co., Ltd.) tetrahydrofuran solution | |
| [Filler-reinforced charge transporting layer] | |
| Polycarbonate resin (Z Polyca, viscosity average | 4 weight parts |
| molecular weight 50,000, Teijin Chemicals Co.) | |
| Low molecular weight charge transporting material | 3 weight parts |
| having the following structure | |
| 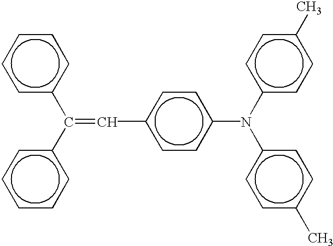 | |
| α-alumina (Sumicorundum AA-03, Sumitomo | 0.7 weight parts |
| Chemical Co., Ltd.) | |
| Cyclohexane | 280 weight parts |
| Tetrahydrofuran | 80 weight parts |

The manufacturing conditions (coating conditions, dryness conditions) of the charge transporting layer and filler-reinforced charge transporting layer were adjusted so that the ionization potential of the latent electrostatic image bearing member were the values shown in Table 3.

(Manufacture of Latent Electrostatic Image Bearing Member B)

A latent electrostatic image bearing member B was manufactured without providing a filler-reinforced charge transporting layer in the aforementioned latent electrostatic image bearing member A.

(Manufacture of Latent Electrostatic Image Bearing Member C)

A latent electrostatic image bearing member C was manufactured in the same way as the latent electrostatic image bearing member A, except that in the latent electrostatic image bearing member A, the molecular weight of the polycarbonate resin used for the charge transporting layer and filler-reinforced charge transporting layer was 70,000 or less.

(Manufacture of Latent Electrostatic Image Bearing Member D)

A latent electrostatic image bearing member D was manufactured in the same way as the latent electrostatic image bearing member A, except that in the latent electrostatic image bearing member A, the molecular weight of the polycarbonate resin used for the charge transporting layer and filler-reinforced charge transporting layer was 20,000 or less.

(Manufacture of Latent Electrostatic Image Bearing Member E)

A latent electrostatic image bearing member E was manufactured in the same way as the latent electrostatic image bearing member A, except that in the latent electrostatic image bearing member A, the compositional ratio (CTM/R) of the charge transferring material (GM) and polycarbonate resin (R) was 4/10 in terms of weight ratio.

(Manufacture of Latent Electrostatic Image Bearing Member F)

A latent electrostatic image bearing member F was manufactured in the same way as the latent electrostatic image bearing member A, except that in the latent electrostatic image bearing member A, the compositional ratio (CTM/R) of the charge transferring material (CTM) and polycarbonate resin (R) was 11/10 in terms of weight ratio.

(Manufacture of Intermediate Transfer Body A)

18 weight parts of carbon black, 3 weight parts of dispersing agent and 400 weight parts of toluene relative to 100 weight parts of PVDF100, were dispersed uniformly to give a dispersion solution A cylindrical mold was immersed in this solution, and gently raised and dried at room temperature to form a uniform PVDF film of 75 μm. The cylindrical mold was repeatedly immersed in the solution under the above conditions, raised at 10 mm/sec, and dried at room temperature to form a 150 μm PVDF belt The cylindrical mold on which the aforementioned 150 μm PVDF film was formed was then immersed in a uniform dispersion of 100 weight parts of polyurethane polymer, 3 weight parts of curing agent (isocyanate), 20 weight parts of carbon black, 3 weight parts of dispersing agent and 500 weight parts of MEK, raised at 30 mm/sec, and dried naturally. This was repeated after drying to form the desired 150 μm urethane polymer layer. For the surface layer, 100 weight parts of polyurethane prepolymer, 3 weight parts of curing agent (isocyanate), 50 weight parts of finely powdered FIFE, 4 weight parts of dispersing agent and 500 weight parts of MEK were uniformly dispersed.

The cylindrical mold coated with the aforementioned 150 μm urethane prepolymer was immersed therein, raised at 30 mm/sec, and dried naturally. After drying, this was repeated to form a urethane polymer surface layer in which 5 μm PTE was uniformly dispersed. After drying at room temperature, crosslinking was performed at 130° C. for 2 hours to give a three-layer composition transfer belt (resin layer: 150 μm, elastic layer: 150 μm, surface layer: 5 μm). This intermediate transfer body had a hardness of 40° (JIS-A), and a static friction coefficent of 0.3.

(Manufacture of Intermediate Transfer Body B)

The intermediate transfer body B was manufactured in the same way as the intermediate transfer body A, except that the crosslinking temperature of the surface layer was 110° C. and crosslinking was performed for 2 hours. This intermediate transfer body had a hardness of 9° (JIS-A), and a static friction coefficient of 0.7.

(Manufacture of Intermediate Transfer Body C)

The intermediate transfer body C was manufactured in the same way as the intermediate transfer body A, except that the layer thickness of the elastic layer was 50 μm, the crosslinking temperature of the surface layer was 140° C. and crosslinking was performed for 3 hours. This intermediate transfer body had a hardness of 68° (JIS-A), and a static friction coefficient of 0.08.

### Example B-1

(Polyol Resin 1)

378.4 g (number average molecular weight approx. 360) of low molecule bisphenol A type epoxy resin, 86.0 g (number average molecular weight: approx. 2700) of high polymer bisphenol A type epoxy resin, 191.0 g of a diglicydyl compound which is an addition product of a bisphenol A type propylene oxide (n+m=approx. 2.1 in the aforementioned general formula (1)), 274.5 g bisphenol F, 70.1 g p-cumylphenol and 200 g xylene were added to a separable flask fitted with a stirrer, thermometer, N2 introduction port and cooling pipe. The temperature was raised to 70-100° C. in a N2 atmosphere, and 0.183 g of lithium chloride was added. The temperature was raised again to 160° C., water was added under decompression, xylene, water, other volatile components and polar solvent soluble components were removed by bubbling water and xylene, and polymerization was performed at a reaction temperature of 180° C. for 6 to 9 hours. In this way, 11000 g of a polyol resin having Mn:3800, Mw/Mn:3.9, Mp:5000, softening point 109° C., Tg 58° C. and an epoxy equivalent of 30000 or more (hereafter polyol resin 1), was obtained. The reaction conditions in the polymerization reaction were controlled so that the monomer component did not remain. The polyoxyalkylene part of the chain was verified by NMR.

(Manufacture of Toner)

<Black Toner>

| | |
|---|---|
| Water | 1000 parts |
| Phthalocyanine green water cake (solids 30%) | 200 parts |
| Carbon black (MA60, | 540 parts |
| Mitsubishi Chemical Corporation) | |
| Polyol resin 1 | 1200 parts |

The aforementioned starting materials were mixed by a Henschel mixer, and a mixture containing water within a pigment aggregate was thus obtained. This was kneaded for 45 minutes by two rollers set to a roll surface temperature of 130° C., roll cooling was performed, and the product was crushed in a pulverizer to obtain a master batch pigment.

| | |
|---|---|
| Polyol resin 1 | 100 parts |
| Master batch | 8 parts |
| Charge controlling agent (Orient | 2 parts |
| Chemical Industries, Ltd. | |
| Bontron E-84) | |

After mixing these materials in a mixer, the materials were melt-kneaded in a two roller mill, and roll cooling of the kneaded mixture was performed. The product was then introduced into an impact plate crusher by a jet mill (an I-type mill, Nippon Pneumatic Mfg. Co., Ltd.) and air current grading by swirl flow (DS classifier: Nippon Pneumatic Mfg. Co., Ltd.) to obtain black colored coloring particles having a volume average particle diameter of 6.5 μm. 1.0 wt % of hydrophobic silica (HDK H2000, Clariant Japan, Ltd.) having a primary particle diameter of 10 nm and 0.5 wt % of titanium oxide (MT-150A, TAYCA Corporation) having a particle diameter of 15 nm were then mixed by a Henschel mixer, and then passed through a sieve of 50 μm mesh to remove aggregates and to obtain a black toner 1. By preparing the additive mixing conditions (rotation speed, mixing time, frequency of mixings, temperature during mixture, shape of rotating blades) most appropriately, the tensile fracture strength and loose apparent density shown in Table 3 were obtained. The ionization potential depends on the resin, the charge controlling agent, type and amount of pigment, but it also depends on kneading conditions. Therefore, the kneading conditions (kneading time, number of kneading operations and temperature) were adjusted to obtain the values shown in Table 3.

<Yellow Toner>

| | |
|---|---|
| Water | 600 parts |
| Pigment Yellow 17 water cake (solids 50%) | 1200 parts |
| Polyol resin 1 | 1200 parts |

The aforementioned starting materials were mixed by a Henschel mixer, and a mixture containing water within a pigment aggregate was thus obtained. This was kneaded for 45 minutes by two rollers set to a roll surface temperature of 130° C., roll cooling was performed, and the product was crushed in a pulverizer to obtain a master batch pigment.

| | |
|---|---|
| Polyol resin 1 | 100 parts |
| Master batch | 8 parts |
| Charge controlling agent (Orient | 2 parts |
| Chemical Industries, Ltd. | |
| Bontron E-84) | |

After mixing these materials in a mixer, the materials were melt-kneaded in a two roller mill 3 times or more, and roll cooling of the kneaded mixture was performed.

Similarly to the example of producing a black toner, the melt-kneaded was crushed and classified in order to obtain yellow colored coloring particles having a volume average particle diameter of 6.5 μm. 1.0 wt % of hydrophobic silica (HDK H2000, Clariant Japan, Ltd.) having a primary particle diameter of 10 nm and 0.5 wt % of titanium oxide (MT-150A, TAYCA Corporation) having a particle diameter of 15 nm were then mixed by a Henschel mixer. Then the mixture passed through a sieve with 50 μm mesh to remove aggregates and obtain a yellow toner 1. By preparing the additive mixing conditions (rotation speed, mixing time, frequency of mixings, temperature during mixture, shape of rotating blades) most appropriately, the tensile fracture strength and loose apparent density shown in Table 3 were obtained. The ionization potential depends on the resin, the charge controlling agent, type of pigment and amount, but it also depends on kneading conditions. Therefore, the kneading conditions (kneading time, number of kneading operations and temperature) were adjusted to obtain the values shown in Table 3.

<Magenta Toner>

| | |
|---|---|
| Water | 600 parts |
| Pigment Red 57 water cake (solids 50%) | 1200 parts |
| Polyol resin 1 | 1200 parts |

The aforementioned materials were mixed by a Henschel mixer, and a mixture containing water within a pigment aggregate was thus obtained. This was kneaded for 45 minutes by two rollers set to a roll surface temperature of 130° C., roll cooling was performed, and the product was crushed in a pulverizer to obtain a master batch pigment.

| | |
|---|---|
| Polyol resin 1 | 100 parts |
| The aforementioned Master batch | 8 parts |
| Charge controlling agent (Orient | 2 parts |
| Chemical Industries., Ltd. | |
| Bontron E-84) | |

After mixing these materials in a mixer, the materials were melt-kneaded in a two roller mill 3 times or more, and roll cooling of the kneaded mixture was performed.

Similarly to the example of producing a black toner, the melt-kneaded was crushed and classified in order to obtain magenta colored coloring particles having a volume average particle diameter of 6.5 μm. 1.0 wt % of hydrophobic silica (HDK H2000, Clariant Japan, Ltd.) having a primary particle diameter of 10 nm and 0.5 wt % of titanium oxide (MT-150A, TAYCA Corporation) having a particle diameter of 15 nm were then mixed by a Henschel mixer. Then the mixture passed through a sieve with 50 μm mesh to remove aggregates and obtain a magenta toner 1. By preparing the additive mixing conditions (rotation speed, mixing time, frequency of mixings, temperature during mixture, shape of rotating blades) most appropriately, the tensile fracture strength and loose apparent density shown in Table 3 were obtained. The ionization potential depends on the resin, the charge controlling agent, type of pigment and amount, but it also depends on kneading conditions. Therefore, the kneading conditions (kneading time, number of kneading operations and temperature) were adjusted to obtain the values shown in Table 3.

<Cyan Toner>

| | |
|---|---|
| Water | 600 parts |
| Pigment Blue 15:3 water cake (solids 50%) | 1200 parts |
| Polyol resin 1 | 1200 parts |

The aforementioned materials were mixed by a Henschel mixer, and a mixture containing water within a pigment aggregate was thus obtained. This was kneaded for 45 minutes by two rollers set to a roll surface temperature of 130° C., roll cooling was performed, and the product was crushed in a pulverizer to obtain a master batch pigment.

| | |
|---|---|
| Polyol resin 1 | 100 parts |
| Master batch | 8 parts |
| Charge controlling agent (Orient | 2 parts |
| Chemical Industries, Ltd. | |
| Bontron E-84) | |

After mixing these materials in a mixer, the materials were melt-kneaded in a two roller mill 3 nines or more, and roll cooling of the kneaded mixture was performed.

Similarly to the example of producing a black toner, the melt-kneaded was crushed and classified in order to obtain cyan colored coloring particles having a volume average particle diameter of 6.5 μm. 1.0 wt % of hydrophobic silica (HDK H2000, Clariant Japan, Ltd.) having a primary particle diameter of 10 nm and 0.5 wt % of titanium oxide (NT-150A, TAYCA Corporation) having a particle diameter of 15 nm were then mixed by a Henschel mixer. Then the mixture passed through a sieve with 50 μm mesh to remove aggregates and obtain a cyan toner 1. By preparing the additive mixing conditions (rotation speed, mixing time, frequency of mixings, temperature during mixture, shape of rotating blades) most appropriately, the tensile fracture strength and loose apparent density shown in Table 3 were obtained. The ionization potential depends on the resin, the charge controlling agent, type of pigment and amount, but it also depends on kneading conditions. Therefore, the kneading conditions (kneading time, number of kneading operations and temperature) were adjusted to obtain the values shown in Table 3.

### Example B-2 to B-5

A toner and developer were prepared and evaluated in the same way as Example B-1, except for using resin 2 to 5 synthesized and manufactured with the materials, additive amounts and physical properties shown in Table 2.

### Example B-6

A test was performed by adding 2.0 wt % hydrophobic silica (HDK H2000, Clariant Japan, Ltd.) and 1.0 wt % titanium oxide (MT-150A, TAYCA Corporation), and making the additive mixing conditions less severe (lower rotation speed, shorter mixing time, fewer frequency of mixings) to control the tensile fracture strength and loose apparent density to the values shown in Table 3. Other processes were conducted in the same way as Example B-1.

### Example B-7

A test was performed by adding 0.2 wt % hydrophobic silica (HDK H12000, Clariant Japan, Ltd.) and 0.2 wt % titanium oxide (MT-150A, TAYCA Corporation), and making the additive mixing conditions more severe (higher rotation speed, longer mixing time, larger frequency of mixings) to control to the tensile fracture strength and loose apparent density to the values shown in Table 3. The other processes were conducted in the same way as in Example B-1.

### Example B-8

A test was performed by adding dimethyl silicone oil (viscosity 300 mm2/s) to silica (OX-50, Japan Aerogel) having a primary particle diameter of 40 nm, adding 0.5 wt % of heat-treated hydrophobic silica so as to have the free silicone oil component 50%. The other processes were conducted in the same way as Example B-1. By preparing the additive mixing conditions (rotation speed, mixing time, frequency of mixings, temperature during mixture, shape of rotating blades) most appropriately, the tensile fracture strength and loose apparent density shown in Table 3 were obtained.

### Example B-9

A test was performed by adding dimethyl silicone oil (viscosity 300 mm2/s) and 0.2 wt % of zinc stearate (SZ-2000, Sakai Chemical Industry Co., Ltd.) to silica (OX-50, Japan Aerogel) having a primary particle diameter of 40 nm, adding 0.5 wt % of heat-treated hydrophobic silica so as to have the free silicone oil component 50%. The other processes were conducted in the same way as Example B-1. By preparing the additive mixing conditions (rotation speed, mixing time, frequency of mixing, temperature during mixture, shape of rotating blades) most appropriately, the tensile fracture strength and loose apparent density shown in Table 3 were obtained.

Example B-10

A test was performed in the same way as Example B-1, except for controlling the volume average particle diameter of each color toner to 11 μm, and crushing it.

### Example B-11

A test was performed in the same way as Example B-1, except for making the melt-kneading conditions more severe (kneading 6 times by 3 roller mills with 130° C. of the roller temperature), so as to have 110° C. of the softening point, 61° C. of the glass transition point (Tg), and 110° C. of the outflow start temperature.

### Example B-12

A test was performed in the same way as Example B-1, except for making the melt-kneading conditions less severe (Booth Co-kneader, weak kneading conditions), so as to have 130° C. of the softening point, 92° C. of the glass transition point (Tg), and 129° C. of the outflow start temperature.

### Example B-13

A test was performed in the same way as Example B-1, except for making the toner kneading conditions less severe (Booth Co-kneader, weak kneading conditions) so as to have 4300 of number average molecular weight (Mn), 3.9 of weight average molecular weight/number average molecular weight (Mw/Mn), and 4900 of at least one of peak molecular weight (MP), at the same time.

### Example B-14

A test was performed in the same way as Example B-1, except for making the toner kneading conditions more severe (kneading 7 times by 3 roller mills with 120° C. of the roller temperature) so as to have 3500 of number average molecular weight (Mn), 2.8 of weight average molecular weight/number average molecular weight (Mw/M), and 4200 of at least one of peak molecular weight (Mp), at the same time.

### Example B-15

A test was performed in the same way as in Example B-1, except for altering the resin to a polyester resin (a resin synthesized from terephthalic add, fumaric acid, polyoxypropylene-(2,2)-2,2-bis(4-hydroxyphenyl)propane and trimellitic acid, which comprises acid value: 3, hydroxyl value: 25, M: 44300, Mw/Mn 3.8, Tg: 59° C., softening point 106° C.).

### Example B-16

A test was performed in the same way as Example B-1, except for adding 5 weight parts of montan ester wax at the time of melt-kneading. The dispersion average particle diameter of the wax in the toner was 1.2 μm.

### Example B-17

A test was performed in the same way as Example B-1, except for adding 4 weight parts of carnauba wax with fatty acids removed (acid value 4) at the time of melt-kneading. The dispersion average particle diameter of the wax in the toner was 0.8 μm.

### Example B-18

A test was performed in the same way as Example B-1, except for using a latent electrostatic image bearing member B.

### Example B-19

A test was performed in the same way as Example B-1, except for using a latent electrostatic image bearing member C.

### Example B-20

A test was performed in the same way as Example B-1, except for using a latent electrostatic image bearing member D.

### Example B-21

A test was performed in the same way as Example B-1, except for using a latent electrostatic image bearing member E.

### Example B-22

A test was performed in the same way as Example B-1, except for using a latent electrostatic image bearing member F.

### Example B-23

A test was performed in the same way as Example B-1, except for using an intermediate transfer body B.

### Example B-24

A test was performed in the same way as Example B-1, except for using an intermediate transfer body C.

### Example B-25

A test was performed in the same way as Example B-1, except for using a testing device B.

### Example B-26

A test was performed in the same way as Example B-1, except for using a testing device C.

### Comparative Example B-1

A test was performed by adding 2.0 wt % hydrophobic silica (IDK H2000, Clariant Japan, Ltd.) and 1.0 wt % titanium oxide (MT-150A, TAYCA Corporation), and making the additive mixing conditions less severe (lower rotation speed, shorter mixing time, fewer frequency of mixings) to control the tensile fracture strength and loose apparent density to the values shown in Table 3. Other processes were conducted in the same way as Example B-1.

### Comparative Example B-2

A test was performed by adding 0.3 wt % hydrophobic silica (HDK H2000, Clariant Japan, Ltd.) and 0.3 wt % titanium oxide (MT-150A, TAYCA Corporation), and making the additive mixing conditions more severe (higher rotation speed, longer mixing time, more frequency of mixings) to control the tensile fracture strength to the values shown in Table 3. Other processes were conducted in the same way as Example B-1.

### Comparative Example B-3

A test was performed by altering the toner resin to polyester resin (polyester synthesized from terephthalic acid with bisphenol A propylene oxide added, and a succinc add derivative; acid value 4, A: 45000, Mw/Mn: 4.0, Tg: 62° C., softening point 106° C.), and altering the additives to 2.0 wt % of the titanium oxide (N-150A, TAYCA Corporation) particles having a primary particle diameter of 15 nm, and controlling the tensile fracture strength to the values shown in Table 3. This test was performed in the same way as Example B-1 except for using a latent electrostatic image bearing member E.

### Comparative Example B-4

A test was performed by altering the toner resin to polyester resin (polyester synthesized from terephthalic acid with bisphenol A propylene oxide added, and a succinic acid derivative; add value 4, Mn: 45000, Mw/M: 4.0, Tg: 62° C., softening point 106° C.), and altering the additives to 2.0 wt % of the titanium oxide (MT-150A, TAYCA Corporation) particles having a primary particle diameter of 15 nm, and controlling the tensile fracture strength to the values shown in Table 3. This test was performed in the same way as Example B-1 except for using an intermediate transfer body C.

### Comparative Example B-5

A test was performed by altering the toner resin to polyester resin (polyester synthesized from terephthalic acid with bisphenol A propylene oxide added, and a succinic acid derivative; acid value 4, Mn: 45000, Mw/Mn: 4.0, Tg: 62° C., softening point 106° C.), and altering the additives to 2.0 wt % of the titanium oxide (MT-150A, TAYCA Corporation) particles having a primary particle diameter of 15 nm, and controlling the tensile fracture strength to the values shown in Table 3. This test was performed in the same way as Example B-1 except for using a latent electrostatic image bearing member E and an intermediate transfer body C.

TABLE 3
Test results

| | Electrostatic | | | Tensile | Ionization potential | Ionization potential | | | | |
|---|---|---|---|---|---|---|---|---|---|---|
| | image | Intermediate | | fracture | between toner and | between toner and | | | Toner | Toner |
| | bearing | transfer | Testing | strength | electrostatic image | intermediate | Toner | Image- | transfer | refill |
| | member | body | device | (N/m²) | bearing member (eV) | transfer body (eV) | Scattering | Dropout | rate | properties |
| Ex. B-1 | A | A | A | 550 | 0.4 | 0.3 | ◯ | ◯ | ◯ | ◯ |
| Ex. B-2 | A | A | A | 820 | 0.6 | 0.5 | ◯ | ◯ | ◯ | ◯ |
| Ex. B-3 | A | A | A | 230 | 0.2 | 0.1 | ◯ | ⊚ | ⊚ | ◯ |
| Ex. B-4 | A | A | A | 1150 | 0.8 | 0.6 | Δ | ◯ | ◯ | ◯ |
| Ex. B-5 | A | A | A | 1020 | 0.4 | 0.4 | ◯ | ◯ | ⊚ | ◯ |
| Ex. B-6 | A | A | A | 11 | 0.2 | 0.3 | ⊚ | ⊚ | ⊚ | ⊚ |
| Ex. B-7 | A | A | A | 1380 | 0.4 | 0.6 | Δ | ◯ | ◯ | Δ |
| Ex. B-8 | A | A | A | 540 | 0.6 | 0.3 | ⊚ | ⊚ | ⊚ | Δ |
| Ex. B-9 | A | A | A | 130 | 0.1 | 0.2 | ⊚ | ⊚ | ⊚ | Δ |
| Ex. B-10 | A | A | A | 640 | 0.9 | 0.8 | ⊚ | Δ | ◯ | ◯ |
| Ex. B-11 | A | A | A | 950 | 0.5 | 0.6 | ◯ | ◯ | ⊚ | Δ |
| Ex. B-12 | A | A | A | 590 | 0.6 | 0.7 | ◯ | ◯ | ⊚ | ◯ |
| Ex. B-13 | A | A | A | 820 | 0.6 | 0.5 | ◯ | ◯ | ⊚ | ◯ |
| Ex. B-14 | A | A | A | 1320 | 0.6 | 0.4 | ◯ | ◯ | ⊚ | ◯ |
| EX. B-15 | A | A | A | 630 | 0.9 | 0.9 | ◯ | ◯ | ⊚ | ◯ |
| Ex. B-16 | A | A | A | 650 | 0.3 | 0.4 | ◯ | ⊚ | ◯ | Δ |
| Ex. B-17 | A | A | A | 550 | 0.1 | 0.2 | ◯ | ⊚ | ⊚ | Δ |
| Ex. B-18 | B | A | A | 550 | 0.5 | 0.4 | ◯ | ◯ | Δ | ◯ |
| Ex. B-19 | C | A | A | 550 | 0.4 | 0.3 | ◯ | ◯ | ◯ | ◯ |
| Ex. B-20 | D | A | A | 550 | 0.5 | 0.3 | ◯ | ◯ | Δ | ◯ |
| Ex. B-21 | E | A | A | 550 | 0.7 | 0.3 | ◯ | ◯ | ◯ | ◯ |
| Ex. B-22 | F | A | A | 550 | 0.5 | 0.3 | ◯ | ◯ | ◯ | ◯ |
| Ex. B-23 | A | B | A | 550 | 0.4 | 0.6 | ◯ | ◯ | Δ | ◯ |
| Ex. B-24 | A | C | A | 550 | 0.4 | 0.7 | ◯ | Δ | Δ | ◯ |
| Ex. B-25 | A | A | B | 550 | 0.4 | 0.3 | ◯ | ◯ | ◯ | ◯ |
| Ex .B-26 | A | A | C | 550 | 0.4 | 0.3 | Δ | ◯ | Δ | ◯ |
| Comp. | A | A | A | 9 | 0.3 | 0.4 | ◯ | ◯ | ◯ | ⊚ |
| Ex. B-1 | | | | | | | | | | |
| Comp. | A | A | A | 1430 | 0.5 | 0.5 | Δ | X | X | X |
| Ex. B-2 | | | | | | | | | | |
| Comp. | A | A | A | 550 | 1.2 | 0.3 | ◯ | X | X | X |
| Ex. B-3 | | | | | | | | | | |
| Comp. | A | A | A | 550 | 0.4 | 1.2 | ◯ | X | X | X |
| Ex. B-4 | | | | | | | | | | |
| Comp. | A | A | A | 550 | 1.2 | 1.2 | X | X | X | X |
| Ex. B-5 | | | | | | | | | | |

TABLE 4
Test results

| | | | | | | | | | | High | Low | |
|---|---|---|---|---|---|---|---|---|---|---|---|---|
| | | | | | | | | | | temperature, | temperature, | |
| | | | | | | | | | Color | high | low | |
| | | | | | Heat | | | Color | repro- | humidity | humidity | |
| | Transfer | Line | Image | Toner | stability | Trans- | | bright- | duci- | charge | charge | Fixing |
| | dust | reproducibility | deposition | density | in storage | parency | Gloss | ness | bility | stability | stability | properties |
| Ex. B-1 | ◯ | ◯ | ◯ | ⊚ | ◯ | ◯ | ⊚ | ◯ | ⊚ | ◯ | ◯ | ◯ |
| Ex. B-2 | ◯ | ◯ | ⊚ | ⊚ | ◯ | ◯ | ⊚ | ◯ | ⊚ | Δ | ◯ | ◯ |
| Ex. B-3 | ◯ | ◯ | ◯ | ⊚ | ◯ | ◯ | ⊚ | ◯ | ⊚ | ◯ | ◯ | ◯ |
| Ex. B-4 | ⊚ | ⊚ | ◯ | ⊚ | ◯ | ◯ | ⊚ | ◯ | ⊚ | ◯ | ⊚ | ◯ |
| Ex. B-5 | ◯ | ◯ | ◯ | ⊚ | ◯ | ◯ | ⊚ | ◯ | ⊚ | ◯ | ◯ | ◯ |
| Ex. B-6 | Δ | Δ | ◯ | Δ | ◯ | ◯ | ◯ | ◯ | ◯ | ◯ | ◯ | Δ |
| Ex. B-7 | ⊚ | ⊚ | ◯ | ◯ | ◯ | ◯ | ◯ | ◯ | ◯ | Δ | Δ | ◯ |
| Ex. B-8 | Δ | ◯ | ⊚ | ⊚ | ⊚ | ◯ | ◯ | ◯ | ⊚ | ⊚ | ⊚ | ◯ |
| Ex. B-9 | Δ | ◯ | ⊚ | ⊚ | ⊚ | ◯ | ◯ | ◯ | ⊚ | ⊚ | ⊚ | ⊚ |
| Ex. B-10 | Δ | Δ | ⊚ | ◯ | ⊚ | ◯ | ◯ | Δ | ◯ | ⊚ | ⊚ | ◯ |
| Ex. B-11 | ◯ | ◯ | ◯ | ⊚ | ◯ | ⊚ | ⊚ | ◯ | ⊚ | ◯ | ◯ | ⊚ |
| Ex. B-12 | ◯ | ◯ | ◯ | ⊚ | ◯ | ◯ | ◯ | ◯ | ◯ | ◯ | ◯ | ⊚ |
| Ex. B-13 | ◯ | ◯ | ◯ | ⊚ | ◯ | ◯ | ⊚ | ◯ | ⊚ | ◯ | ◯ | ⊚ |
| Ex. B-14 | ◯ | ◯ | ◯ | ⊚ | ◯ | ⊚ | ⊚ | ⊚ | ⊚ | ⊚ | ◯ | ⊚ |
| Ex. B-15 | ◯ | ◯ | ◯ | ⊚ | ◯ | ⊚ | ⊚ | ⊚ | ⊚ | ◯ | ◯ | ⊚ |
| Ex. B-16 | ◯ | ◯ | ◯ | ⊚ | ◯ | ◯ | ⊚ | ◯ | ⊚ | ◯ | ◯ | ⊚ |
| Ex. B-17 | ◯ | ◯ | ◯ | ⊚ | ◯ | ◯ | ⊚ | ◯ | ⊚ | ◯ | ◯ | ⊚ |
| Ex. B-18 | ◯ | Δ | ◯ | ⊚ | ◯ | ◯ | ⊚ | ◯ | ⊚ | ◯ | ◯ | ◯ |
| Ex. B-19 | ◯ | Δ | ◯ | ⊚ | ◯ | ◯ | ⊚ | Δ | Δ | ◯ | ◯ | ◯ |
| Ex. B-20 | ◯ | Δ | Δ | ◯ | ◯ | ◯ | ◯ | ◯ | ◯ | ◯ | ◯ | ◯ |
| Ex. B-21 | ◯ | Δ | Δ | ◯ | ◯ | ◯ | ⊚ | ◯ | ⊚ | ◯ | ◯ | ◯ |
| Ex. B-22 | ◯ | Δ | Δ | ⊚ | ◯ | ◯ | ⊚ | ◯ | ⊚ | ◯ | ◯ | ◯ |
| Ex. B-23 | ◯ | Δ | ◯ | ◯ | ◯ | ◯ | ◯ | ◯ | Δ | ◯ | ◯ | ◯ |
| Ex. B-24 | ◯ | Δ | ◯ | ◯ | ◯ | ◯ | ◯ | ◯ | ◯ | ◯ | ◯ | ◯ |
| Ex. B-25 | Δ | ◯ | ◯ | ⊚ | ◯ | ◯ | ⊚ | ◯ | ◯ | ◯ | ◯ | ◯ |
| Ex. B-26 | Δ | ◯ | ◯ | ⊚ | ◯ | ◯ | ⊚ | ◯ | ◯ | ◯ | ◯ | ◯ |
| Comp. | X | X | ◯ | X | ⊚ | Δ | Δ | Δ | Δ | ◯ | ◯ | Δ |
| Ex. B-1 | | | | | | | | | | | | |
| Comp. | Δ | Δ | X | ◯ | Δ | ◯ | ◯ | ◯ | ◯ | Δ | Δ | Δ |
| Ex. B-2 | | | | | | | | | | | | |
| Comp. | ◯ | X | ◯ | ◯ | ◯ | ◯ | ◯ | ◯ | ◯ | Δ | Δ | ◯ |
| Ex. B-3 | | | | | | | | | | | | |
| Comp. | ◯ | ◯ | X | ◯ | ◯ | ◯ | ◯ | ◯ | ◯ | ◯ | ◯ | Δ |
| Ex. B-4 | | | | | | | | | | | | |
| Comp. | X | Δ | X | ◯ | ◯ | ◯ | Δ | Δ | Δ | X | X | Δ |
| Ex. B-5 | | | | | | | | | | | | |

TABLE 5

| | | | | | | | | | | | Softening | Tg of |
|---|---|---|---|---|---|---|---|---|---|---|---|---|
| | | Low molecular | | High molecular | | Diglycidyl | | | Bisphenol | p-cumyl | point of | resin |
| | | weight bisphenol A | | weight bisphenol A | | compound | | Bisphenol F | AD | phenol | resin | ob- |
| | | | Adding | | Adding | n + | Adding | Adding | Adding | Adding | obtained | tained |
| | Resin | Mn | amount(g) | Mn | amount(g) | m | amount(g) | amount(g) | amount(g) | amount(g) | ° C. | ° C. |
| Ex. B-1 | Resin 1 | 360 | 378.4 | 2700 | 86 | 2.1 | 191 | 274.5 | — | 70.1 | 109 | 58 |
| Ex. B-2 | Resin 2 | 360 | 205.3 | 3000 | 54 | 2.2 | 432 | 282.7 | — | 26.0 | 109 | 58 |
| Ex. B-3 | Resin 3 | 360 | 252.6 | 10000 | 112 | 5.9 | 336 | — | 255.3 | 44.1 | 109 | 58 |
| Ex. B-4 | Resin 4 | 2400 | 289.9 | 10000 | 232 | 6.0 | 309 | — | 117.5 | 51.6 | 116 | 61 |
| Ex. B-5 | Resin 5 | 680 | 421.5 | 6500 | 107 | 2.0 | 214 | 210 | — | 47.5 | 114 | 60 |

By using an image-forming device according to one aspect of the present invention, which, in a two-step transfer process, first transfers a toner image formed on a latent electrostatic image bearing member to an intermediate transfer body, and then transfers this toner image to a transfer material, the tensile fracture strength during 10 kg/cm² compression is 10-1400 (N/m²), the ionization potential (IP) difference between the toner and the latent electrostatic image bearing member is 1.0 eV or less, and the ionization potential (IP) difference between the toner and the intermediate transfer body is 1.0 eV or less. Hence toner transfer properties were improved, image-dropouts and abnormal images were prevented, the lost toner amount was reduced due to improved toner transfer rate, toner consumption was reduced, solid images were more uniform due to improved toner refill properties, toner dust was reduced, thin line reproducibility was improved, there was less soiling due to better charge environmental stability in high temperature, high humidity and low temperature, low humidity conditions, and scatter of toner was prevented. Moreover, printed matter having excellent heat-resistance storage properties, color reproducibility, color brightness, gloss, transparency and fixing properties could be obtained.

What is claimed is:

1. A toner for electrophotography, comprising:
a binder resin; and
a colorant,
the toner has a tensile fracture strength of 10-1400 (N/m²) under 10 kg/cm² compression, and a loose apparent density of 0.10-0.50 (g/cm³).

2. A toner for electrophotography according to claim 1, further comprising at least two or more inorganic fine particles having hydrophobically-treated primary particles in which an average particle diameter is 1-100 nm, and the toner has a volume average particle diameter of 3 μm to 10 μm.

3. A toner for electrophotography according to claim 1, further comprising:
at least two or more inorganic fine particles having hydrophobically-treated primary particles in which an average particle diameter is 1-100 nm; and
at least one or more inorganic fine particles having hydrophobically-treated primary particles in which an average particle diameter is 30 nm or more.

4. A toner for electrophotography according to claim 1, wherein the toner has a softening point of 60-150° C., a flow start temperature of 70° C.-130° C., and a glass transition point (Tg) of 40-70° C.

5. A toner for electrophotography according to claim 1, wherein the toner for electrophotography has a number average molecular weight (Mn) of 2000-8000, the weight average molecular weight/number average molecular weight (Mw/Mn) of 1.5-20, and having at least one peak molecular weight (Mp) of 3000-7000.

6. A toner for electrophotography according to claim 1, wherein the binder resin comprises a polyol resin.

7. A toner for electrophotography according to claim 6, wherein the polyol resin is an epoxy resin having a polyoxyalkylene portion in the main chain.

8. A toner for electrophotography according to claim 1, wherein the binder resin comprises at least a polyol resin unit and a polyester resin unit.

9. A toner for electrophotography according to claim 1,
wherein the toner comprises at least a wax having a dispersed average particle diameter of 3 μm or less.

10. A developer for electrophotography, comprising:
a toner for electrophotography; and
a carrier containing magnetic particles,
wherein the toner for electrophotography comprises:
a binder resin; and
a colorant,
wherein the toner for electrophotography has a tensile fracture strength of 10-1400 (N/m²) under 10 kg/cm² compression, and a loose apparent density of 0.10-0.50 (g/cm³).

11. An image-forming device, comprising:
a latent electrostatic image bearing member;
a charger for charging the latent electrostatic image bearing member;
a light irradiator for irradiating the latent electrostatic image bearing member to a light to form a latent electrostatic image;
an image developer for developing the latent electrostatic image with a developer for electrophotography to form a visible developed image; and
a transfer for transferring the visible developed image to a transfer medium,
wherein the developer for electrophotography comprises a toner for electrophotography which comprises:
a binder resin; and
a colorant,
wherein the toner for electrophotography has a tensile fracture strength of 10-1400 (N/m²) under 10 kg/cm² compression, and a loose apparent density of 0.10-0.50 (g/cm³).

12. An image forming device according to claim 11,
wherein the developer for electrophotography is a one-component developer.

13. An image forming device according to claim 11,
wherein the developer for electrophotography is a two-component developer comprising a carrier containing magnetic particles.

14. An image-forming device according to claim 11,
wherein the image developer forms the visible developed image by applying developers for electrophotography comprising a plurality of colors onto the latent electrostatic image which is divided into a plurality of colors, and the transfer transfers the developed image to the transfer material by one of a single operation and a plurality of operations.

15. An image-forming device according to claim 11,
wherein the image developer comprises a plurality of developing units for individual colors, the developing unit comprises:
a developing roller; and
a developing blade for uniformly controlling a thickness of the developer supplied onto the developing roller,
and the image developer develops the respective latent electrostatic images formed on the respective developing rollers in the developing units using the developers of corresponding colors, and the transfer transfers the developed image to the transfer material by one of a single operation and a plurality of operations.

16. An image-forming device according to claim 11,
wherein the transfer comprises:
an intermediate transfer body;
a first transferee which transfers the developed image from the latent electrostatic image bearing member to the intermediate transfer body; and
a second transferer which transfers the developed image from the intermediate transfer body to the final transfer material,
wherein the developed image formed on the latent electrostatic image bearing member is first transferred to the intermediate transfer body, and second transferred to the final transfer material.

17. An image-forming device according to claim 16,
wherein the intermediate transfer body has a static coefficient of friction in the range of 0.1-0.6.

18. An image forming device according to claim 11,
wherein the image forming device is a direct transfer type tandem color image forming device comprising an image-forming unit which comprises:
a latent electrostatic image bearing member;
a charger;
a light irradiator; and
an image developer,
the image forming unit is disposed in plurality of along a transfer belt stretched between a belt drive roller and a belt driven roller, and the direct transfer type tandem color image forming device transfers the developed images formed on each of the latent electrostatic image bearing members by sequentially superimposing onto a single transfer member carried on the transfer belt, in which the transfer member is located in a state to touch the latent electrostatic image bearing member.

19. An image forming device according to claim 11,
wherein the image forming device is an indirect transfer type tandem color image forming device comprising an image-forming unit which comprises:
a latent electrostatic image bearing member;
a charger;
a light irradiator; and
an image developer,
the image forming unit is disposed in plurality of along a transfer belt stretched between a belt drive roller and a belt driven roller, and the indirect transfer type tandem color image forming device first transfers the developed images formed on the latent electrostatic image bearing member by separately superimposing onto an intermediate transfer body to form a developed image, and second transfers the developed image to a final transfer material to obtain a color image, in which the intermediate transfer member is located in a state to touch the latent electrostatic image bearing member.

20. An image-forming device, comprising:
a latent electrostatic image bearing member;
a charger for charging the latent electrostatic image bearing member;
a light irradiator for irradiating the latent electrostatic image bearing member to a light to form a latent electrostatic image;
an image developer for developing the latent electrostatic image with a developer to form a visible developed image; and
a transfer for transferring the visible developed image to an intermediate transfer body, and then to a transfer medium,
wherein the developer is a one-component developer comprising a toner for electrophotography having a tensile fracture strength of 10-1400 (N/m²) under 10 kg/cm² compression, and an ionization potential (IP) difference between the toner for electrophotography and the latent electrostatic image bearing member is 0-1.0 eV, and an IP difference between the toner for electrophotography and the intermediate transfer body is 0-1.0 eV or less.

21. An image-forming device according to claim 20,
wherein the toner for electrophotography comprises at least two or more inorganic fine particles having hydrophobically-treated primary particles in which an average particle diameter is 1-100 nm, and the toner for electrophotography has a volume average particle diameter of 2 μm to 8 μμm.

22. An image-forming device according to claim 20, wherein the toner for electrophotography has a softening point of 60-150 C., a flow start temperature of 70-130° C., and a glass transition point of (Tg) of 40-70° C.

23. An image-forming device according to claim 20, wherein the toner for electrophotography has a number average molecular weight (Mn) of 2000-8000, the weight average molecular weight/number average molecular weight (Mw/M) of 1.5-20, and at least one peak molecular weight (Mp) of 3000-7000.

24. An image-forming device according to claim 20,
wherein the toner for electrophotography comprises a binder resin which comprises a polyol resin, and the polyol resin is an epoxy resin having a polyoxyalkylene portion in the main chain.

25. An image-forming device according to claim 20, wherein the toner for electrophotography comprises a wax, and a dispersed average particle diameter of the wax in the toner for electrophotography is 0.001-3 μm.

26. An image-forming device according to claim 20,
wherein the latent electrostatic image bearing member is a function separated electronic photoconductor comprising:
an electroconductive substrate;
a charge generating layer;
a charge transporting layer; and
a filler-reinforced charge transporting layer,
wherein the charge transporting layer comprises at least a charge transferring material (CTM) and a polycarbonate resin (R) having a viscosity average molecular weight of 30,000 to 60,000, and the compositional ratio (CTM/R) of 5/10 to 10/10 in terms of weight ratio.

27. An image-forming device according to claim 20, wherein the intermediate transfer body is an elastic belt having a hardness of 10°≦HS≦65° (JIS-A).

28. An image-forming device according to claim 20,
wherein the intermediate transfer body has a static coefficient of friction in the range of 0.1-0.6.

29. An image-forming method, comprising:
a step for charging a latent electrostatic image bearing member,
a step for irradiating the latent electrostatic image bearing member to a light to form a latent electrostatic image;
a step for developing the latent electrostatic image with a developer for electrophotography to form a visible developed image; and
a step for transferring the visible developed image to a transfer medium,
wherein the developer for electrophotography comprises a toner for electrophotography which comprises:
a binder resin; and
a colorant,
wherein the toner for electrophotography has a tensile fracture strength of 10-1400 (N/m²) under 10 kg/cm² compression, and a loose apparent density of 0.10-0.50 (g/cm³).

30. An image-forming method, comprising:
a step for charging a latent electrostatic image bearing member,
a step for irradiating the latent electrostatic image bearing member to a light to form a latent electrostatic image;
a step for developing the latent electrostatic image with a developer for electrophotography to form a visible developed image; and
a step for transferring the visible developed image to an intermediate transfer body, and then to a transfer medium,
wherein the developer for electrophotography is a one-component developer comprising a toner for electrophotography having a tensile fracture strength of 10-1400 (N/m²) under 10 kg/cm² compression, and an ionization potential (IP) difference between the toner for electrophotography and the latent electrostatic image bearing member is 04-1.0 eV, and an IP difference between the toner for electrophotography and the intermediate transfer body is 0.1.0 eV or less.
